(19) United States
(12) Patent Application Publication
(10) Pub. No.: US 2005/0007312 A1
(43) Pub. Date: Jan. 13, 2005

(54) Plasma display device and driving method used for same

(75) Inventors: Yoshito Tanaka, Tokyo (JP); Mitsuyoshi Makino, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC PLASMA DISPLAY CORPORATION

(21) Appl. No.: 10/886,042

(22) Filed: Jul. 8, 2004

(30) Foreign Application Priority Data
Jul. 8, 2003 (JP) 2003-271716

(51) Int. Cl. G09G 3/28

(52) U.S. Cl. 345/60

(57) ABSTRACT

A plasma display device is provided which is capable of solving a problem that luminance of a black display caused by light emitted by pre-discharge and pre-erasing discharge is high, of enhancing a contrast ratio by lowering display luminance, of reducing discharge currents that flow by writing discharge without lowering display luminance. By dividing surface discharge electrodes on a side where writing discharge is made to occur into first and second portions, writing discharge to select a state of being displayed or being non-displayed is made to occur by using only the first portion. Then, sustaining discharge to realize light-emission for displaying is made to occur by using the first and second portions. This causes currents that flow by writing discharge to decrease and writing operations to be performed in a stable manner. Since no reduction in currents that flow by sustaining discharge occurs, displaying at high luminance can be maintained.

### BACKGROUND OF THE INVENTION

1. Field of the Invention

The present invention relates to a plasma display device and a method for driving the plasma display device and a plasma display panel making up the plasma display device and more particularly to the plasma display device that can be suitably used to improve a contrast ratio of a display screen and to the plasma display panel that can achieve stable luminance-enhanced display at low costs and to the driving method to be used in the plasma display device having the plasma display panel.

2. Description of the Related Art

First, first conventional technology and its problems to be solved are described. A plasma display device including a plasma display panel (hereinafter may be referred simply to as a “PDP”) as its main component has many features in that it can be of a thin-type, it can display images on a large screen with comparatively easiness, and it can provide a wide viewing angle and a high speed response. Therefore, in recent years, a PDP is widely used, as a flat panel display, in wall-hung TVs (television), public display devices, or a like. The PDP can be classified, in terms of structures, into two types, one being a DC (Direct Current)-type PDP in which a display electrode (that is, a pair of surface electrodes made up of a scanning electrode and a sustaining electrode) is exposed in discharging space and operations are performed in a state of direct-current discharge and another being an AC (Alternating Current)-type PDP in which the display electrode is not exposed in discharge space and is covered with a dielectric and operations are performed indirectly in a state of alternating-current discharge. Moreover, the AC-type PDP is further classified into two types, one being of a memory operating type PDP which uses a memory function based on a charge accumulating action on the dielectric and another being of a refresh operating type which does not use the memory function.

In a conventional memory operating type PDP used in the conventional plasma display device, for example, as shown in FIG. 29, are formed groups of surface discharge electrodes being made up of each of m-pieces (Si, i=1, 2, . . . , m) of scanning electrodes 2 and each of m-pieces (Ci, i=1, 2, . . . , m) of sustaining electrodes 3, wherein each of the scanning electrodes 2 and each of the sustaining electrodes 3 are arranged in an inner surface of a front substrate (not shown) in a display panel in parallel to each other in a row direction H, and n-pieces of data electrodes 4a and 4b arranged in an inner surface of a rear substrate (not shown) in a display panel in a column direction v orthogonal to each of the groups of surface discharge electrodes. One unit cell (display cell) 5 is formed in an intersecting region of each of the groups of surface discharge electrodes and each of the data electrodes 4a and 4b and groups of these unit cells are arranged in a matrix form in the row direction H and the column direction V. In the case of monochrome display, one pixel is made up of one unit cell and, in the case of color display, one pixel is made up of three unit cells (one emitting a red color R, another emitting a green color G, and another emitting a blue color B).

FIG. 30 is a plan view illustrating the unit cell 5 shown in FIG. 29. In the unit cell 5, as shown in FIG. 30, a scanning electrode 2 and a scanning electrode 3 are arranged above a rib (partition wall, division wall) 7 with a discharge gap being interposed between the scanning electrode 2 and the scanning electrode 3. A bus electrode 2a is mounted on the scanning electrode 2 on a side being opposite to a side of the discharge gap 6 and a bus electrode 3a is mounted on the sustaining electrode 3 on a side being opposite to a side of the discharge gap 6.

FIG. 31 is a cross-sectional view of the unit cell 5 taken along a line A-A in FIG. 30. In the unit cell 5 shown in FIG. 31, a front substrate 11 and a rear substrate 12 are arranged in a manner in which the front substrate 11 faces the rear substrate 12 at a specified interval. The front substrate 11 is made up of a glass substrate or a like and the scanning electrode 2 and the sustaining electrode 3 are arranged on the front substrate 11 so as to be away from each other by a length of a discharge gap 6. Each of the scanning electrode 2 and sustaining electrode 3 is made up of a transparent electrode using an ITO (Indium Tin Oxide) film being a transparent conductive thin film, or a like as materials. The metal bus electrode 2a and the metal bus electrode 3a, both being used to lower line resistance, are formed, respectively, on the scanning electrode 2 and the sustaining electrode 3. A transparent dielectric layer 13 is formed on the scanning electrode 2, sustaining electrode 3, bus electrodes 2a and 3a and, on the transparent dielectric layer 13 is formed a protecting layer 14. The protecting layer 14 is made of magnesium oxide or a like which serves to protect the transparent dielectric layer 13 from discharge.

Also, the rear substrate 12 is made up of a glass substrate or a like and data electrodes 4a and 4b are formed on the rear substrate 12 in a manner in which the data electrodes 4a and 4b are orthogonal to the scanning electrode 2 and the sustaining electrode 3. Moreover, on the data electrodes 4a and 4b is formed a white dielectric layer 15 on which a phosphor layer 16 used to convert an ultraviolet ray being produced by discharge into visible light is formed. The phosphor layer 16 is painted, for example, red (R), green (G), and blue (B) for every unit cell 5 to obtain a color display PDP. Between the front substrate 11 and rear substrate 12 are formed ribs 7 of a parallel cross shape in a manner to surround each of the unit cells 5. The ribs 7 serve to secure discharge space 17 and also to partition a pixel. The discharge space 17 is filled with a mixture gas of He (helium), Ne (neon), Xe (xenon), or a like.

FIG. 32 is a diagram explaining principles of a gray-scale display method employed in the PDP of FIG. 29 in which time is given as abscissa and the numbers of the scanning electrodes in the PDP as ordinate. In the PDP shown in FIG. 32, one field TF (for example, 1/60 seconds) for displaying one screen is divided into four sub-fields SF1, SF2, SF3, and SF4, with weights being assigned to each sub-field according to a gray level, and each sub-field is divided further into four periods, one being a pre-discharging period T1, another being a scanning period T2, another being a sustaining period (sustaining discharge period) T3, and another being a sustaining erasing period (sustaining discharge erasing period) T4. Sloped lines shown in each of the scanning periods T2 in FIG. 32 represent timing with which a scanning pulse is applied, in a one-pass scanning manner, to each of the scanning electrodes 2. Writing discharge occurs when both the scanning pulse and a data pulse to be applied to the data electrodes 4a and 4b are fed at the same time. The sustaining period T3 is a period during which the unit cell 5 emits light for displaying.

During the sustaining period T3, a sustaining pulse is applied alternately to the scanning electrode 2 and sustaining electrode 3 and, in a cell in which discharge occurs during the scanning period T2, light is emitted with strength corresponding to a length (that is, the number of sustaining pulses) of the sustaining period. In FIG. 32, since a ratio of a length of each sustaining period T3 for each of the sub-fields SF1, SF2, SF3, and SF4 is set to be 1:2:4:8, by combining light to be emitted during the sustaining period T3 for each of these sub-fields, a screen of 16 levels of gray (0 to 15) can be displayed. For example, if a screen of 9 levels of gray is displayed, during one field TF, operations are controlled so that light is emitted during the sub-field SF1 (gray level; 1) and during the sub-field SF4 (gray level; 8). In general, when one is divided into n-pieces of the sub-fields, by setting a ratio of luminance in each sub-field to be 1 (=20):2 (=21): . . . :2n−2:2n−1, display of 2n level of gray is made possible.

FIG. 33 is a diagram showing waveforms of pulses for driving to be applied to each electrode during each sub-field shown in FIG. 32. During each sub-field, as shown in FIG. 33, during the pre-discharging period T1, a first pre-discharging pulse “da” of negative polarity relative to a sustaining electrode reference potential is applied to the sustaining electrode 3, a second pre-discharging pulse “db” of positive polarity relative to a scanning electrode reference potential is applied to the scanning electrode 2, a potential exceeding a discharge starting voltage is generated between the sustaining electrode 3 and scanning electrode 2, which causes discharge to forcedly occur in all unit cells 5. The first pre-discharging pulse “da” has a square waveform which causes a voltage to be sharply changed at both a front edge and a rear edge of the pulse. The second pre-discharging pulse “db” has an inclined waveform which causes a voltage to be gently changed at the front edge of the pulse. A change rate at the front edge is set to be smaller than 10 (V/μs).

Then, a pre-erasing discharge pulse “e” of negative polarity relative to the scanning electrode reference potential is applied to the scanning electrode 2, which causes discharge again to forcedly occur in all unit cells 5. The pre-erasing discharge pulse “e” has an inclined waveform which causes a voltage to be gently changed at the front edge of the pulse. The change rate at the front edge is set to be smaller than 10 (V/μs). A discharge operation induced by applications of the pre-discharging pulses “da” and “db” is called “pre-discharge” and the discharge operation induced by the application of a pre-erasing discharge pulse “e” is called “pre-erasing discharge” By the pre-erasing discharge, distribution of wall charges is adjusted and, by application of subsequent other driving pulses, occurrence of erroneous discharge can be prevented. Moreover, by pre-discharge and pre-erasing discharge, an active particle density in each unit cell 5 is increased and a reaction speed at time of subsequent writing discharge is improved.

Following the pre-discharge and pre-erasing discharge, during the scanning period T2, a scanning pulse “f” is applied to the scanning electrodes S1, . . . , Sm, with deviated timing for every electrode. The scanning pulse “f” is of negative polarity relative to a scanning electrode reference potential. A display data pulse “g” is applied with timing when the scanning pulse “f” is applied to data electrodes D1, . . . , Dn according to information to be used for displaying. The display data pulse “g” is of positive polarity relative to a data electrode reference potential. Sloped lines shown in the display data pulse “g” represent that presence or absence of the display data pulse “g” is determined based on presence or absence of information to be used for displaying for a corresponding unit cell 5. In a unit cell 5 in which the display data “g” is fed when the scanning pulse “f” is applied, discharge occurs in the discharge space 17 between the scanning electrode 2 and data electrodes 4a and 4b. However, if the display data pulse “g” is not fed when the scanning pulse “f” is applied, no discharge occurs. Since display information is written into each unit cell 5 by the discharge, this discharge is called “writing discharge”.

Moreover, this writing discharge triggers discharge to occur between the scanning electrode 2 and data electrodes 4a and 4b, which also induces discharge between the scanning electrode 2 and sustaining electrode 3 in some cases. Also, in some cases, in order to get this discharge to occur in a stable manner, by applying a bias potential (that is, a sub-scanning pulse “p”) of positive polarity relative to the sustaining electrode reference potential to the sustaining electrode 3, a potential difference between the scanning electrode 2 and the sustaining electrode 3 at time of writing discharge is made to become larger. Furthermore, in some cases, in order to reduce an amplitude of the scanning pulse “f”, during all periods through the scanning period T2, a bias potential (that is, scanning base pulse “q”) of negative polarity relative to the scanning electrode reference potential is applied to the scanning electrode 2 and a pulse with a potential corresponding to an amount of the change in the amplitude is applied as a scanning pulse “f”. In a unit cell 5 in which writing discharge occurred, positive wall charges have been accumulated on the transparent dielectric layer 13 formed on the scanning electrode 2. At this time, negative wall charges are accumulated on the white dielectric layer 15 formed on the data electrodes 4a and 4b.

Then, during the sustaining period T3, by superimposition of a positive potential generated by positive wall charges formed on the transparent dielectric layer 13 on a potential of the first sustaining pulse “ha” of negative polarity applied to the sustaining electrode 3, the first discharge occurs. Moreover, at time of writing discharge, if discharge between the scanning electrode 2 and sustaining electrode 3 was induced, since negative wall charges have been formed on the transparent dielectric layer 13 on the sustaining electrode 3 by writing discharge, a positive potential generated by positive wall charges formed on the transparent dielectric layer 13 on the scanning electrode 2 and a negative potential generated by negative wall charges formed on the transparent dielectric layer 13 on the sustaining electrode 3 are superimposed on a potential of the first sustaining pulse, the first discharge occurs. When the first discharge has occurred, positive wall charges are accumulated on the transparent dielectric layer 13 on the sustaining electrode 3 and negative wall charges are accumulated on the transparent dielectric layer 13 on the scanning electrode 2. When a potential of a second sustaining pulse “hb” to be applied to the scanning electrode 2 is superimposed on a potential by these wall charges, the second discharge occurs.

Thereafter, similarly, by superimposition of a potential generated by wall charges formed by n-th discharge on a potential of an n+1st sustaining pulse, discharge is maintained. This discharge operation is called “sustaining discharge”. By the number of continued operations of sustaining discharge, luminance in a display screen is controlled. Moreover, by adjusting, in advance, voltages of the sustaining pulses “ha” and “hb” so that no discharge occurs only by the application of these pulses “ha” and “hb”, in the unit cell 5 in which writing discharge did not occur, since a potential by wall charges is not generated before the first application of the sustaining pulse “ha”, the first sustaining discharge does not occur even when the sustaining pulse “ha” is applied and no further sustaining discharge occurs. After the application of the sustaining pulses “ha” and “hb”, during the sustaining erasing period T4, a sustaining erasing pulse “k” of negative polarity relative to a scanning electrode reference potential is applied to all the scanning electrodes 2 and, in the unit cell 5 in which the sustaining discharge continued, discharge occurs and distribution of wall charges is initialized. The sustaining erasing pulse “k” has an inclined waveform which causes a voltage to be gently changed at the front edge of the pulse. A change rate at the front edge is set to be smaller than 10 (V/μs). The discharge operation induced by the sustaining erasing pulse “k” is called “sustaining erasing discharge”.

In the conventional plasma display device described above, when all sub-fields are in a state of being not selected, even if a luminance ratio of a display screen is “0” (zero), that is, even if the screen is in a black display state, during the pre-discharging period T1, light is being emitted by pre-discharge in all the unit cells 5. Since the light emitted by the pre-discharging is weak compared with light emitted by sustaining discharge, luminance in black display is lower than that obtained when the number of sustaining discharge operations is large. However, when a plasma display device is used in a dark environment or when dark images are to be displayed, luminance in black display becomes a factor which degrades quality of a display screen. As an index of representing the quality of a display screen, a display contrast ratio being a ratio of maximum luminance to minimum luminance (that is, black luminance) can be used. If the display contrast ratio is larger, light and darkness can be clearly displayed.

Technologies to improve a display contrast ratio are disclosed in, for example, following patent references. A plasma display device is disclosed in Japanese Patent Application Laid-open No. Hei08-222036 (Abstract, FIG. 1) in which, by employing technology, so-called a “thinning-out” method in which pre-discharge is made to occur only in specified unit cells during every sub-field, minimum luminance, that is, black display luminance is made lower, which enables improvement of the contrast ratio.

In another plasma display device disclosed in Japanese Patent Application Laid-open No. 2002-298742 (FIGS. 1, 2, and 26), a bus electrode is mounted in the vicinity of a discharge gap and an aperture is formed in a transparent electrode and, therefore, a region where pre-discharge occurs is limited within a range of mounting the bus electrode, which causes most of light emitted by pre-discharging to be shielded by the bus electrode and, as a result, though both of maximum luminance and black luminance are lowered, a degree to which black luminance is lowered is larger the degree to which maximum luminance is lowered, as a result, a contrast ratio is improved.

However, the conventional plasma display device described above has a following problem. That is, in the plasma display device as shown in FIG. 29, light-emitting luminance in black display is large, which causes a display contrast ratio to be small.

Also, in the plasma display device disclosed in the Japanese Patent Application Laid-open No. Hei08-222036, in order to lower black display luminance, pre-discharge operations are thinned out However, this method has a problem, that is, during a sub-field during which no pre-discharge is made to occur or in a unit cell in which no pre-discharge is made to occur, occurrence of writing discharge is less stable compared with that of writing discharge during a sub-field during which the pre-discharge was made to occur or in a unit cell in which the pre-discharge was made to occur and, therefore, proper image display cannot be realized. Particularly, in a unit cell in which pre-discharge operations are thinned out continuously in two or more sub-fields, occurrence of writing discharge becomes remarkably unstable, thus causing a flicker in displayed images, occurrence of cells being not lit, or a like.

Moreover, in the plasma display device disclosed in the Japanese Patent Application Laid-open No. 2002-298742, by making a degree to which black luminance is lowered be larger than the degree to which maximum luminance is lowered, a contrast ratio is improved. However, this method has a problem, that is, since a difference between a lowering ratio of maximum luminance and a lowering ratio of black luminance is small, an effect of improving a contrast ratio is small. The reason is that, even if the bus electrode is mounted in the vicinity of a discharge gap and the aperture is formed in the transparent electrode, in some cases, the pre-discharge region extends within the aperture of the transparent electrode and, depending on conditions, across the aperture portion up to an electrode being near to a non-discharge gap, which makes it impossible to limit the pre-discharge region to a small region.

Next, problems with a second conventional technology are described. A third example of a conventional PDP, a conventional method for driving the PDP and a conventional method for controlling luminance of the PDP are described by referring to FIGS. 34 and 35 (for example, Japanese Patent Application Laid-open No. 2002-258794). FIG. 34 is a sectional view partially illustrating a conventional PDP. The PDP shown in FIG. 34 has two insulating substrates 221a and 221b, one acting as a front insulating substrate 221a and another as a rear insulating substrate 221b. On the insulating substrate 221a serving as the front substrate, transparent scanning electrodes 201 and sustaining electrodes 203 are formed and metal trace electrodes 204 used to make low resistance of each of the scanning electrodes 201 and sustaining electrodes 203 are placed on each of the scanning electrodes 201 and each of the sustaining electrodes 203 in a manner in which each of the trace electrodes 204 and each of the scanning electrodes 201 overlap each other and in which each of the trace electrodes 204 and each of the sustaining electrodes 203 overlap each other. A first dielectric layer 209 is formed so that it covers each of the scanning electrodes 201 and each of the sustaining electrodes 203 and then a protecting layer 210 made of magnesium oxide, or a like is formed to prevent the first dielectric layer 209 from discharge.

On the insulating substrate 221b serving as the rear substrate is formed data electrodes 205 extending in a direction orthogonal to the scanning electrodes 201 and sustaining electrodes 203. A second dielectric layer 211 is formed so that it covers the data electrodes 205. On the second dielectric layer 211 are formed ribs (partition wall, division wall) 207 extending in the same direction as the data electrodes 205 and being used to partition a display cell acting as a unit for displaying. Moreover, on side surfaces of the ribs 207 and on surfaces of the dielectric layer 211 having no ribs 207 thereon are formed phosphor layers 208 used to convert an ultraviolet ray produced by discharge of discharge gas into visible light. Space sandwiched between the front insulating substrate 221a and the rear insulating substrate 221b serves as discharge space 206 to be filled with discharge gas consisting of helium, neon, xenon or a like. In the PDP configured as above, surface discharge 200 occurs between each of the scanning electrodes 201 and each of sustaining electrodes 203.

FIG. 35 is a plan view showing the PDP shown in FIG. 34, viewed from a side of a display surface. Two gaps among the scanning electrodes 201 and two sustaining electrodes 203 each being adjacent to each of the scanning electrodes 201, one being the main discharge gap MG in which discharge occurs and another being the non-discharge gap SG in which no discharge occurs. Therefore, a unit display cell 212 is defined by the non-discharge gap SG and the rib 207. The non-discharge gap SG is set to be wider than that of the main discharge gap MG to avoid interference of discharge by unit displaying cells 212 adjacent to each other in up and down directions. Ordinarily, the non-discharge gap SG is about 3 to 5 times longer than the main discharge gap MG in many cases.

Next, various display operations of a display cell to be performed in a selective manner are described. FIG. 36 is a timing chart showing pulses to be applied to each electrode in the conventional method for driving a known plasma display device. In FIG. 36, a period A is a pre-discharging period used to cause discharge to easily occur during a subsequent selective operating period, a period B is the selective operating period during which an ON/OFF operation for displaying in each display cell is selected, a period C is a sustaining period during which discharge for displaying in all display cells selected is made to occur, and a period D is a sustaining erasing period during which discharge for displaying is stopped. Moreover, in the conventional driving method, as a reference potential of surface electrodes consisting of each of the scanning electrodes 201 and each of the sustaining electrodes 203, a sustaining voltage Vos used to sustain discharge during the sustaining period C is employed. Therefore, a voltage of the scanning electrodes 201 and sustaining electrodes 203 being higher than the sustaining voltage Vos are expressed as a voltage of positive polarity and being lower than that are expressed as a voltage of negative polarity. Also, a reference potential of the data electrodes 205 is a ground potential GND (0V).

First, during the pre-discharging period A, a polarity sawtooth-shaped pre-discharging pulse “Pops” of positive polarity is applied to the scanning electrodes 201 and, at the same time, a square pre-discharging pulse “Popc” of negative polarity to the sustaining electrodes 203. A crest voltage of the pre-discharging pulse is set at a voltage exceeding a discharge starting threshold voltage value of the scanning electrodes 201 and sustaining electrodes 203. Therefore, from a time point when a voltage of the sawtooth-shaped pre-discharging pulse “Pops” is boosted by application of the pre-discharging pulses “Pops” and “Popc” respectively to the scanning electrodes 201 and sustaining electrodes 203, which causes a voltage between both the electrodes to exceed the discharge starting threshold voltage, feeble discharge occurs between the scanning electrodes 201 and sustaining electrodes 203. As a result, a negative wall charge is formed on the scanning electrodes 201 and a positive wall charge is formed on the sustaining electrodes 203.

Then, to the scanning electrodes 201, following the application of the pre-discharging pulse “Pops”, a sawtooth-shaped pre-discharging erasing pulse “Pope” of negative polarity is applied. At this point, a potential of the sustaining electrodes 203 is fixed at the sustaining voltage Vos. The wall charges formed on the scanning electrodes 201 and sustaining electrodes 203 are erased by the application of the pre-discharging erasing pulse “Pope”. The process of erasing wall charges performed during the pre-discharging period A includes a process of calibrating the wall charges, which is needed to achieve favorable operations in subsequent processes such as selective operations, sustaining discharge, or a like.

Next, during the selective operating period B, after the scanning electrodes 201 has been held once at a base potential Vobw, a negative-polarity scanning pulse “Pow” is sequentially applied to each of the scanning electrodes 201 and, at the same time, a data pulse “Pod” is applied to the data electrodes 205 according to data to be used for displaying. The application of the scanning pulse “Pow” and data pulse “Pod” is individually controlled for one line by a scanning driver IC and data driver IC both being made up of integrated circuits and both not being shown. While the scanning pulse “Pow” and data pulse “Pod” are being applied, the sustaining electrode 203 is held at a positive-polarity potential Vosw. Moreover, in the facing electrode consisting of the scanning electrodes 201 and the data electrodes 205, the ultimate potential of the scanning pulse “Pow” and of the data pulse “Pod” is so set that, when either of the scanning pulse “Pow” or the data pulse “Pod” is singly applied, a facing electrode voltage between each of the scanning electrodes 201 and each of data electrodes 205 does not exceed a discharge starting threshold voltage and, when voltages of both the scanning pulse “Pow” and data pulse “Pod” are superimposed on each other, the facing electrode voltage exceeds the discharge starting threshold voltage. Also, during the selective operating period B, the potential “Vosw” of the sustaining electrodes 203 is so set that, even when the potential Vosw and the potential of the scanning pulse “Pow” are superimposed on each other, the facing electrode potential difference between the scanning electrodes 201 and the sustaining electrodes 203 does not exceed the discharge starting threshold voltage.

Therefore, only in a display cell in which the data pulse “Pod” has been applied with timing of application of the scanning pulse “Pow”, facing discharge between each of the scanning electrodes 201 and each of the data electrodes 205 occurs. At this point, a potential is produced between the scanning electrodes 201 and sustaining electrodes 203 by application of the voltage of the scanning pulse “Pow” and the voltage of Vosw, which triggers facing discharge to occur between the scanning electrodes 201 and sustaining electrodes 203. This discharge serves as writing discharge. As a result, in the selected display cell, a positive wall charge is formed on the scanning electrodes 201 and a negative wall charge is formed on the sustaining electrodes 203. Then, during the sustaining period C, all the scanning electrodes 201 are held at a sustaining voltage Vos and a first sustaining pulse having its crest voltage being the sustaining voltage Vos and of negative polarity is applied to the sustaining electrodes 203. The sustaining voltage Vos is set at a voltage at which discharge occurs when a wall voltage generated on a surface electrode by writing discharge during the selective operating period B is superimposed on the potential of the sustaining voltage Vos, and at a voltage at which, when there is no superimposition of the wall charge, a surface electrode voltage does not exceed the discharge starting threshold voltage and no discharge occurs accordingly. Therefore, sustaining discharge occurs only in a display cell in which writing discharge has occurred and wall charges have been formed during the selective operating period B. Then, a sustaining pulses “Pos” having its crest voltage being the sustaining voltage Vos and being reversed in phase to one another are applied to the scanning electrodes 201 and sustaining electrodes 203. As a result, sustaining discharge occurs only in a display cell in which discharge has occurred by the first sustaining pulse.

After that, during the sustaining erasing period D, a voltage of each of the sustaining electrodes 203 is fixed at the sustaining voltage Vos and a negative-polarity sawtooth-shaped sustaining erasing pulse “Poe” is applied to the scanning electrodes 201. By these processes, wall charges on the surface electrode are erased and the charged states return back to their initial states where no charges are formed, that is, to the states before the pre-discharging pulses “Pops” and “Popc” were applied during the pre-discharging period A. The process of erasing wall charges performed during the sustaining erasing period D includes a process of calibrating the wall charges which is needed to achieve favorable operations in subsequent processes.

Here, the method in which the selective operating period had been separated from the sustaining period in terms of time was described above. However, other methods can be employed, that is, a method in which these periods are mixed in terms of time may be employed. Even in that case, from a viewpoint of an individual display cell, the other methods are the same as that described above in that selective operations are performed following operations performed during the pre-discharging period and then operations during the sustaining period are performed.

Next, a method for controlling luminance in the conventional plasma display device disclosed in, for example, Japanese Patent Application Laid-open No. 2002-042661. In the conventional plasma display device, in order to make gray-level display of an image, a sub-field method is employed. The reason for this is that, in an AC (Alternating Current)-type plasma display device, modulation of light-emitting display luminance by a voltage is difficult and changing of a number of light-emitting times is required for the modulation of the luminance. In the sub-field method, one piece of a gray-scale image is decomposed into two or more binary display images which are displayed at a high speed and which are then reproduced as images having multi-gray shades by an integration effect of vision. One piece of an image is displayed ordinarily at a speed of 1/60 seconds which is called “one field”. When images are to be displayed in 8-bit 256 shades of gray, one field is divided into 8 sub-fields (SFs) and luminance is given to each of the sub-fields at a rate of 1:2:4:8:16:32:64:128. This makes it possible to display images in shades of gray by selecting an SF during which light is emitted according to a luminance level of an input signal. Each SF includes periods from the pre-discharging period A to the sustaining erasing period D and luminance of each SF can be set by changing a number of sustaining cycles during the sustaining period C. In some cases, the pre-discharging period A is excluded depending on a driving form. Moreover, a method is available in which the number of sub-fields to be divided is made larger than a number of bits of gray scale to provide redundancy (for example, as disclosed in Japanese Patent Application Laid-open No. 2000-322025). This is effective in suppressing a moving image pseudo contour which is a hindrance to a display being peculiar to the PDP.

In the PDP having configurations described above, luminance used for displaying is proportional to a number of discharge operations to be repeated during one field, that is, to a number of sustaining pulse operations and light-emitting luminance to be obtained by one time sustaining pulse operation. Ordinarily, time for one field is 1/60 seconds. On the other hand, if the number of sub-fields is increased with an aim of suppressing the moving image pseudo contour, time to be used for selective operations increases and, as a result, time that can be used during the sustaining period relatively decreases. Due to this, in order to improve display luminance, light-emitting luminance that can be obtained from one time sustaining pulse operation has to be enhanced. The light-emitting luminance that can be obtained from the one time sustaining pulse operation (this light-emitting luminance is called a “unit light-emitting luminance” in this is specification) is proportional to an amount of currents that flow by discharge. Moreover, a discharge current is proportional to areas of the scanning electrodes and sustaining electrodes that cause surface discharge to occur. More exactly, the discharge current is proportional to electrostatic capacity formed between the scanning electrodes and/or sustaining electrodes and a protecting layer. However, no problem occurs if the discharge current is considered to be proportional of areas of electrodes. Therefore, to improve display luminance, areas of electrodes have to be made larger.

However, in the PDP having such the configurations as shown in FIG. 35, if areas of the electrodes are widened to enhance luminance, the non-discharge gap SG inevitably becomes narrow. If the non-discharge gap SG becomes narrow, discharge interference between display cells 112 being adjacent to one another in up and down directions in FIG. 35 becomes intense which causes operations to become unstable and, therefore, it is impossible that the electrode areas are made so wide.

Next, configurations of a PDP proposed to solve above problems are described. FIG. 37 is a plan view showing a second conventional PDP viewed from a side of a display surface (as disclosed in, for example, Japanese Patent Application Laid-open No. 2002-042661). All components of the PDP are not shown in FIG. 37, however, basic components of the PDP shown in FIG. 37 are the same as that of the first conventional PDP shown in FIG. 34 and same reference numbers are assigned to components having the same function as in the third conventional PDP.

The PDP of the conventional display panel differ greatly from that in the first conventional display panel in that the ribs 207 are formed not only in a direction orthogonal to a direction in which the scanning electrode 201 or the sustaining electrode 203 extends, but also in a direction being parallel to the direction in which the scanning electrodes 201 or the sustaining electrodes 203 extend, which provides the ribs 207 of a parallel cross shape. By configuring as above, discharge interference occurring among display cells 212 being adjacent to one another in an up and down direction and the electrode areas can be made larger and in that the scanning electrodes 201 and sustaining electrodes 203 are so formed that an arranging order of the scanning electrodes 201 and sustaining electrodes 203 is interchanged for every display line. The aim of the interchange in the arranging order is to reduce a capacitive component produced by the scanning electrodes 201 and sustaining electrodes 203 in the display cells 212 being adjacent to one another.

Moreover, a conventional PDP having a structure in which a change in display luminance by electrode areas is positively utilized is available. FIG. 38 is a plan view of a third conventional PDP viewed from a side of a display surface (as disclosed in, for example, Japanese Patent Application Laid-open No. Hei07-312178). As shown in FIG. 38, the scanning electrode 201 is divided into a first portion 201a and a second portion 201b and the sustaining electrode 203 is divided into a first portion 203a and a second portion 203b. By getting discharge to occur by using selectively the electrode portion, it is made possible to change an effective electrode area and to calibrate luminance.

As described above, when an electrode area is increased to enhance luminance, as a result, a discharge current also increases It is natural that a discharge current increases in sustaining discharge. However, even in writing discharge during the selective operating period B, a discharge current increases. However, the scanning pulse “Pow” to cause writing discharge to occur is applied by using a scanning driver IC being an integrated circuit and, therefore, a current capacity of the scanning driver IC is comparatively small, and if an amount of the current increases, a big voltage drop occurs. If the voltage drop occurs, a problem arises in that an effective potential among electrodes can not be produced, which causes the writing discharge to be unstable and a display of an image to be unstable accordingly.

Moreover, since the trace electrode 204 has an electrical resistance of a finite value, as an amount of currents increases, a voltage drop caused by the trace electrodes 204 occurs. The voltage drop caused by the trace electrodes 204 is proportional to a distance from an electrode taking section and, therefore, the voltage drop is large in a portion being far from the electrode voltage taking section. Due to this, distribution occurs in voltages applied within a face of the display panel, which reduces an operating margin and, as a result, operations easily become fixed, thus causing reduction in a yield.

Also, another problem is that an increase in current capacity of the scanning driver IC induces a rise in its prices and an increase in currents leads to high costs.

Not only the increase in an amount of currents but also a widened discharge region presents a problem related to a driving characteristic. In the conventional panel driving technology, charge calibration such as charge erasing, charge initialization or a like is performed by using an inclined wave. The charge calibration using the inclined wave is performed by causing a feeble discharge of positive polarity to occur in the vicinity of a discharge gap portion. Such the charge calibration is an effective method in that a difference in characteristics can be accommodated for every display cell.

However, since discharge occurs only in the discharge gap, the charge calibration is performed only in the vicinity of the discharge gap. On the other hand, as shown in FIG. 37, when charges are formed even in portions being far from the discharge gap, big charges are formed by sustaining discharge even in the portion being far from the discharge gap. Since wall charges formed in the portion being far from the discharge gap are not changed by the inclined wave, operations move, with charges being accumulated, from a subsequent selective operating period B to the sustaining period C. In the vicinity of the discharge gap, since charge calibration is performed, erroneous discharge caused by wall charges in portions being far from the discharge gap does not occur in ordinary cases. However, if feeble discharge occurs due to some reasons, a problem arises in that the discharge is easily changed to erroneous discharge due to the accumulated wall charges, which becomes one of factors that disturbs stability in displaying images.

### SUMMARY OF THE INVENTION

In view of the above, it is a first object of the present invention to provide a plasma display device capable of obtaining a high-quality display screen by lowering light-emitting luminance in black display to improve a contrast ratio. It is a second object of the present invention to provide a plasma display device capable of reducing discharge currents that flow by writing discharge without lowering display luminance and of minimizing occurrence of erroneous discharge.

According to a first aspect of the present invention, there is provided a plasma display device including:
a plasma display panel; and
a driving unit to drive the plasma display panel by dividing one field for a display screen into two or more sub-fields
with weights being assigned to each sub-field according to a gray level;
wherein the plasma display panel includes:
a first substrate and a second substrate arranged in a manner in which the first substrate faces the second substrate;
two or more pairs of main electrodes, each pair being made up of a scanning main electrode and a sustaining main electrode and being formed on a surface of the first substrate being opposite to the second substrate in parallel to each other with a discharge gap being interposed between the scanning main electrode and the sustaining main electrode;
two or more pairs of extended electrodes, each pair being made up of a scanning extended electrode formed on a side being opposite to a discharge gap relative to the scanning main electrode with a specified interval being interposed between the scanning main electrode and the scanning extended electrode and a sustaining extended electrode formed on a side being opposite to the discharge gap relative to the sustaining main electrode with a specified interval being interposed between the sustaining main electrode and the sustaining extended electrode;
two or more data electrodes formed on a surface of the second substrate being opposite to the first substrate in a manner to be orthogonal to each of the pairs of main electrodes and each of the pairs of extended electrodes;
two or more unit cells formed, in a manner to be surrounded by ribs, at intersecting regions of the two or more pairs of main electrodes and the two or more pairs of extended electrodes and the two or more data electrodes;
discharge space containing each of the two or more unit cells being formed between the first substrate and second substrate with discharge gas being filled; and
a light shielding unit to shield most of light emitted by the scanning main electrode and the sustaining main electrode;
wherein, during every sub-field, the driving unit to cause pre-discharge to occur in all unit cells, by applying a pre-discharging pulse only to the scanning main electrode and the sustaining main electrode and not to the scanning extended electrode and sustaining extended electrode and to cause address discharge to occur in a selected unit cell by applying a scanning pulse in a one-pass scanning manner to each scanning main electrode and simultaneously by applying a display data pulse, in synchronization with the scanning pulse, to each of data electrodes and, to cause sustaining discharge to occur in each selected unit cell by applying all or a greater part of a sustaining pulse alternately to the scanning extended electrode and sustaining extended electrode.

In the foregoing, a preferable mode is one wherein the driving unit is so constructed that, when the sustaining pulse is applied to the scanning extended electrode and the sustaining extended electrode, the sustaining pulse is simultaneously to the scanning main electrode and the sustaining main electrode.

Also, a preferable mode is one wherein the scanning main electrode or the sustaining main electrode is constructed by stacking a metal bus electrode on a transparent electrode and wherein a width of the bus electrode being stacked on the main electrode or the sustaining main electrode is set to be smaller than a width of corresponding the transparent electrode and to be more than half of that of the transparent electrode and wherein the bus electrode makes up the light shielding unit.

Also, a preferable mode is one wherein the scanning main electrode or sustaining main electrode is constructed only of the metal bus electrode and the bus electrode makes up the light shielding unit.

Also, a preferable mode is one wherein at least in a region containing the discharge gap, a black dielectric layer is formed which shields light emitted by the scanning main electrode and the sustaining main electrode.

Also, a preferable mode is one wherein at least one of two scanning extended electrodes or two sustaining extended electrodes contained in unit cells being adjacent to one another in up and down directions is electrically connected to at least one of another scanning extended electrodes or another sustaining extended electrodes.

Also, a preferable mode is one wherein one bus electrode is formed in a center portion of the two scanning extended electrodes being electrically connected and integrated or the two sustaining extended electrodes being electrically connected and integrated.

Also, a preferable mode is one wherein the two scanning extended electrodes being electrically connected and integrated or the two sustaining extended electrodes being electrically connected and integrated are electrically connected via a connection unit which passes through a central line of the unit cell.

Also, a preferable mode is one wherein the two scanning extended electrodes being electrically connected and integrated or the two sustaining extended electrodes being electrically connected and integrated are electrically connected via a connection unit formed above a rib surrounding the unit cell.

According to a second aspect of the present invention, there is provided a method for driving a plasma display device having a plasma display panel and a driving unit to drive the plasma display panel by dividing one field for a display screen into two or more sub-fields with weights being assigned to each sub-field according to a gray level, the method including:
a step of constructing the plasma display panel of a first substrate and a second substrate arranged in a manner in which the first substrate faces the second substrate, two or more pairs of main electrodes each pair being made up of a scanning main electrode and a sustaining main electrode being formed on a surface of the first substrate being opposite to the second substrate in parallel to each other with a discharge gap interposed between the scanning main electrode and the sustaining main electrode, two or more pairs of extended electrodes each pair being made up of a scanning extended electrode formed on a side being opposite to a discharge gap relative to the scanning main electrode with a specified interval being interposed between the scanning main electrode and the scanning extended electrode and a sustaining extended electrode formed on a side being opposite to the discharge gap relative to the sustaining main electrode with a specified interval being interposed between the sustaining main electrode and the sustaining extended electrode, two or more data electrodes formed on a surface of the second substrate being opposite to the first substrate in a manner to be orthogonal to each of the pairs of main electrodes and each of the pairs of extended electrodes, two or more unit cells formed, in a manner to be surrounded by partition walls at intersecting regions between the two or more pairs of main electrodes and the two or more pairs of extended electrodes and the two or more data electrodes, discharge space containing each of the two or more unit cells being formed between the first substrate and second substrate with discharge gas being filled, and a light shielding unit to shield most of light emitted by the scanning main electrode and the sustaining main electrode; and
a step of getting the driving unit to cause pre-discharge to occur in all unit cells, during every sub-field, by applying a pre-discharging pulse only to the scanning main electrode and the sustaining main electrode and not to the scanning extended electrode and sustaining extended electrode and to cause address discharge to occur in a selected unit cell by applying a scanning pulse in a one-pass scanning manner to each scanning main electrode and simultaneously by applying a display data pulse, in synchronization with the scanning pulse, to each of data electrodes and to cause sustaining discharge to occur in each selected unit cell by applying all or a greater part of a sustaining pulse alternately to the scanning extended electrode and sustaining extended electrode.

According to a third aspect of the present invention, there is provided a plasma display device including:
two or more first electrodes; and
two or more second electrodes each having a gap being interposed between each of the first electrodes and each of the second electrodes;
wherein a display is made by discharge made to occur between each of the first electrodes and each of the second electrodes and wherein each of the first electrodes has a first portion and a second portion wherein the first portion of each of the first electrodes is used for selective discharge to select a state of being displayed or not being displayed and the second portion of each of the second electrodes is not used for the selective discharge to select a state of being displayed or not being displayed.

In the foregoing, a preferable mode is one wherein each of the second electrodes has a first portion and a second portion and wherein the first portion of each of the second electrodes is used for the selective discharge to select a state of being displayed or not being displayed and the second portion of each of the second electrodes is not used for the selective discharge to select a state of being displayed or not being displayed. In the above description, the first portion is electrically separated from the second portion. The number of divided portions is not limited to two. Moreover, by dividing either or both of the first electrodes and second electrodes, currents that flow by writing discharge and, as a result, a voltage drop in writing discharge is suppressed, which enables stable writing operations to be performed in various states for displaying. In the present invention, there is an advantage in that, since currents that flow by sustaining discharge do not decrease, display luminance is not reduced.

According to a fourth aspect of the present invention, there is provided a plasma display device including:
a first substrate and a second substrate in a manner in which the first substrate faces the second substrate;
two or more first electrodes being formed on a surface side of the first substrate being opposite to the second substrate and extending in parallel to one another in a row direction;
two or more second electrodes formed in parallel to the two or more first electrodes with a main discharge gap in which discharge for displaying is made to occur being sandwiched between each of the first electrodes and each of the second electrodes;
two or more third electrodes being formed on a surface side of the second substrate being opposite to the first substrate and extending in a column direction being orthogonal to a direction in which the first electrodes extend; and
two or more display cells each being defined by an intersecting region among each of the first electrodes, each of the second electrodes, and each of the third electrodes;
wherein each of the first electrodes has a first portion and a second portion and wherein the first portion of each of the first electrodes is used for selective discharge to select a state of being displayed or not being displayed and the second portion of each of the first electrodes is not used for selective discharge to select a state of being displayed or not being displayed.

In the foregoing, a preferable mode is one wherein each of the second electrodes has a first portion and a second portion wherein the first portion of the second electrodes is used for selective discharge to select a state of being displayed or not being displayed and the second portion of the second electrodes is not used for selective discharge to select a state of being displayed or not being displayed.

Also, a preferable mode is one wherein each of display lines is formed by a pair of each of the two or more first electrodes and each of the second electrodes and the first and second electrodes are so constructed that an arranging order of each of the first electrodes and each of the second electrodes is interchanged for every display line and wherein, in the display lines being adjacent to one another, at least one of second portions, being adjacent to one another, of each of the first electrodes is electrically connected to at least one of second portions, being adjacent to one another, of each of the second electrodes.

Also, a preferable mode is one wherein ribs to maintain gaps between the first and second substrates are formed in boundaries of the display lines and each of the second portions of the first electrodes and each of the second portions of the second electrodes both being electrically connected to one another in the display lines being adjacent to one another has a high resistance electrode portion having a visible light transmittance and a low resistance electrode portion not having the visible light transmittance and wherein at least part of each of the low resistance electrode portion not having the visible light transmittance and each of the ribs formed in boundaries of the display lines overlap each other.

Also, a preferable mode is one wherein each of the first portions of each of first electrodes and each of the first portions of each of the second electrodes are formed in a manner in which a main discharge gap is sandwiched between each of the first portions of each of the first electrodes and each of the first portions of each of the second electrodes and wherein each of the second portions of each of the first electrodes is formed on a side being opposite to the main discharge gap on each of the first portion of each of the first electrodes and each of the second portions of each of the second electrodes is formed on a side being opposite to the main discharge gap on each of the first portions of each of the second electrodes.

According to a fifth aspect of the present invention, there is provided a method for driving a plasma display device having a first substrate and a second substrate both being arranged so as to face each other, two or more first electrodes being formed on a surface side of the first substrate being opposite to the second substrate and extending in parallel to one another in a row direction and each being divided into, at least, a first portion and a second portion, two or more second electrodes formed in parallel to the first electrodes with a main discharge gap in which discharge for displaying is made to occur being sandwiched between each of the first electrodes and each of the second electrodes, two or more third electrodes being formed on a surface side of the second substrate being opposite to the first substrate and extending in a column direction being orthogonal to a direction in which the first electrodes extend, and two or more display cells being defined by an intersecting region among each of the first electrodes, each of the second electrodes, and each of the third electrodes, the method including:
a step of getting discharge that controls presence or absence of light emission in the display cells to occur by applying a first selected pulse to each of the electrodes having an independent input for every line; and
a step of getting discharge that emits light for displaying to occur by continuously applying a sustaining pulse between each of the first electrodes and each of the second electrodes,
wherein the first selected pulse is applied to each of the first portion of each of the first electrodes and the sustaining pulse is applied to each of the first portions and the second portions of each of the first electrodes.

In the foregoing, a preferable mode is one wherein the process of getting discharge that controls presence or absence of light emission in the display cells to occur includes a step of getting discharge to occur between each of the first electrodes and each of the third electrodes and a step of getting discharge to occur between each of the first electrodes and each of the second electrodes.

Also, a preferable mode is one wherein each of the second electrodes is divided into a first portion and a second portion and the step of getting discharge to occur between each of the first electrodes and each of the third electrodes includes a step of getting discharge between the first portion of each of the first electrodes and the first portion of each of the second electrodes.

Also, a preferable mode is one wherein a gray scale expression is made by setting two or more sub-field periods during one of which discharge that controls presence or absence of light emission in display cells is made to occur, discharge that emits light for displaying is made to occur by continuously applying a sustaining pulse between each of the first electrodes and each of the second electrodes in one field period during which one piece of an image is displayed and by combining selection of the sub-field periods and wherein, during at least one of the sub-field periods contained in the field period, the first selected pulse is applied to each of the first portions of each of the first electrodes and the sustaining pulse is applied to each of the first portions and second portions of each of the first electrodes and, during at least the sub-field period, the first selected pulse is applied to each of the first portions of each of the first electrodes and the sustaining pulse is applied to each of the first portions of each of the first electrodes.

Also, a preferable mode is one wherein the sub-field period during which the sustaining pulse is applied to each of the first portions of each of the first electrodes is a sub-filed period during which sustaining discharge is made to occur once.

Also, a preferable mode is one wherein the sub-field during which the sustaining pulse is applied to each of the first portions of each of the first electrodes is a sub-field during which a minimum luminance is expressed.

Also, a preferable mode is one wherein a gray scale expression is made by setting two or more sub-field periods during one of which discharge that controls presence or absence of light emission in display cells is made to occur, discharge that emits light for displaying is made to occur by continuously applying a sustaining pulse between each of the first electrodes and each of the second electrodes in one field period during which one piece of an image is displayed and by combining selection of the sub-field periods, wherein, during at least one of the sub-field periods contained in the field period, the first selected pulse is applied to each of the first portions of each of the first electrodes and the sustaining pulse is applied to each of the first and second portions of each of the first electrodes and during at least one of the sub-field periods, the first selected pulse is applied to each of the first portions of each of the first electrodes and a sustaining pulse is not applied.

Also, a preferable mode is one wherein the sub-field during which the sustaining pulse is not applied is a sub-field during which a minimum luminance is expressed.

Also, a preferable mode is one wherein each of the first portions of each of the first electrodes and each of the first portions of each of the second electrodes are formed in a manner in which the main discharge gap is sandwiched by each of the first portions of each of the first electrodes and each of the first portions of each of the second electrodes and each of the second portions of each of the first electrodes is formed on a side being opposite to the main discharge gap on each of the first portion of each of the first electrodes and each of the second portions of each of the second electrodes is formed on a side being opposite to the main discharge gap on each of the first portions of each of the second electrodes and at least one final sustaining pulse out of the sustaining pulses continuously applied is set so that a potential difference between each of the second portions of each of the first electrodes and each of the second portions of each of the second electrodes is lower than a potential difference between each of the first portions of each of the first electrodes and each of the first portions of each of the second electrodes and each of the first portions of each of the first electrodes.

Also, a preferable mode is one wherein each of the first portions of each of the first electrodes and each of the first portions of each of the second electrodes are formed in a manner in which the main discharge gap is sandwiched by each of the first portions of each of the first electrodes and each of the first portions of each of the second electrodes and each of the second portions of each of the first electrodes is formed on a side being opposite to the main discharge gap on each of the first portion of each of the first electrodes and each of the second portions of each of the second electrodes is formed on a side being opposite to the main discharge gap on each of the first portions of each of the second electrodes and at least one final sustaining pulse out of the sustaining pulses continuously applied is set so that a potential difference between each of the second portions of each of the first electrodes and each of the second portions of each of the second electrodes is larger than a potential difference between each of the first portions of each of the first electrodes and each of the first portions of each of the second electrodes and each of the first portions of each of the first electrodes.

According to a sixth aspect of the present invention, there is provided a plasma display device having a first substrate and a second substrate both being arranged so as to face each other, two or more first electrodes being formed on a surface side of the first substrate being opposite to the second substrate and extending in parallel to one another in a row direction and each being divided into, at least, a first portion and a second portion, two or more second electrodes formed in parallel to the first electrodes with a main discharge gap in which discharge for displaying is made to occur being sandwiched between each of the first electrodes and each of the second electrodes and each being divided into, at least, a first portion and a second portion, two or more third electrodes being formed on a surface side of the second substrate being opposite to the first substrate and extending in a column direction being orthogonal to a direction in which the first electrodes extend, and two or more display cells being defined by an intersecting region among each of the first electrodes, each of the second electrodes, and each of the third electrodes, the plasma display device configured:
to get discharge that controls presence or absence of light emission in the display cells to occur between each of the first portions of each of the first electrodes and each of the third electrodes and between each of the first portions of each of the first electrodes and each of the first portions of each of the second electrodes by applying a first selected pulse to each of the first portions of each of the first electrodes having an individual input for every row and by applying a second selected pulse selectively to each of the third electrodes having an individual input for every column; and
to discharge that emits light for displaying to occur by continuously applying a sustaining pulse between each of the first electrodes containing each of the first and second portions and each of the second electrodes containing each of the first and second portions.

With the above configurations, during every sub-field, a pre-discharging pulse to cause pre-discharge to occur in all unit cells is applied only to the scanning main electrode and sustaining main electrode and is not applied to the scanning extended electrode and sustaining extended electrode and address discharge is made to occur in a unit cell selected by applying a scanning pulse in a one-pass scanning manner to each scanning main electrode and, at the same time, by applying a display data pulse, in synchronization with the scanning pulse, to each of data electrodes and sustaining discharge is made to occur in each unit cell selected by applying all or a greater part of a sustaining pulse alternately to the scanning extended electrode and sustaining extended electrode and, further, a light shielding unit to shield most of light emitted by the scanning main electrode and sustaining main electrode is mounted and, therefore, a region where the pre-discharge occurs is completely limited to a region being sandwiched between the scanning main electrode and sustaining main electrode and light emitted by discharge in the pre-discharging region is shielded by the light shielding unit, which prevents most of light emitted by the pre-discharge from being emitted to a display side and which, as a result, makes black luminance caused by light emitted by the pre-discharge be made very low and which can improve a contrast ratio greatly.

With another configuration as above, light emitted in a portion of the discharge gap is shielded by the black dielectric layer and, therefore, almost all light emitted by the pre-discharge is shielded. As a result, black luminance caused by light-emitting luminance in pre-discharge becomes low to a degree to which the black luminance can not be recognized visually and the contrast ratio of a display screen can be improved. Moreover, most of the regions of the scanning main electrode and sustaining main electrode is light-shielded by the black dielectric layer and therefore it is not necessary that a width of the bus electrode used for light-shielding is expanded up to a width being the same as that of the scanning main electrode and sustaining main electrode. As a result, when a width of the bus electrode is determined, considerations have to be given only to electrical resistance in the electrode, which can widen a freedom of designing. When the black dielectric layer is formed only in a region of the discharge gap, an area needed to form the black dielectric layer can be made small, which enables reduction in materials.

With still another configuration as above, at least one of the two electrically integrated scanning extended electrodes is electrically connected, in an integrated manner, to at least one of two electrically integrated sustaining extended electrodes formed in unit cells being adjacent to one another in up and down directions and, therefore, the number of terminals for connection to the scanning extended electrode can be reduced. Moreover, in a center portion between the two integrated scanning extended electrodes or between the two integrated sustaining extended electrodes is formed one piece of the bus electrode and, therefore, an influence by shielding of light emitted by sustaining discharge is suppressed and, as a result, a rate of efficiency of taking out light emitted by sustaining discharge can be improved. Furthermore, the two electrically connected and integrated scanning extended electrodes or the two electrically connected and integrated sustaining extended electrodes are connected to one another through the connection section formed above the rib surrounding the unit cell and, therefore, an influence by shielding of light emitted by sustaining discharge is suppressed and a rate of efficiency of taking out light emitted by the sustaining discharge can be improved.

With still another configuration as above, only currents that flow by writing discharge can be reduced, which enables a voltage drop caused by writing discharge to be suppressed and stable writing operations to be performed in various display states. At this point, since no currents in sustaining discharge decrease, display luminance is not lowered.

With still another configuration as above, a low-cost scanning driver IC having small current capacity can be used, manufacturing costs can be reduced. Since accumulation of unwanted wall charge can be suppressed, hindrance to displaying caused by erroneous discharge can be suppressed. Time of occurrence of hindrance to displaying caused by secular changes in driving voltage characteristics can be delayed. That is, the plasma display device being capable of maintaining a high-quality display for a long time can be provided at low costs.

With still another configurations, the present invention can be applied to entire plasma display devices in which improvements in a contrast ratio in a display screen are demanded.

### BRIEF DESCRIPTION OF THE DRAWINGS

The above and other objects, advantages, and features of the present invention will be more apparent from the following description taken in conjunction with the accompanying drawings in which:

FIG. 1 is a schematic block diagram showing electrical configurations of a plasma display device according to a first embodiment of the present invention;

FIG. 2 is a diagram illustrating a PDP drawn from FIG. 1;

FIG. 3 is a plan view showing configurations of a unit cell shown in FIG. 2.

FIG. 4 is a cross-sectional view of the unit cell taken along a line A-A of FIG. 3;

FIG. 5 is a diagram of waveforms of pulses to be applied to each electrode to explain operations of the plasma display device of FIG. 1;

FIG. 6 is a table explaining a result showing improvements in a contrast ratio according to the first embodiment of the present invention;

FIG. 7 is a plan view illustrating configurations of a unit cell of a PDP according to a second embodiment of the present invention;

FIG. 8 is a cross-sectional view of the unit cell taken along a line A-A of FIG. 7;

FIG. 9 is a plan view illustrating configurations of a unit cell of a PDP according to a third embodiment of the present invention.

FIG. 10 is a cross-sectional view of the unit cell taken along a line A-A of FIG. 9.

FIG. 11 is a diagram illustrating configurations of a PDP according to a fourth embodiment of the present invention;

FIG. 12 is a diagram illustrating configurations of a unit cell shown in FIG. 11;

FIG. 13 is a diagram showing a modified example of the fourth embodiment of the present invention;

FIG. 14 is a diagram showing another modified example of the fourth embodiment of the present invention;

FIG. 15 is a diagram showing still another modified example of the fourth embodiment of the present invention;

FIG. 16 is a plan view of a plasma display device of a fifth embodiment of the present invention;

FIG. 17 is a schematic block circuit diagram showing connection among electrodes and driving circuits of the fifth embodiment of the present invention;

FIG. 18 is a timing chart showing a method for driving the plasma display device of the fifth embodiment of the present invention;

FIG. 19 is a plan view of a plasma display device of a sixth embodiment of the present invention;

FIG. 20 is a schematic block circuit diagram showing connection among electrodes and driving circuits of the sixth embodiment of the present invention;

FIG. 21 is a timing chart showing a method for driving the plasma display device of the sixth embodiment of the present invention;

FIG. 22 is a plan view of a plasma display device of a seventh embodiment of the present invention;

FIG. 23 is a circuit block diagram showing connections between each electrode and a driving circuit of the seventh embodiment of the present invention;

FIG. 24 is a timing chart showing a method for driving a plasma display device of an eighth embodiment of the present invention;

FIGS. 25A, 25B, and 25C are cross-sectional views illustrating a display panel with wall charges formed therein in the plasma display device of the eighth embodiment of the present invention;

FIGS. 26A, 26B, and 26C are cross-sectional views illustrating a display panel with wall charges formed therein in the plasma display device of the seventh embodiment of the present invention;

FIG. 27 is a timing chart showing a method for driving a plasma display device of a ninth embodiment of the present invention;

FIG. 28 is a timing chart showing a method for driving a plasma display device of a tenth embodiment of the present invention;

FIG. 29 is a plan view schematically illustrating an arrangement of electrodes of a PDP used in a conventional plasma display device;

FIG. 30 is a plan view illustrating a unit cell shown in FIG. 29;

FIG. 31 is a cross-sectional view of the unit cell taken along a line A-A in FIG. 30.

FIG. 32 is a diagram explaining principles of a gray-scale display method employed in the PDP of FIG. 29;

FIG. 33 is a diagram showing waveforms of pulses for driving to be applied to each electrode during each sub-field of FIG. 32;

FIG. 34 is a sectional view partially illustrating a panel structure of a known plasma display device;

FIG. 35 is a plan view schematically showing a panel structure of the known plasma display device shown in FIG. 34;

FIG. 36 is a timing chart explaining a conventional method for driving a known plasma display device;

FIG. 37 is a plan view illustrating configurations of a panel structure of a known plasma display device; and

FIG. 38 is a plan view showing a panel structure of a known plasma display device.

### DETAILED DESCRIPTION OF THE PREFERRED EMBODIMENTS

Best modes of carrying out the present invention will be described in further detail using various embodiments with reference to the accompanying drawings. In the embodiment, black luminance is lowered by limiting a region where pre-discharge occurs to a narrow range to lower light-emitting luminance by pre-discharge, which improves a contrast ratio, thus achieving a high-quality display screen of a plasma display device of the present invention.

### First Embodiment

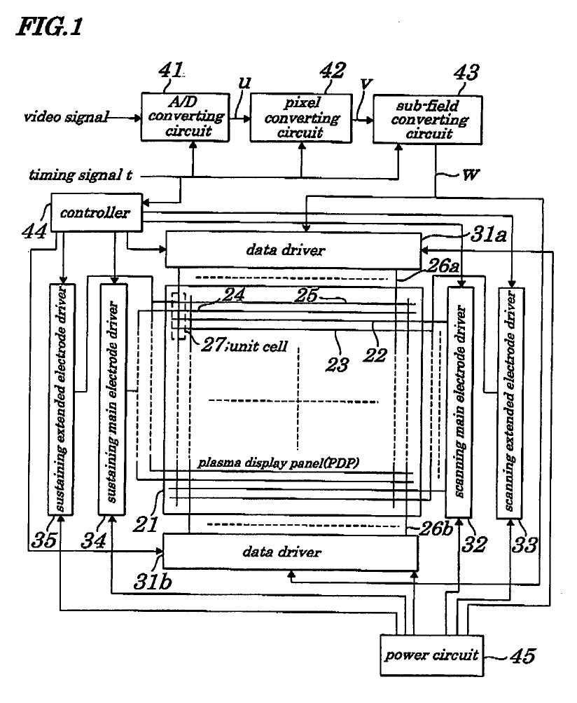

FIG. 1 is a schematic block diagram showing electrical configurations of a plasma display device according to a first embodiment of the present invention. The plasma display device of the first embodiment, as shown in FIG. 1, includes a plasma display panel (PDP) 21, data drivers 31a and 31b, a scanning main electrode driver 32, a scanning extended electrode driver 33, a sustaining main electrode driver 34, a sustaining extended electrode driver 35, an A/D (Analog/Digital) converting circuit 41, a pixel converting circuit 42, a sub-field converting circuit 43, a controller 44, and a power circuit 45.

In the PDP 21, a front substrate (not shown) and a rear substrate (not shown) are arranged in a manner in which the front substrate faces the rear substrate. On a surface of the front substrate facing the rear substrate, a scanning main electrode 22 and a sustaining main electrode 24 are arranged in parallel to each other with a discharge gap (not shown) being interposed between the scanning main electrode 22 and the sustaining main electrode 24. The scanning main electrode 22 and sustaining main electrode 24 make up a pair of main electrodes. On a side being opposite to a discharge gap relative to the scanning main electrode 22 is formed a scanning extended electrode 23 with a specified interval being interposed between the scanning main electrode 22 and scanning extended electrode 23 and on a side being opposite to the discharge gap relative to the sustaining main electrode 24 is formed a sustaining extended electrode 25 with a specified interval being interposed between the sustaining main electrode 24 and the sustaining extended electrode 25. The scanning extended electrode 23 and the sustaining extended electrode 25 make up a pair of extended electrodes. On a surface of the rear substrate facing the front substrate are formed two or more data electrodes 26a and 26b in such a manner to intersect various kinds of main electrodes and various kinds of extended electrodes. A unit cell 27 is formed at each of intersecting regions of each of two or more pairs main electrodes and each of two or more pairs of extended electrodes and a plurality of data electrodes 26a and 26b.

The data driver 31a applies a display data pulse and an erasing data pulse both corresponding to display data “W” to the data electrode 26a. The data driver 31b applies a display data pulse and an erasing data pulse both corresponding to display data “W” to the data electrode 26b. The scanning main electrode driver 32 applies a pre-discharging pulse, pre-erasing discharge pulse, scanning pulse, sustaining pulse, and sustaining erasing pulse to the scanning main electrode 22. The scanning extended electrode driver 33 applies a sustaining pulse and sustaining erasing pulse to the scanning extended electrode 23. The sustaining main electrode driver 34 applies a pre-discharging pulse and sustaining pulse to the sustaining main electrode 24. The sustaining extended electrode driver 35 applies a sustaining pulse to the sustaining extended electrode 25.

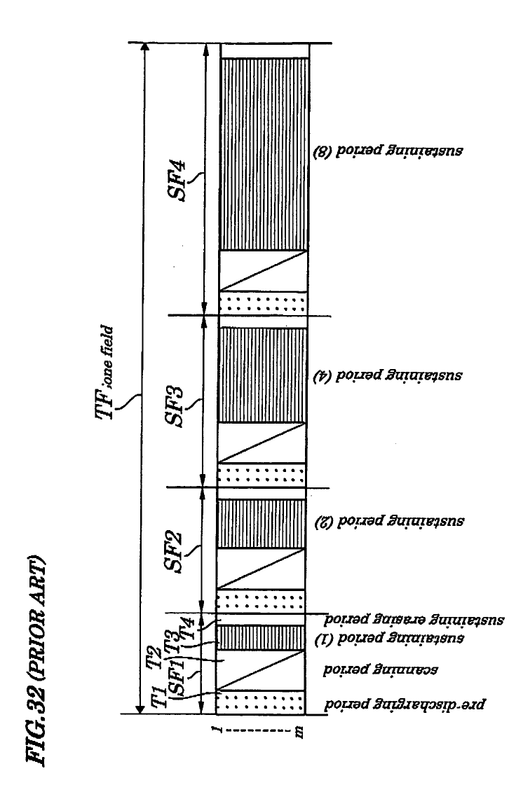

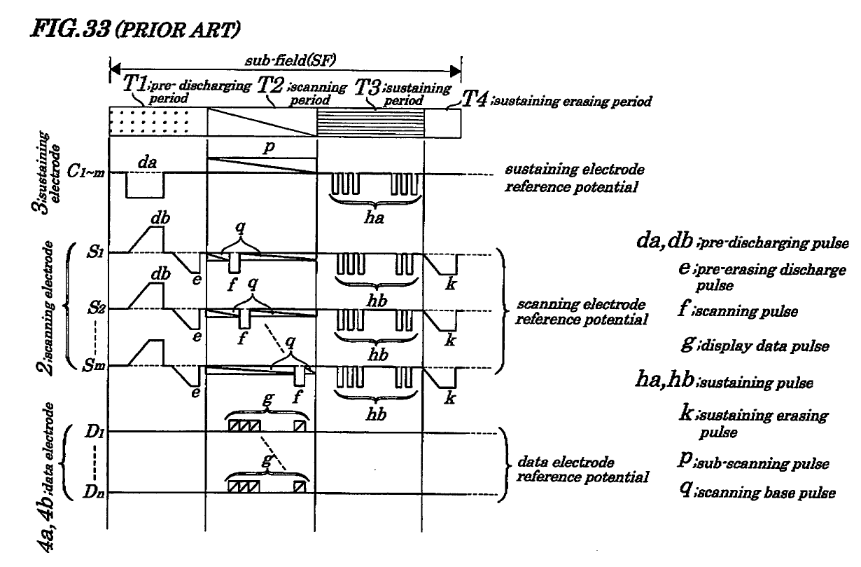

The A/D converting circuit 42 converts an analog video signal “in” into a digital video signal “u”. The pixel converting circuit 41 converts the number of pixels of a video signal “u” into the number of pixels of the PDP 21 being the number of pixels to perform actual display and generates a video signal “v”. The sub-field converting circuit 43 converts a video signal “v” applied from the pixel converting circuit 42 during one field to display data “W” for every sub-field and sends out the converted display data “W” to data drivers 31a and 31b. The one field is divided into, for example, four sub-fields SF1, SF2, SF3, and SF4, with weights being assigned to each sub-field according to a gray level as in the conventional case shown in FIG. 32.

The controller 44 controls timing of operations of the data drivers 31a and 31b, scanning main electrode driver 32, scanning extended electrode driver 33, sustaining main electrode driver 34, and sustaining extended electrode driver 35. In the embodiment in particular, during every sub-field, a pre-discharging pulse to cause pre-discharge to occur in all unit cells 27 is applied only to the scanning main electrode 22 and sustaining main electrode 24 and is not applied to the scanning extended electrode 23 and sustaining extended electrode 25 and address discharge is made to occur in a unit cell 27 selected by applying a scanning pulse in a one-pass scanning manner to each scanning main electrode 22 and simultaneously by applying a display data pulse, in synchronization with the scanning pulse, to each of the data electrodes 26a and 26b and sustaining discharge is made to occur in each unit cell 27 selected by applying all or a greater part of a sustaining pulse alternately to the scanning extended electrode 23 and sustaining extended electrode 25. Also, the controller 44, when applying a sustaining pulse to the scanning extended electrode 23 and sustaining extended electrode 25, applies the sustaining pulse to the scanning main electrode 22 and sustaining main electrode 24 at the same time. The power circuit 45 feeds a specified high voltage to the data drivers 31a and 31b, scanning main electrode driver 32, scanning extended electrode driver 33, sustaining main electrode driver 34, and sustaining extended electrode driver 35. A timing signal (horizontal sync signal, vertical sync signal) “t” is input into the above A/D converting circuit 41, pixel converting circuit 42, sub-field converting circuit 43, and controller 44 and synchronizes operations of each of the circuits and a display screen.

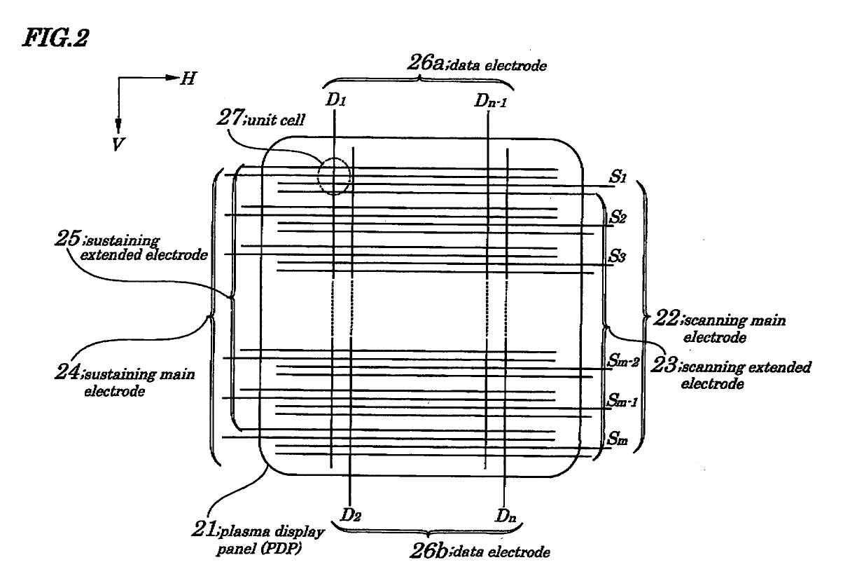

FIG. 2 is a diagram illustrating the PDP 21 drawn from FIG. 1. In the PDP 21, as shown in FIG. 2, in an inner surface of the front substrate (not shown) are arranged m-pieces of the scanning main electrodes 22 (Si, i=1, 2, . . . , m), the sustaining main electrode 24, the scanning extended electrode 23, and sustaining extended electrode 25 in parallel to one another in a row direction H. Moreover, in an inner surface of the rear substrate (not shown) are arranged the data electrodes 26a (Dj, j−1, 3, . . . , n−1) and the data electrodes 26b (Dj, j=2, 4, . . . , n) along a column direction V being orthogonal to the scanning main electrodes 22 or the like. Furthermore, a unit cell 27 is formed at each of intersecting regions of the data electrodes 26a and 26b, scanning main electrode 22, or the like and groups of the unit cells 27 are arranged in a matrix form in the row direction H and column direction V.

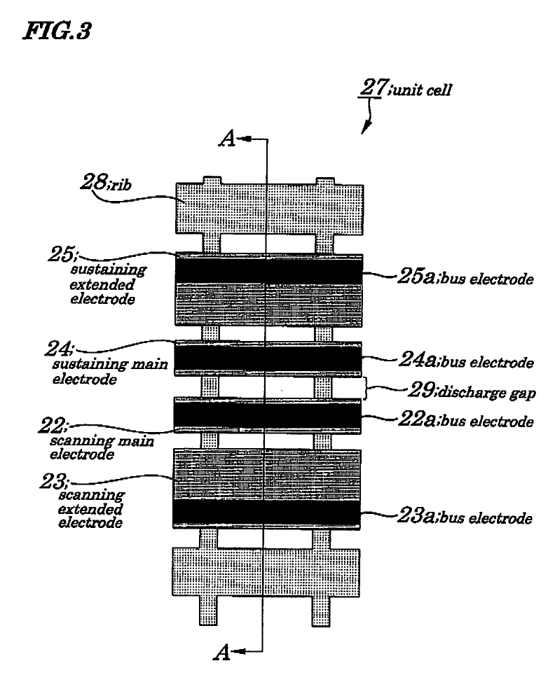

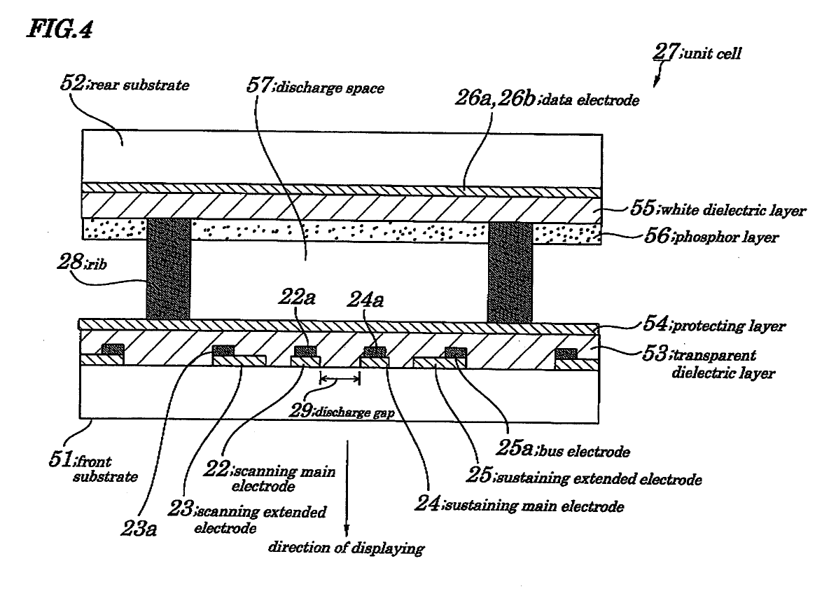

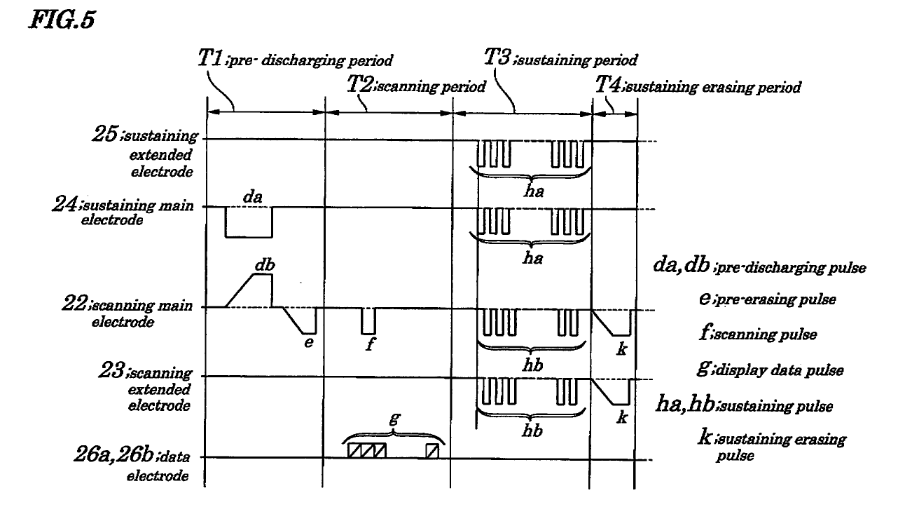

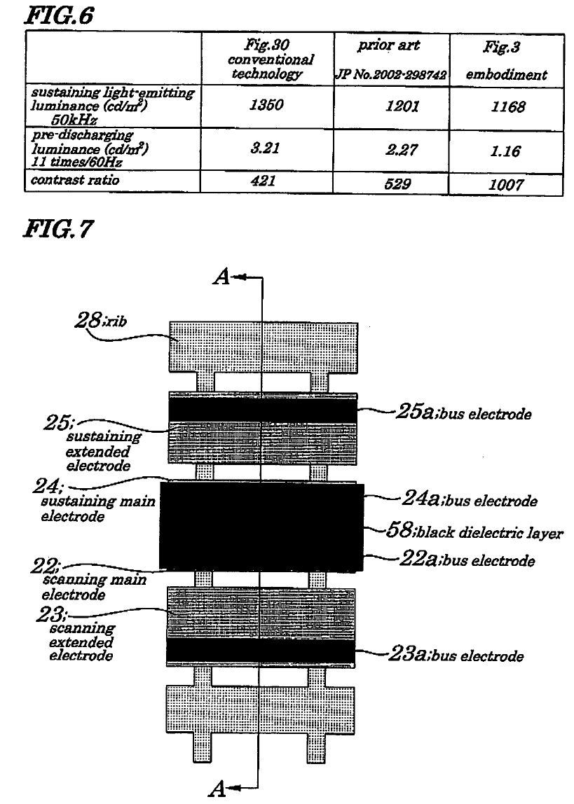

FIG. 3 is a plan view showing configurations of the unit cell 27 shown in FIG. 2. The unit cell 27, as shown in FIG. 3, is formed in a manner to be surrounded by the rib (partition wall, division wall) 28 of a parallel cross shape and the scanning main electrode 22 and the sustaining main electrode 24, with a discharge gap 29 being interposed between the scanning main electrode 22 and sustaining main electrode 24, above the rib 28. The scanning main electrode 22 is constructed by stacking a metal bus electrode 22a on a transparent electrode and a width of the bus electrode 22a is set to be smaller than that of the corresponding electrode and to be more than half of the width of the transparent electrode and the bus electrode 22a shields most of light emitted by the scanning main electrode 22 and sustaining main electrode 24. Also, the bus electrode 22a serves to lower line resistance of the scanning main electrode 22. The sustaining main electrode 24 is also constructed by stacking a metal bus electrode 24a on a transparent electrode and the bus electrode 24a shields most of light emitted by the scanning main electrode 22 and sustaining main electrode 24. Moreover, the bus electrode 24a serves to lower line resistance of the sustaining main electrode 24. The scanning extended electrode 23 and sustaining extended electrode 25 are formed above the rib 28. On a side of the scanning extended electrode 23 being opposite to the scanning main electrode 22 is formed a bus electrode 23a and on a side of the sustaining extended electrode 25 being opposite to the sustaining main electrode 24 is formed a bus electrode 25a. The bus electrode 23a serves to lower line resistance of the scanning extended electrode 23. The bus electrode 25a serves to lower line resistance of the sustaining extended electrode 25.

FIG. 4 is a cross-sectional view of the unit cell 27 taken along a line A-A of FIG. 3. In the unit cell 27, as shown in FIG. 4, a front substrate 51 and a rear substrate 52 are arranged in a manner to face each other at a specified interval. The front substrate 51 is made up of a glass substrate or a like and on the front substrate 51 are arranged the scanning main electrode 22, scanning extended electrode 23, sustaining main electrode 24, and sustaining extended electrode 25. Each of the scanning main electrode 22, scanning extended electrode 23, sustaining main electrode 24, and sustaining extended electrode 25 is made up of a transparent electrode using an ITO film being a transparent conductive thin film, or a like and each of the metal bus electrodes 22a, 23a, 24a, and 25a is formed, respectively, on each of the electrodes 22, 23, 24, and 25. On these electrodes is formed a transparent dielectric layer 53 on which a protecting layer 54 is formed. The protecting layer 54 is made of MgO or a like which protects the transparent dielectric layer 53 from discharge.

The rear substrate 52 is made up of a glass substrate or a like. On the rear substrate 52 are formed the data electrodes 26a and 26b in a manner to be orthogonal to the scanning main electrode 22 and a like. On the data electrodes 26a and 26b is formed a white dielectric layer 55 on which a phosphor layer 56 used to convert an ultraviolet ray produced by discharge into visible light is formed. The phosphor layer 56 is painted red (R), green (G), and blue (B) for every unit cell 27 to obtain a color display PDP. Between the front substrate 51 and rear substrate 52 are formed ribs 28 of a parallel cross shape in a manner to surround each of the unit cells 27. The ribs 28 serve to secure discharge space 57 and to partition a pixel. The discharge space 57 is filled with a mixture gas of He, Ne, Xe or a like as a discharging gas.

FIG. 5 is a diagram of waveforms of pulses to be applied to each electrode to explain operations of the plasma display device of FIG. 1. By referring to FIG. 5, a driving method to be used the plasma display device is described. According to the driving method, during every sub-field, a pre-discharging pulse to cause pre-discharge to occur in all unit cells 27 is applied only to the scanning main electrode 22 and sustaining main electrode 24 and is not applied to the scanning extended electrode 23 and sustaining extended electrode 25. After that, address discharge is made to occur in a unit cell selected by applying a scanning pulse in a one-pass scanning manner to each scanning main electrode 22 (Si, i=1, 2, . . . , m) and simultaneously by applying a display data pulse, in synchronization with the scanning pulse, to each of the data electrodes 26a and 26b, and sustaining discharge is made to occur in each unit cell 27 selected by applying all or a greater part of a sustaining pulse alternately to the scanning extended electrode 23 and sustaining extended electrode 25.

That is, during the pre-discharging period T1, a first pre-discharging pulse “da” of negative polarity is applied to the sustaining main electrode 24 and a second pre-discharging pulse “db” of positive polarity is applied to the scanning main electrode 22 and, therefore, a potential exceeding a discharge starting voltage is applied between the sustaining main electrode 24 and the scanning main electrode 22, which causes discharge to forcedly occur in all unit cells 27. At this point, since the pre-discharging pulse is not applied to the sustaining extended electrode 25 and scanning extended electrode 23, a region where pre-discharge occurs is limited to a region sandwiched between the sustaining main electrode 24 and scanning main electrode 22 (including the sustaining main electrode 24 and scanning main electrode 22) and does not extend in a direction of the sustaining extended electrode 25 and scanning extended electrode 23. Then, a pre-erasing discharge pulse “e” of negative polarity is applied to the scanning main electrode 22 and discharge is made to forcedly occur again in all cells 27. Since the pre-erasing discharge pulse “e” is not applied to the scanning extended electrode 23 and no pre-discharge occurs in the scanning extended electrode 23, the pre-erasing discharge does not extend in a direction of the scanning extended electrode 23.

During the scanning period T2, a scanning pulse “f” of negative polarity is applied in a one-pass scanning manner to the scanning main electrode 22 (Si, i=1, 2, . . . , m). In FIG. 5, a waveform of a scanning pulse “f” corresponding to arbitrary one line of the scanning line is shown. In synchronization with timing with which the scanning pulse “f” is applied, a display data pulse “g” of positive polarity corresponding to display information is applied to the data electrodes 26a, 26b (D1, D2, . . . , Dn). Sloped lines shown in the display data pulse “g” represent that presence or absence of the display data pulse “g” is determined based on presence or absence of information to be displayed for a related unit cell 27. In a unit cell 27 in which the display data pulse “g” is fed when the scanning pulse “f” is applied, address discharge occurs in the discharge space 57 existing between the scanning electrode 22 and data electrodes 26a and 26b, however, if the display data pulse “g” is not applied at the application of the scanning pulse, address discharge does not occur. This address discharge is writing discharge by which display information is written in each unit cell 27. In the unit cell 27 in which the writing discharge occurred, positive wall charges are accumulated on the transparent dielectric layer 53 on the scanning main electrode 22 and negative wall charges are accumulated on the white dielectric layer 55 on the data electrodes 26a and 26b.

During the sustaining period (sustaining discharge period) T3, by superimposition of a positive potential generated by positive wall charges formed on the transparent dielectric layer 53 on the scanning main electrode 22 on a potential of a first sustaining pulse “ha” of negative polarity to be applied to the sustaining main electrode 24, a first sustaining discharge occurs. At this time, the sustaining pulse “ha” is applied also to the sustaining extended electrode 25 and, therefore, the first sustaining discharge extends up to a portion of the sustaining extended electrode 25. As a result of the first sustaining discharge, positive wall charges are accumulated on the sustaining main electrode 24 and the transparent dielectric layer 53 on the sustaining extended electrode 25 and negative wall charges are accumulated on the transparent dielectric layer 53 on the scanning main electrode 22. By superimposition of a potential of a second sustaining pulse “hb” to be applied to the scanning main electrode 22 on a potential difference generated by these wall charges, a second sustaining discharge occurs. At this time, the sustaining pulse “hb” is applied also to the scanning extended electrode 25 and, therefore, the second sustaining discharge extends up to a portion of the scanning extended electrode 25 and, therefore, negative wall charges are accumulated on the transparent dielectric layer 53 on the scanning extended electrode 25. Thereafter, both the scanning main electrode 22 and the scanning extended electrode 23 simultaneously act in the same way as the conventional scanning electrode and both the sustaining main electrode 24 and the sustaining extended electrode 25 simultaneously act in the same way as the conventional sustaining electrode and, as a result, the sustaining discharge continues.

During the sustaining erasing period T4, after the application of the sustaining pulses “ha” and “hb”, a sustaining erasing pulse “k” of negative polarity is applied to all the scanning main electrodes 22 and the scanning extended electrode 23 and, as a result, sustaining erasing discharge occurs in the unit cell 27 in which the sustaining discharge had continued and wall charges are reset.

In the conventional technology, the region where pre-discharge occurs is a wide region being sandwiched between the scanning electrode and sustaining electrode, including both the electrodes. However, in the first embodiment of the present invention, the region where pre-discharge occurs is limited completely to a region sandwiched between the scanning main electrode 22 and the sustaining main electrode 24. Also, the sustaining discharge region extends up to a region sandwiched between the scanning extended electrode 23 and the sustaining extended electrode 25. Since light emitted by the discharge in the region sandwiched between the scanning extended electrode 23 and the sustaining extended electrode 25 is shielded by each of the bus electrodes 22a and 24a formed, respectively, on the scanning main electrode 22 and the sustaining main electrode 24, most of the light emitted by pre-discharge is not emitted on a side of a display surface, which enables black luminance caused by light emitted by pre-discharge to be made remarkably small compared with that occurring in the conventional technology.

During the sustaining period T3, though light emitted in the region sandwiched between the scanning main electrode 22 and the sustaining main electrode 24 is shielded in the same way as during the pre-discharging period T1, light emitted in the region extending up to the scanning extended electrode 23 and sustaining extended electrode 25 is less shielded, when the unit cell 27 is viewed as a whole, a degree of the decrease in light-emitting luminance is small compared with the degree found in the conventional technology. Thus, in the first embodiment, the degree of the decrease in light-emitting luminance by sustaining discharge is overwhelmingly larger than the degree of the decrease in light-emitting luminance by pre-discharge and, therefore, a contrast ratio that can be estimated according to an expression of “(sustaining discharge light-emitting luminance)+(pre-discharge light-emitting luminance)” becomes greater.

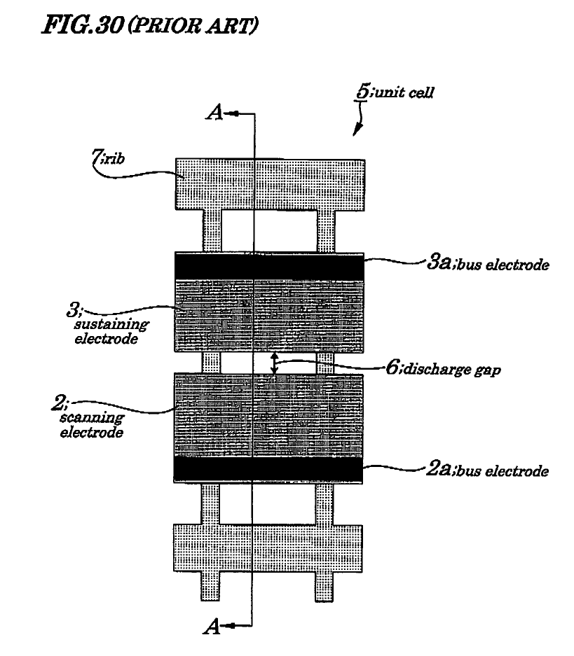

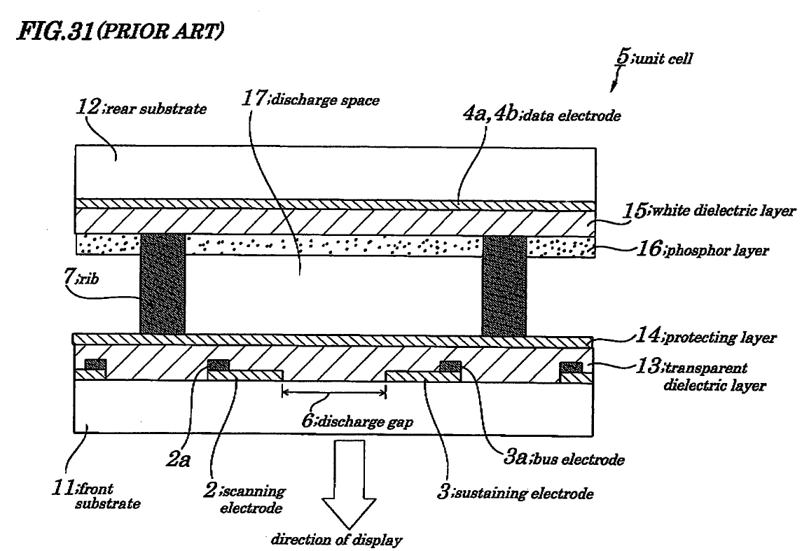

FIG. 6 is a table explaining a result showing improvements in a contrast ratio according to the first embodiment of the present invention. As shown in FIG. 6, the contrast ratio is 421 in the conventional technology shown in FIG. 30, 529 in the conventional technology shown by in the Japanese Patent Application Laid-open No. 2002-298742, and 1007 in the first embodiment shown in FIG. 3 which shows a remarkable improvement. Especially, though the luminance by pre-discharge is 2.27 cd/m2 in the Japanese Patent Application Laid-open No. 2002-298742, it is 16 cd/m2 in the embodiment, which shows a great decrease.

In order to increase a contrast ratio, a region where pre-discharge occurs has to be limited to a small region and light emitted in the region where the pre-discharge occurs has to be shielded more strongly. To do this, for example, the region sandwiched between the scanning main electrode 22 and the sustaining main electrode 24 (including both the main electrodes) is made small and the scanning main electrode 22 and the sustaining main electrode 24 have to be constructed so that most of them is overlain on the light-shielding bus electrode. In this case, as an ultimate configuration, it can be thought that use of the scanning main electrode 22 and sustaining main electrode 24 made up of transparent electrodes is omitted and the electrodes being equivalent to main electrodes are constructed by metal bus electrodes each corresponding to each of the main electrodes. However, in the process in which the bus electrode is constructed only by Ag (silver) thick-films, since smoothness of an edge portion of the bus electrode is not good, it is difficult to control a discharge gap being constructed only of bus electrodes so that designed values are met.

Because of this, it is preferable that the discharge gap is constructed of transparent electrodes whose edge portion has an excellent smoothness and the bus electrode having its width being is smaller than that of the transparent electrode are mounted on the transparent electrode. The reason why the width of the bus electrode is smaller than that of the transparent electrode is that, when the bus electrode is formed on the transparent electrode, a margin for positional deviation has to be taken into consideration. The margin is about ±20 μm at the worst time when being estimated by referring to formation of a thick-film Ag layer to be performed by using a screen printing method and, therefore, by making the width of the bus electrode be by 40 μm smaller than that of the transparent electrode and by mounting the bus electrode and the transparent electrode on the same central axis, even if the position is deviated, the bus electrode does not jut out from the transparent electrode. However, if the margin for positional deviation can be improved by using other process technology, it is preferable that, to enhance the effect of light shielding, the width of the bus electrode is made as large as possible within a range not exceeding the width of the transparent electrode.

To make small the region sandwiched between the scanning main electrode 22 and sustaining main electrode 24, a width of each of the main electrodes has to be narrowed or the discharge gap has to be made small. However, if the width of the main electrode is made narrow, resistance of the electrode, which is a combined resistance of resistance of each of the main electrodes and of each of the bus electrodes mounted on the main electrodes, becomes large. It is, therefore, necessary that the main electrodes and bus electrodes have not only a width but also a thickness exceeding some degree. Also, a change of the discharge gap, since it greatly affects driving characteristics, is not desirous. Moreover, to reduce electrode resistance and to improve a light-shielding characteristic, it is desirous that the width of the bus electrode is large and, when taking the positional deviation into consideration, the width of the bus electrode is a size smaller than that of the main electrode (for example, by 40 μm smaller). Even when the bus electrode is constructed of a thick-film Ag layer by using the screen printing method, the main electrode and the bus electrode are preferably designed so that a width of the main electrode is, for example, 80 μm and a width of the bus electrode is 40 μm, with a positional deviation being considered.

On the other hand, when the main electrode and bus electrode are designed so that a width of the main electrode is, for example, 50 μm and that a width of the bus electrode is, for example, 10 μm, with considerations being given to a positional deviation, the bus electrode is too slender which makes the electrode resistance greater and, therefore, in some cases, the main electrode and bus electrode do not operate normally even by application of a driving pulse. Therefore, it is preferable that, as a guide for designing, a width of the bus electrode is one half or more the width of the main electrode. Moreover, a width of the sustaining extended electrode that may greatly affects light-emitting luminance by sustaining discharge may be adjusted properly according to sustaining light-emitting luminance. In this case, if a width of the extended electrode is made greater, sustaining light-emitting luminance increases and, if a width of the extended electrode is made small, sustaining light-emitting luminance becomes less.

Thus, according to the first embodiment, the region where pre-discharge occurs is limited completely to the region sandwiched between the scanning main electrode 22 and the sustaining main electrode 24 and, since light emitted by discharge in the region where the pre-discharge occurs is shielded by the bus electrodes 22a and 24a being mounted, respectively, on the scanning main electrode 22 and the sustaining main electrode 24, most of light emitted by the pre-discharge is not emitted out to a display surface side and black luminance caused by light emitted by the pre-discharge is made very small and a ratio of contrast is greatly improved accordingly.

However, there is a problem in the first embodiment in that light in a portion of the discharge gap 29 being a light-emitting region by the pre-discharge is not shielded and, as a result, a contrast ratio is desirable to be more improved. In a following second embodiment to be described below, the contrast ratio can be more improved.

### Second Embodiment

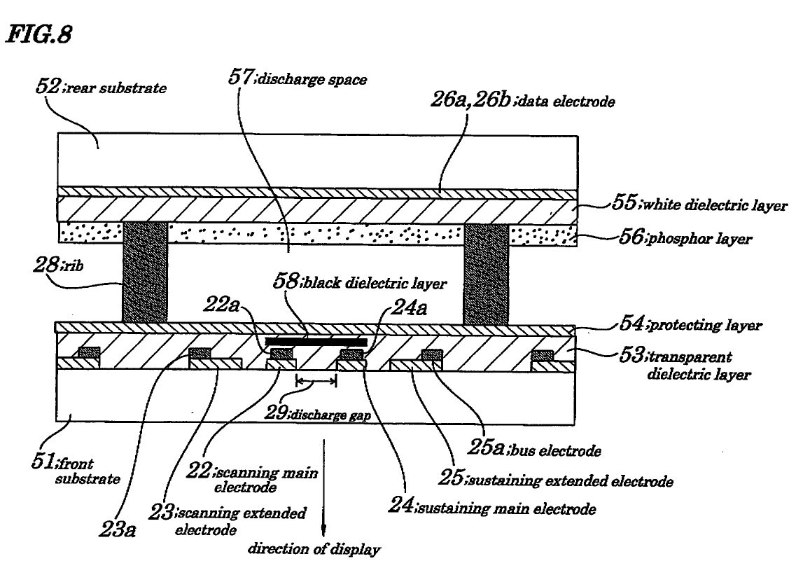

FIG. 7 is a plan view illustrating configurations of a unit cell 27 of a PDP according to a second embodiment of the present invention in which same reference numbers are assigned to components having the same function as in the first embodiment shown in FIG. 3. FIG. 8 is a cross-sectional view of the unit cell 27 taken along a line A-A of FIG. 7.

In the unit cell 27 of the PDP of the second embodiment, a black dielectric layer 58 is formed on a scanning main electrode 22 and a sustaining main electrode 24. The black dielectric layer 58 is formed in a manner in which it covers directly a region including the scanning main electrode 22, sustaining main electrode 24, bus electrodes 22a and 24a, and a discharge gap 29 as shown in FIG. 3. As shown in FIG. 8, the black dielectric layer 58 is formed in a transparent dielectric layer 53. In this case, the transparent dielectric 53 is formed so as to cover all the electrodes on which the black dielectric layer 58 is stacked and further the transparent dielectric layer 53 is formed in a manner in which it covers all regions including the black dielectric layer 58. The black dielectric layer 58 shields light emitted by the scanning main electrode 22 and sustaining main electrode 24.

In the PDP of the second embodiment, since light emitted in a portion of the discharge gap 29 is shielded by the black dielectric layer 58, almost all the light emitted by pre-discharge are shielded. As a result, black luminance caused by light-emitting luminance by pre-discharge becomes so small that it can not be recognized visually and, therefore, a contrast ratio of a display screen is improved compared with that in the first embodiment. Moreover, since light emitted in most of the region of the scanning main electrode 22 and sustaining main electrode 24 is shielded by the black dielectric layer 5B, it is not necessary that a width of each of the bus electrodes 22a and 24a is extended, with the aim of shielding light, so as to have the same width as the scanning main electrode 22 and sustaining main electrode 24. As a result, when a width of the bus electrodes 22a and 24a is determined, considerations have to be given only to electrical resistance, which can widen a freedom of designing.

### Third Embodiment

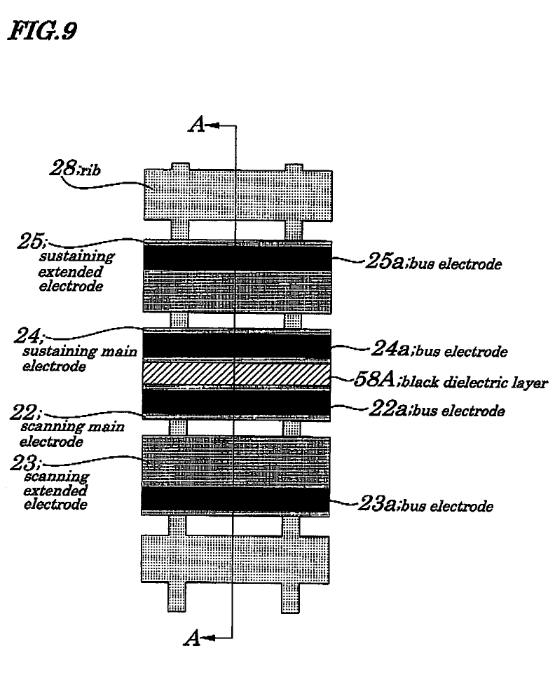

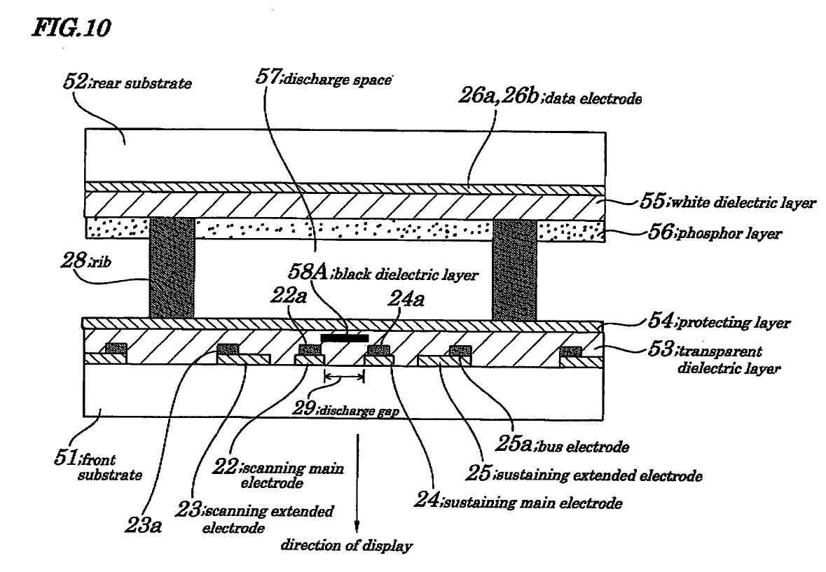

FIG. 9 is a plan view illustrating configurations of a unit cell 27 of a PDP according to a third embodiment of the present invention in which same reference numbers are assigned to components having the same function as in the first embodiment shown in FIG. 7. FIG. 10 is a cross-sectional view of the unit cell taken along a line A-A of FIG. 9. In the unit cell of the PDP of the third embodiment shown in FIG. 9, instead of the black dielectric layer 58 shown in FIG. 7, a black dielectric layer 58A is mounted, which is formed in a region being different from the region in which the black dielectric layer 58 is formed. The black dielectric layer 58A, as shown in FIG. 10, is formed almost only above the discharge gap 29 and not above the scanning main electrode 22 and the sustaining main electrode 24.

In the PDP of the third embodiment, light emitted in a portion of the discharge gap 29 is shielded by the black dielectric layer 58A and light emitted on the scanning main electrode 22 and sustaining main electrode 24 is shielded by the bus electrodes 22a and 24a as in the case of the first embodiment. This enables a contrast ratio of a display screen to be improved. Moreover, since the region in which the black dielectric layer 58A is formed is made narrow, which enables materials used to form the black dielectric layer 58A to be decreased.

In each of the above embodiments, the number of terminals used to take out electricity and/or signals from the scanning main electrode 22 and the scanning extended electrode 23 is two times larger than that in the conventional scanning electrode. For example, if a PDP has 480 scanning lines in a vertical direction, in the case of the conventional configurations, the needed number of scanning electrodes is 480 pieces. However, in the case of each of the above embodiments, a total of 960 pieces of terminals including 480 pieces of terminals for the scanning main electrodes and 480 pieces of terminals for the scanning extended terminals is required, which presents a problem in that the configurations of the PDP become complicated. Another problem with each of the above embodiments is that light emitted by sustaining discharge is shielded by the bus electrode 23a and 25a mounted, respectively, on the scanning extended electrodes 23 and the sustaining extended electrode 25. A following fourth embodiment solves the problems described above.

### Fourth Embodiment

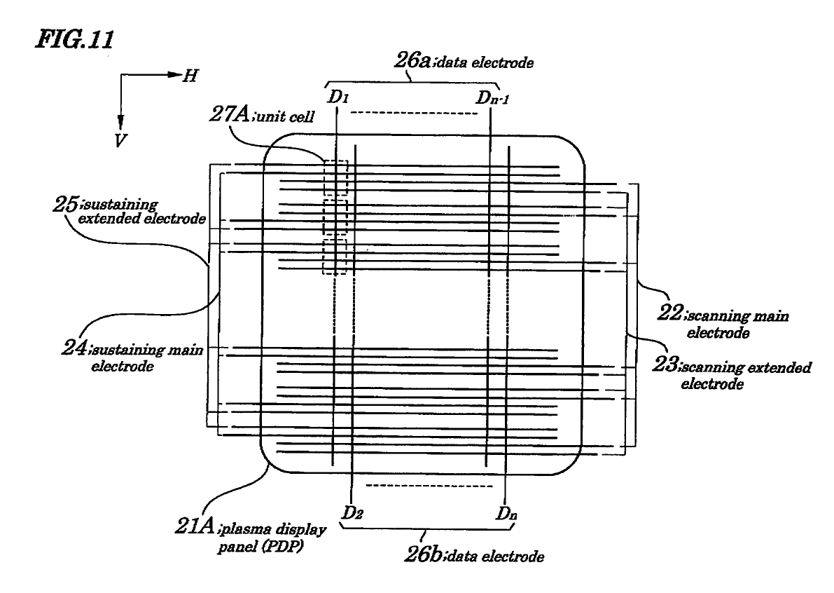

FIG. 11 is a diagram illustrating configurations of a PDP 21A according to a fourth embodiment of the present invention in which same reference numbers are assigned to components having the same function as the first embodiment shown in FIG. 2. In the PDP 21A of the fourth embodiment, a unit cell 27A is formed at an intersecting portion of each of data electrodes 26a and 26b and each of scanning main electrodes 22 or a like and groups of the unit cells 27A are arranged in a matrix form in a row direction H and a column direction of V. In the unit cells 27A being adjacent to one another, sustaining extended electrodes 25 are arranged so as to be adjacent to one another and scanning extended electrodes 23 are arranged so as to be adjacent to one another.

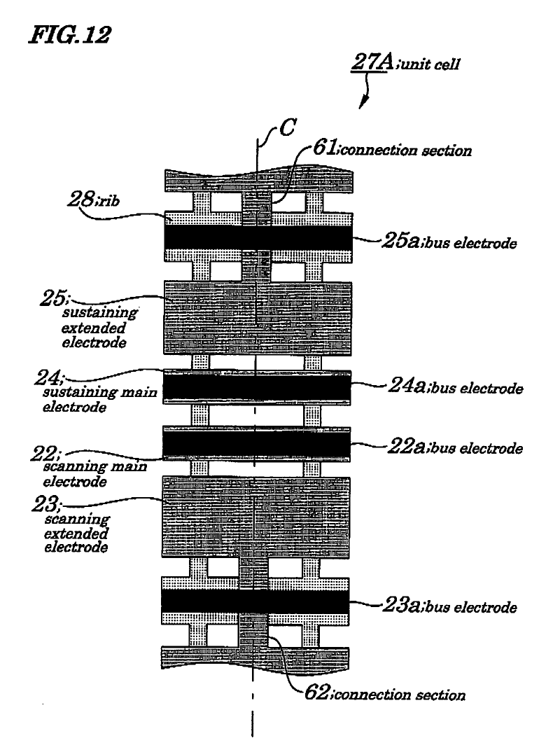

FIG. 12 is a diagram illustrating configurations of the unit cell 27A shown in FIG. 11. In the unit cell 27A shown in FIG. 12, the sustaining extended electrode 25 is electrically connected to another sustaining extended electrode in another unit cell 27A (not shown) being adjacent to the unit cell 27A in an upper direction via a connection section 61 and therefore the sustaining extended electrode 25 and the another sustaining extended electrode 25 (not shown) are electrically integrated. The scanning extended electrode 23 is electrically connected to another scanning extended electrode 23 (not shown) in another unit cell 27A (not shown) being adjacent to the unit cell 27A in a down direction via a connection section 62 and, therefore, the scanning extended electrode 23 and the another sustaining extended electrode 25 (not shown) are electrically integrated. The connection sections 61 and 62 are formed above the rib 28 and pass through a central axis C. In a center portion between the electrically integrated two sustaining extended electrodes 25 (that is, in a center portion of the connection section 61, 62) is formed a bus electrode 25a and in a center portion between the electrically integrated two scanning extended electrodes 23 (that is, in a center portion of the connection section 61, 62) is formed a bus electrode 23a.

For example, if the PDP 27A has 480 scanning lines in a vertical direction, the number of terminals for connection to the scanning extended electrode is reduced to 240 and a total number of terminals of the scanning extended electrode 23 and sustaining extended electrode 25 is reduced to 720 (480+240). Since each of the bus electrodes 23a and 25a is formed in a center portion of each of the connection portions 62 and 61, an influence by shielding of light emitted by sustaining discharge is suppressed, thus improving a rate of efficiency of taking out light emitted by the sustaining discharge.

### Fifth Embodiment

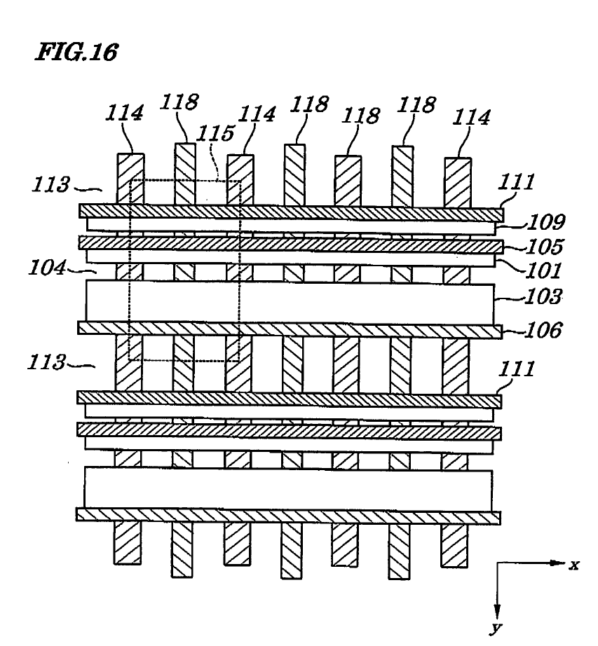

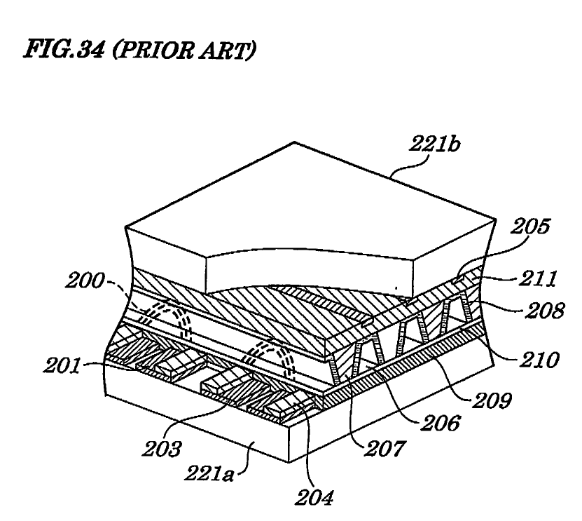

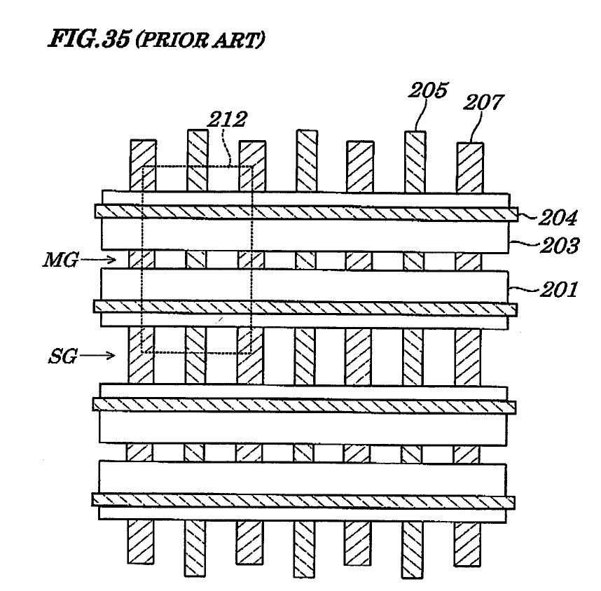

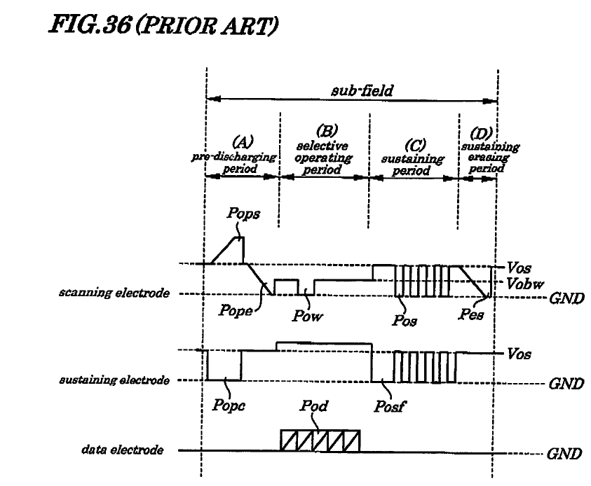

A plasma display panel, PDP used in a plasma display device used in the fifth embodiment of the present invention is constructed of the same or approximately same components as employed in the third conventional PDP shown in FIG. 34. That is, in the PDP, a pair of discharge electrodes covered with a first dielectric layer and a protecting layer is formed on a front substrate, electrodes covered with a second dielectric layer is formed on a rear substrate and ribs to form discharge space on the second dielectric layer and a phosphor layer to obtain visible emitted light are formed also on the second dielectric layer. Therefore, configurations peculiar to the present invention are described in detail by referring to drawings as below. In the plasma display device of the fifth embodiment, as shown in FIG. 16, on the front substrate 102 (not shown) are mounted scanning electrodes 101 and sustaining electrodes 103. Both the scanning electrode 101 and sustaining electrode 103 are constructed so as to be transparent. A main discharge gap 104 is formed between the scanning electrode 101 and the sustaining electrode 103. First trace electrode 105 is formed in a manner in which the first trace electrode 105 is overlain on the scanning electrode 101. Second trace electrode 106 is formed in a manner in which the second trace electrode 106 is overlain on the sustaining electrode 103. Each of the first trace electrode 105 and the second trace electrode 106 is made up of metal which serves to reduce electrical resistance of the scanning electrode 101 and sustaining electrode 103.

On the front substrate 102 (not shown) on a side of a reverse discharge gap being located on a side being opposite to the main discharge gap 104 on the side of the scanning electrode 101 is formed scanning-side extending electrode 109. Third trace electrode 111 is formed in a manner in which the third trace electrode 111 is overlain on the scanning-side extending electrode 109. The third trace electrode 111 is made up of metal which serves to reduce electrical resistance of the scanning-side extending electrode 109. A non-discharge gap 113 is formed between the third trace electrode 111 and second trace electrode 106.

The scanning electrode 101, sustaining electrode 103, first trace electrode 105, second trace electrode 106, scanning-side extending electrode 109, and third trace electrode 111 extend in one direction (X-direction) being parallel to one another. Data electrode 118 and rib 114 are formed on the rear substrate (not shown) in a direction (Y-direction) being orthogonal to the X direction. Each of unit display cells 115 is defined by each of non-discharge gaps 113 being adjacent to each of the unit display cells 115 in the Y direction and by the ribs 114 being adjacent to each of the unit display cells 115 in the X direction.

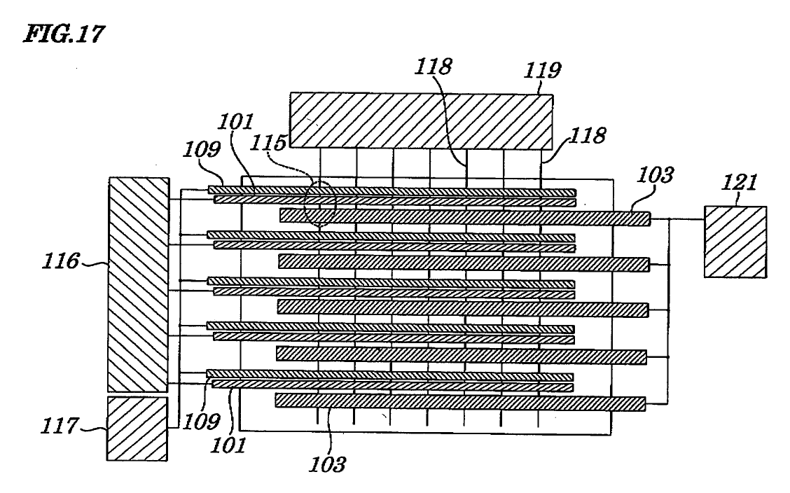

A set of electrodes made up of three electrodes including the scanning electrode 101, sustaining electrode 103, and scanning-side extending electrode 109 is arranged in parallel to one another in the Y direction shown in FIG. 17.

A plurality of the scanning electrodes 101 are electrically taken out individually for every display line and connected to a scanning driver 116. All the scanning-side extending electrodes 109 are connected to a scanning-side extending driver 117. All the data electrodes 118 are individually connected to a data driver 119. All the sustaining electrodes 103 are connected to a sustaining driver 121.

FIG. 18 is a timing chart showing a method for driving the plasma display device of the fifth embodiment of the present invention. The time chart includes a pre-discharging period A used to cause discharge to easily occur during a subsequent selective operating period, selective operating period B during which an ON/OFF operation for displaying in each display cell is selected, sustaining period C during which discharge for displaying in all display cells selected is made to occur, and sustaining erasing period D during which discharge for displaying is stopped, all of which are sequentially set in terms of time. All the sustaining electrodes 103 are driven by a common waveform of a pulse and all the scanning-side extending electrodes 109 are also driven by a common waveform of a pulse. However, the scanning electrode 101 is driven for every column and every line and the data electrodes 118 are also driven for every column and every line. In FIG. 18, for the scanning electrode 101, a waveform of a pulse applied to an n-th column of the scanning electrode 101-n is shown. Also, for the data electrode 118, a waveform of a pulse applied to an m-th column of the data electrode 118-m.

Reference potentials of the scanning electrode 101-n, sustaining electrode 103, and scanning-side extending electrode 109 are set at a sustaining voltage Vs at which discharge is sustained during the sustaining period C. A voltage of the scanning electrode 101-n, sustaining electrode 103, scanning-side extending electrode 109 are expressed as a positive-polarity voltage if being higher than the sustaining voltage Vs and as a negative-polarity voltage if being lower than the sustaining voltage Vs. In the fifth embodiment, for example, a voltage of +170V is employed as the sustaining voltage. A reference voltage for the data electrode 18-m is set to be a ground voltage GND (0V).

During the pre-discharging period A, a positive-polarity sawtooth-shaped pre-discharging pulse “Pps” is applied to the scanning electrode 101-n and, at the same time, a negative-polarity square pre-discharging pulse “Ppc” is applied to the sustaining electrode 103. A potential of the pre-discharging pulse “Ppc” is set at a ground potential GND. A crest voltage of the pre-discharging pulse “Pps” is set at a voltage value that exceeds a discharge starting threshold voltage between the scanning electrode 101-n and the sustaining electrode 103. As the crest voltage, for example, 380 V is used in the embodiment and as an inclination of the pre-discharging pulse “Pps”, about 3V/micro second is used. At this point, the scanning-side extending electrode 109 is held at the sustaining voltage Vs.

After a voltage of the sawtooth-shaped pre-discharging pulse “Pps” rises by application of the pre-discharging pulse “Pps” and the pre-discharging pulse “Ppc” and from a time point when a potential exceeds a discharge starting threshold voltage, feeble discharge occurs between the scanning electrode 101-n and the sustaining electrode 103. As a result, a negative charge is formed on the scanning electrode 101-n and a positive wall charge is formed on the sustaining electrode 103.

The discharge between the scanning electrode 101-n and the sustaining electrode 103, since it is feeble, occurs only in the vicinity of the main discharge gap 104. Due to this, the scanning-side extending electrode 109 is not affected by discharge and a charged state (state of having adsorbed wall charges) of a surface of each of the scanning-side extending electrode 109 is not changed. A negative-polarity sawtooth-shaped pre-discharging erasing pulse “Ppes” is applied, following application of the pre-discharging pulse “Pps”, to the scanning electrode 101-n. A pre-discharging erasing pulse “Ppea” having the same shape is applied to the scanning-side extending electrode 109. The ultimate potential of these pre-discharging erasing pulses “Ppes” and “Ppea” is set at, for example, about −60V and an inclination of these pulses is set at, for example, about 3V/micro second. At this point, a voltage of the sustaining electrode 103 is fixed at the sustaining voltage Vs.

Wall charges formed on the scanning electrode 101-n and the sustaining electrode 103 are erased by application of the pre-discharging erasing pulse “Ppes”. The discharge, since it is also feeble, occurs only in the vicinity of the main discharge gap 104 and no change in the charged state of the scanning-side extending electrode 109 occurs. The process of erasing wall charges performed during the pre-discharging period A includes a process of calibrating the wall charges which is needed to achieve favorable operations in subsequent processes such as selective operations, sustaining discharge, or a like.

Next, during the selective operating period B, after all the scanning electrodes 101 have been held once at a base potential “Vbw”, a negative-polarity scanning pulse “Pw” is sequentially applied to the scanning electrode 101 and data pulse “Pd” corresponding to data for displaying is applied to the data electrodes 118. As the base potential “Vbw”, for example, about 30V is employed in the embodiment. During the selective operating period B, the sustaining electrode 103 is held at the sustaining voltage Vs and the scanning-side extending electrode 109 is held at the base potential Vbw. Moreover, in the facing electrode made up of the scanning electrode 101 and the data electrode 118, the ultimate potential of the scanning pulse “Pw” and of the data pulse “Pd” is so set that, when either of the scanning pulse “Pw” or the data pulse “Pd” is singly applied, a facing electrode voltage between the scanning electrode 101 and data electrode 118 does not exceed a discharge starting threshold voltage and, when both the scanning pulse “Pw” and data pulse “Pd” are superimposed on each other, the facing electrode voltage exceeds the discharge starting threshold voltage. Also, a potential of the scanning pulse “Pw” is so set that, when the scanning pulse “Pw” is applied, a surfacing electrode voltage between the scanning electrode 101 and sustaining electrode 103 does not exceed the discharge starting threshold voltage. In the embodiment, as the ultimate potential of the scanning pulse “Pw”, for example, a voltage of about −70V is used and, as the ultimate potential of the data pulse “Pd”, for example, a voltage of 70V is used. The facing electrode voltage and surface electrode voltage described above are defined as a combined value of a voltage to be applied from outside and a voltage (wall voltage) produced by wall charges formed within a discharge cell.

Only in a display cell in which the data pulse “Pd” has been applied with timing of application of the scanning pulse “Pw”, facing discharge between the scanning electrode 101 and the data electrode 118 occurs. At this point, a potential is produced between the scanning electrode 101 and the sustaining electrode 103 by application of the voltage of the scanning pulse “Pw” and the sustaining voltage of Vs, which triggers facing discharge to occur between the scanning electrode 101 and the sustaining electrode 103. Such the discharge serves as writing discharge. As a result, in selected display cells, a positive wall charge is formed on the scanning electrode 101 and a negative wall charge is formed on the sustaining electrode 103 and such the charge forming operation serves as the writing operation.

At this point, the scanning-side extending electrode 109 is held at the base voltage Vbw. A potential difference between the scanning-side extending electrode 109 and the sustaining electrode 103 is set to be lower than that between the scanning electrode 101 and the sustaining electrode 103 and is set to be considerably lower compared with that of the sustaining voltage Vs. Due to this, writing discharge does not extend through the scanning-side extending electrode 109.

During the sustaining period C following the selective operating period B, all the scanning electrodes 101 and scanning-side extending electrodes 109 are held at the sustaining voltage Vs and a first sustaining pulse “Psf” having its crest voltage being the sustaining voltage Vs and of negative polarity is applied to the sustaining electrode 103. The sustaining voltage Vs is set at a voltage at which discharge occurs when a wall voltage formed on the surface electrode by writing discharge during the selective operation period B is imposed on the sustaining voltage Vs and, when there is no superimposition of the wall charge, a surface electrode voltage does not exceed the discharge starting threshold voltage which causes discharge not to occur. A width of the first sustaining pulse “Psf” is set to be as comparatively long as, for example, about 5 micro seconds so that the sustaining discharge occurs in a stable manner.

Therefore, only in a display cell in which writing discharge has occurs and wall charges are formed during the selective operating period B, sustaining discharge occurs between the scanning electrode 101 and the sustaining electrode 103. By occurrence of the sustaining discharge, negative wall charges are formed on the scanning electrode 101 and positive wall charges are formed on the sustaining electrode 103. Since, at this time point, the scanning-side extending electrode 109 is held at the sustaining voltage Vs, as in the case of the scanning electrode 101, negative wall charges are formed on the scanning-side extending electrode 109.

Then, the sustaining electrode 103 is fixed at the sustaining voltage Vs and a sustaining pulse “Ps” having its crest voltage being the sustaining voltage Vs and of negative polarity is applied to the scanning electrode 101 and the scanning-side extending electrode 109. As a width of the sustaining pulse “Ps”, about 2 micro seconds are used in the embodiment. At this time, since negative wall charges are formed on both the scanning electrode 101 and scanning-side extending electrode 109, both of them act independently and equally as surface discharge electrodes on a scanning side, which causes sustaining discharge to occur between the scanning electrode 101 and the sustaining electrode 103 and between the scanning-side extending electrode 109 and the sustaining electrode 103.

Then, negative-polarity sustaining pulses “Ps” whose crest voltages are the sustaining voltage Vs and whose phases are reversed to one another are alternately and continuously applied to the scanning electrode 101, scanning-side extending electrode 109, and sustaining electrode 103, which causes sustaining discharge to continuously occur.

During the sustaining erasing period D subsequent to the sustaining period C, the sustaining electrode 103 is fixed at the sustaining voltage Vs and a negative-polarity sawtooth-shaped sustaining erasing pulse “Pes” is applied to the scanning electrode 101. Also, a sustaining erasing pulse “Pea” having the same waveform as the sustaining erasing pulse “Pes” is applied to the scanning-side extending electrode 109. In the embodiment, as the ultimate voltage of these sustaining erasing pulses “Pes” and “Pea”, for example, about −60 V is employed. As an inclination of these pulses, for example, about 3V/micro seconds is used.

By such the processes, feeble discharge occurs between the scanning electrode 101 and the sustaining electrode 103 and wall charges on both the electrodes are erased and the charged states return back to their initial states where no charges are formed, that is, to the states before the pre-discharging pulses “Pps” and “Ppc” were applied during the pre-discharging period A. The discharge, since it is also feeble, occurs only in the vicinity of the main discharge gap 104, there is no change in the wall charges formed on the scanning-side extending electrode 109. The process of erasing wall charges performed during the pre-discharging period D includes a process of calibrating the wall charges which is needed to achieve favorable operations in subsequent processes.

Next, discharge currents of the PDP having the configurations described above and plasma display device to be driven by operations described above are described.

Generally, when a voltage to be applied between discharge electrodes is constant, an amount of the current that flows by discharge is proportional to a capacity formed by the electrodes and protecting layers being in contact with a discharging space. Therefore, it can be thought that the amount of the current is approximately proportional to an electrode area. As a result, in the PDP and plasma display device described above, an mount of currents that flows by sustaining discharge is a total area of the scanning electrode 101 and the scanning-side extending electrode 109. On the other hand, in the case of writing discharge, the scanning-side extending electrode 109 does not function as a discharge electrode. At this point, though the area of the sustaining electrode 103 is the same, since the amount of currents is limited to the electrode having a smaller area of the electrode, the discharge current is proportional to the area of the scanning electrode 101.

Since a unit light-emitting luminance on which display luminance is based is proportional to an amount of currents in sustaining discharge, by making large a total area of the scanning electrode 101 and the scanning-side extending electrode 109, luminance can be enhanced. On the other hand, since an amount of currents that flow by writing discharge is proportional to an area of the scanning electrode 101, by making small an area of the scanning electrode 101, the amount of currents that flow by writing discharge can be reduced. That is, making smaller an area of the scanning electrode 101 and by making larger an area of the scanning-side extended electrode 109, both the enhancement of luminance and reduction of currents that flow by writing discharge can be made possible.

When an amount of currents that flow by writing discharge is small, a voltage drop of the scanning pulse “Pw” becomes small and, therefore, a driving margin becomes wide, a yield can be improved. Moreover, since a low-cost scanning driver IC having small current capacity can be used, reduction in manufacturing costs is possible. Thus, a low-cost plasma display device having enhanced luminance can be manufactured in a high-yield manner.

### Sixth Embodiment

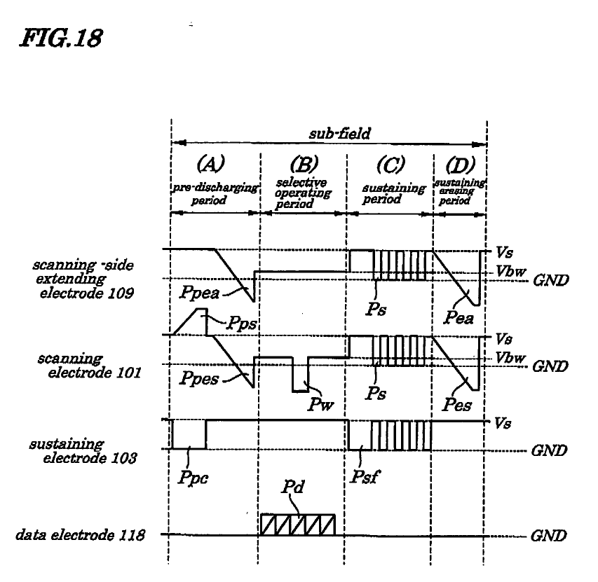

FIG. 19 is a plan view of a plasma display device of a sixth embodiment of the present invention. Configurations of the plasma display of the second embodiment shown in FIG. 19 are the same as those of the fifth embodiment shown in FIG. 16 in that scanning electrode 101, sustaining electrode 103, and scanning-side extending electrode 109 are formed on a front substrate, first trace electrode 105, second trace electrode 106, third trace electrode 111 are formed in a manner in which the first trace electrode 105, second trace electrode 106 and third trace electrode 111 correspond to the scanning electrode 101, sustaining electrode 103, and scanning-side extending electrode 109, respectively, and in which the first trace electrode 105, second trace electrode 106 and third trace electrode 111 are overlain on the scanning electrode 101, sustaining electrode 103, and scanning-side extending electrode 109, respectively, and in that a main discharge gap 104 and a non-discharge gap 113 are formed. In the sixth embodiment, scanning-side extending electrode 122 and fourth trace electrode 123 are additionally mounted. The fourth trace electrode 123 is overlain on the scanning-side extending electrode 122 so that their resistance value are made small.

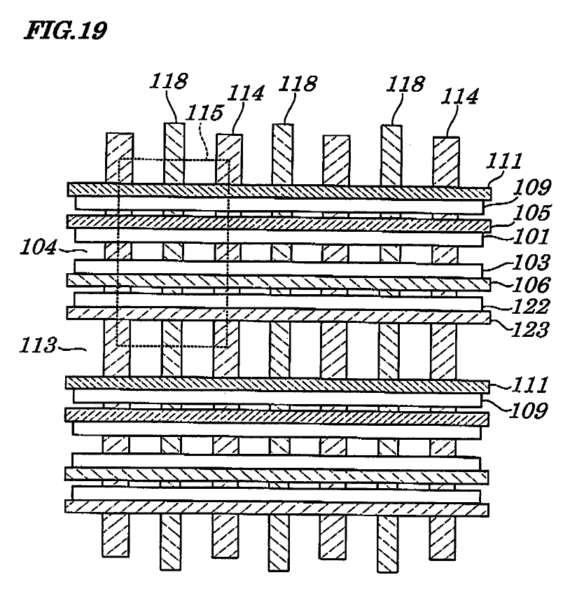

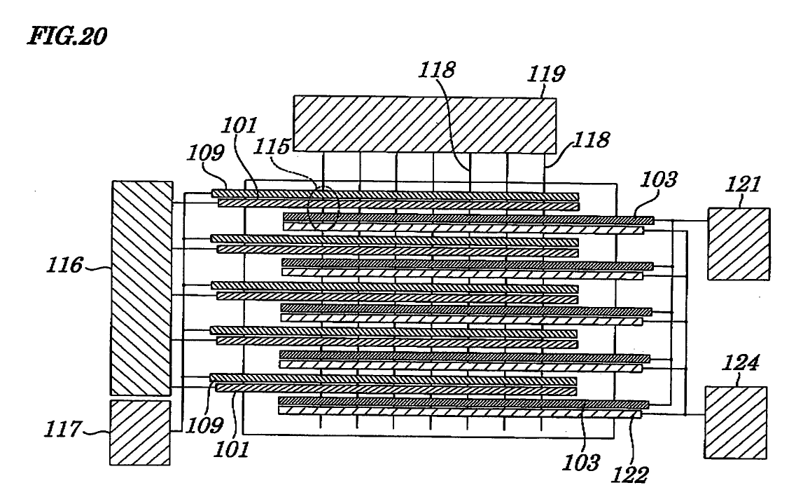

As shown in FIG. 20, configurations of the plasma display of the sixth embodiment are the same as those of the fifth embodiment shown in FIG. 16 in that electricity and/or signals are taken out, for every display line, from the scanning electrode 101 and is connected to of a scanning driver 116, all the scanning-side extending electrodes 109 are electrically connected to a scanning-side extending driver 117, all the sustaining electrodes 103 are electrically connected to a sustaining driver 121, and all the data electrodes 118 are connected individually to a data driver 119. All the sustaining-side extending electrodes 122 are electrically connected to a sustaining-side extending driver 124.

FIG. 21 is a timing chart showing a method for driving the plasma display device of the sixth embodiment. The timing chart shown in FIG. 21 is the same as that of the fifth embodiment shown in FIG. 18 in that a pre-discharging period A, a selective operating period B during which discharge is caused by the pre-discharging period A to occur easily and an ON/OFF operation for displaying in each display cell is selected, a sustaining period C during which discharge for displaying in all display cells selected is made to occur and a sustaining erasing period D during which discharge for displaying is stopped are provided.

All of the sustaining electrodes 103, scanning-side extending electrodes 109, and sustaining-side extending electrodes 122 are driven by a pulse having a common waveform. However, the scanning electrodes 101 and the data electrodes 118 are individually driven for every column and every row. FIG. 21 shows, as a typical example, a waveform to be applied to the scanning electrode 101-n for an n-th column out of all columns of the scanning electrodes 101 and, also as a typical example, a waveform to be applied to the data electrode 118-m for an m-th row out of all the rows of the data electrodes 118.

A reference potential for the scanning electrode 101, sustaining electrode 103, scanning-side extending electrode 109, and sustaining-side extending electrode 122 is set at the sustaining voltage Vs at which discharge is maintained during the sustaining period. The voltage of the scanning electrode 101, sustaining electrode 103, scanning-side extending electrode 109, and sustaining-side extending electrode 122 is expressed as a positive potential when each of the voltages of these electrodes is higher than the sustaining voltage Vs and as a negative potential when each of the voltages of these electrodes is lower than the sustaining voltage. In the embodiment, as the sustaining voltage Vs, for example, +170 is employed. A reference voltage for the data electrodes 118 is set at a ground potential GND (0V).

In the sixth embodiment, as in the case of the fifth embodiment, during the pre-discharging period A, a positive-polarity sawtooth-shaped pre-discharging pulse “Pps” is applied to the scanning electrode 101 and, at the same time, a negative-polarity square discharging pulse “Ppc” is applied to the sustaining electrode 103 and further a negative-polarity square pre-discharging pulse “Ppac” is applied to the sustaining-side extending electrode 122. A potential of the pre-discharging pulses “Ppc” and “Ppac” is set at the ground potential GND. A crest voltage of the pre-discharging pulse “Pps” is set at a potential exceeding a discharge starting threshold voltage between the scanning electrode 101 and the sustaining electrode 103. As an example of the crest voltage, about 380 V is used. As an inclination of the pre-discharging pulse “Pps”, about 3V/micro second is set. At this point, the scanning-side extending electrode 109 are held at the sustaining voltage Vs.

A voltage of the sawtooth-shaped pre-discharging pulse “Pps” is boosted by the application of the pre-discharging pulse “Pps” and the pre-discharging pulse “Ppc” and, from time when a potential difference between the scanning electrodes 101 and the sustaining electrode 103 exceeds a discharge starting voltage, feeble discharge among the electrodes occurs. As a result, negative wall charges are formed on the scanning electrode 101 and positive wall charges are formed on the sustaining electrode 103.

The discharge between the scanning electrode 101 and sustaining electrode 103, since it is feeble, occurs only in the vicinity of the main discharge gap 104. Therefore, the scanning-side extending electrode 109 and sustaining-side extending electrode 122 are not affected by the discharge and no change in charged states (state of having adsorbed wall charges) on surfaces of these electrodes 109 and 122 occurs. A negative sawtooth-shaped pre-discharging erasing pulse “Ppes” is applied, following the application of the pre-discharging pulse “Pps”, to the scanning electrode 101. A pre-discharging erasing pulse “Ppea” having the same waveform as the pulse “Ppes” is applied to the scanning-side extending electrode 109. The ultimate potential of each of the pre-discharging erasing pulses “Ppes” and “Ppea” is, for example, about −60V and an inclination of these pulses is, for example, 3V/micro second. At this point, a potential of the sustaining electrode 103 is fixed at the sustaining voltage vs. The sustaining-side extending electrode 122 is fixed at Vsm being an intermediate potential difference between the sustaining voltage Vs and the ground potential GND.

Wall charges formed on the scanning electrode 101 and sustaining electrode 103 are erased by application of the pre-discharging erasing pulse “Ppes”. The discharge, since it is feeble, occurs only in the vicinity of the main discharge gap 104 and no change in charged states of the scanning-side extending electrode 109 and the sustaining-side extending electrode 122. The process of erasing wall charges performed during the pre-discharging period A includes a process of calibrating the wall charges, which is needed to achieve favorable operations in subsequent processes such as selective operations, sustaining discharge, or a like.

Next, during the selective operating period B, after all the scanning electrodes 101 have been held once at a base potential Vbw, a negative-polarity scanning pulse “Pw” is sequentially applied to the scanning electrode 101 and, at the same time, a data pulse “Pd” is applied to the data electrode 118 according to data to be displayed. In the sixth embodiment, as the base potential Vbw, for example, about 30V is used. During the above operations, the sustaining electrode 103 is held at the sustaining voltage Vs and the scanning-side extending electrode 109 is held at the base potential Vbw and the sustaining-side extending electrode 122 is held at Vsm.

Moreover, in the facing electrode consisting of the scanning electrode 101 and the data electrode 118, the ultimate potential of the scanning pulse “Pw” and of the data pulse “Pd” is so set that, when either of the scanning pulse “Pw” or the data pulse “Pd” is singly applied, a facing electrode voltage between the scanning electrode 101 and data electrode 118 does not exceed a discharge starting threshold voltage and, when both the scanning pulse “Pw” and data pulse “Pd” are superimposed on each other, the facing electrode voltage exceeds the discharge starting threshold voltage. Moreover, a potential of the scanning pulse “Pw” is set so that, when a scanning pulse “Pw” is applied, a surface electrode voltage between the scanning electrode 101 and sustaining electrode 103 does not exceed a discharge starting threshold voltage. For example, the ultimate potential of the scanning pulse “Pw” is about −70V and the ultimate potential of the data pulse “Pd” is about 70V. The facing electrode voltage and surface electrode voltage described above are defined as a combined value of a voltage to be applied from outside and a voltage (wall voltage) produced by wall charges formed within a discharge cell.

Only in a display cell in which the data pulse “Pd” has been applied with timing of application of the scanning pulse “Pw”, facing discharge between the scanning electrode 101 and the data electrode 118 occurs. At this point, a potential is produced between the scanning electrode 101 and sustaining electrode 103 by the application of the voltage of the scanning pulse “Pw” and the sustaining electrode 103, which triggers facing discharge to occur between the scanning electrode 101 and sustaining electrode 103. This discharge serves as writing discharge. As a result, in the selected display cell, positive wall charges are formed on the scanning electrode 101 and negative wall charges are formed on the sustaining electrode 103 and such the charge formation serves as a writing operation.

At this point, the scanning-side extending electrode 109 is held at a base potential Vbw. Therefore, a potential difference between the scanning-side extending electrode 109 and the sustaining electrode 103 is lower than the potential difference between the scanning electrode 101 and sustaining electrode 103 and considerably lower compared with the sustaining voltage Vs. Therefore, writing discharge does not extend through the scanning-side extending electrode 109.

Moreover, the sustaining-side extending electrode 122 is held at a potential being an intermediate voltage between the sustaining voltage Vs and the ground potential GND. Therefore, a potential difference between the sustaining-side extending electrode 122 and the scanning electrode 101 is lower than the potential difference between the sustaining electrode 103 and scanning electrode 101 and considerably lower compared with the sustaining voltage Vs.

As a result, writing discharge does not extend through the sustaining-side extending electrode 122.

During the sustaining period C following the selective operating period B, all the scanning electrodes 101 and all the scanning-side extending electrodes 109 are held at the sustaining voltage Vs and a first sustaining pulse “Psf” having a crest voltage being the sustaining voltage Vs and of positive polarity is applied to the sustaining electrode 103 and sustaining-side extending electrode 122. The sustaining voltage Vs is set at a voltage at which, when a wall voltage generated on a surface electrode by writing discharge during the selective operating period B is superimposed on the sustaining voltage Vs, discharge occurs and at a voltage, when there is no such the superimposition of the wall charge, a surface electrode voltage does not exceed the discharge starting threshold voltage and no discharge occurs. A width of the first sustaining pulse “Psf” is set at, for example, as comparatively long as 5 micro seconds so that sustaining discharge occurs in a stable manner.

Therefore, only in a display cell in which writing discharge occurs and wall charges are formed during the selective operating period B, sustaining discharge occurs between the scanning electrode 101 and the sustaining electrode 103. By the occurrence of the sustaining discharge, negative wall charges are formed on the scanning electrode 101 and positive wall charges are formed on the sustaining electrode 103. At this point, since the scanning-side extending electrode 109 also is held at the sustaining voltage Vs, as in the case of the scanning electrode 101, negative wall charges are formed on the scanning-side extending electrode 109. Moreover, a first sustaining pulse “Psf” is applied to the sustaining-side extending electrode 122 and, therefore, positive wall charges are formed on the sustaining electrode 103.

Then, the sustaining electrode 103 and sustaining-side extending electrode 122 are fixed at the sustaining voltage Vs and a sustaining pulse “Ps” having a crest voltage being the sustaining voltage Vs and of negative polarity is applied to the scanning electrode 101 and scanning-side extending electrode 109. As a width of the sustaining pulse “Ps”, for example, about 2 micro seconds are used. At this point, since negative wall charges are formed on both the scanning electrode 101 and the scanning-side extending electrode 109, both of the electrode 101 and 109 act independently and equally as surface discharge electrodes on a scanning side. Since positive wall charges are formed on both the sustaining electrode 103 and the sustaining-side extending electrode 122, both of the electrode 102 and 122 act independently and equally as surface discharge electrodes on a sustaining side. This causes the occurrence of sustaining discharge by four electrodes including the surface discharge electrodes on the scanning side and on the sustaining-side.

Furthermore, by alternate and continuous application of the sustaining pulses “Ps” having a crest voltage being the sustaining voltage Vs and being reversed in phase to each other to scanning-side surface discharge electrodes made up of the scanning electrode 101 and scanning-side extending electrode 109 and to sustaining-side surface discharge electrodes made up of the sustaining electrode 103 and sustaining-side extending electrode 122, sustaining discharge occurs continuously.

During the sustaining erasing period D following the sustaining period C, the sustaining electrode 103 and sustaining-side extending electrode 122 are fixed at the sustaining voltage Vs and a sawtooth-shaped sustaining erasing pulse “Pes” of negative polarity is applied to the scanning electrode 101. Moreover, a sustaining erasing pulse “Pea” having the same shape as the pulse “Pes” is applied also to the scanning-side extending electrode 109. In the embodiment, as the ultimate potential of these sustaining erasing pulses “Pea” and “Pes”, for example, about −60V is used. As their inclinations, for example, 3V/micro second is used.

By these processes, feeble discharge occurs between the scanning electrode 101 and sustaining electrode 103 and wall charges on the surface electrodes are erased and the charged state returns back to the state before the pre-discharging pulses “Pps”, “Ppc”, and “Ppac” were applied during the pre-discharging period A. This discharge, since it is feeble, occurs only in the vicinity of the main discharge gap 4 and, therefore, there is no change in the wall charges on the scanning-side extending electrode 109 and sustaining-side extending electrode 122. The process of erasing the wall charges performed during the sustaining erasing period D includes a process of calibrating the wall charges, which is needed to achieve favorable operations in subsequent processes.

According to the plasma display device of the sixth embodiment, as in the case of the fifth embodiment, by making small an area of the scanning electrode 101 to be used for writing discharge, discharge currents that flow by writing discharge can be reduced. Also, by making large a total area of the scanning electrode 101 and the scanning-side extending electrode 109 and a total area of the sustaining electrode 103 and the sustaining-side extending electrode 122, currents that flow by the sustaining discharge can be increased and unit light-emitting luminance can be enhanced. Therefore, according to the sixth embodiment, as in the case of the fifth embodiment as shown in FIG. 16, low-cost plasma display device providing high luminance can be manufactured in an enhanced yield.

As described in the fifth embodiment, in order to reduce discharge currents that flow by the writing discharge, to make small an electrode area of the scanning electrode 101 is sufficient. However, in the sixth embodiment, in order to reduce the discharge currents that flow by writing discharge, one of the surface discharge-electrodes on the sustaining side is divided as in the case of the surface discharge electrodes on the scanning side. Advantages obtained by dividing the surface discharge electrodes on the sustaining side are described below.

As described above, even if an area of the sustaining electrode 103 is large, currents that flow by discharge are limited by an area of the scanning electrode 101 having a small area. An amount of charges accumulated on the electrodes is proportional to an amount of currents and, therefore, an amount of charges formed on the electrodes becomes small as the area of the scanning electrode 101 becomes small. Since the area of the scanning electrode 101 has been reduced, a density of a charge to be accumulated is not different greatly from that obtained in the case where an electrode area is large. However, in the case where the sustaining electrode 103 is not divided as in the case of the fifth embodiment, since the sustaining electrode 103 is considerably larger in size than the scanning electrode 101, the density of the charge to be accumulated on the sustaining electrode 103 becomes considerably small. In the case where the density of the charge is low, it is difficult to cause sustaining discharge that occurs first during the sustaining period C to be made to occur in a stable manner, which acts as a factor to inhibit a change in discharge from writing discharge to sustaining discharge. On the other hand, if the surface discharge electrodes have been divided into the sustaining electrode 103 and sustaining-side extending electrode 122, a density of a charge to be accumulated on the sustaining electrode 103 becomes high as in the case of the scanning electrode 101. This enables stable occurrence of first sustaining discharge during the sustaining period C and, therefore, the change of the discharge to sustaining discharge is not inhibited.

In the fifth and sixth embodiments, due to the division of the electrode, the number of trace electrodes in a cell increases. The trace electrode is not transparent and shields light from the cell and, therefore, the increased number of the trace electrodes causes inhibition of high luminance of the plasma display device. However, since an amount of currents that flow through each electrode decreases in proportional to an electrode area, a width of each trace electrode can be made small in size compared with that of a known plasma display device. This makes it possible to maintain an aperture rate being approximately the same as that in the known plasma display device.

### Seventh Embodiment

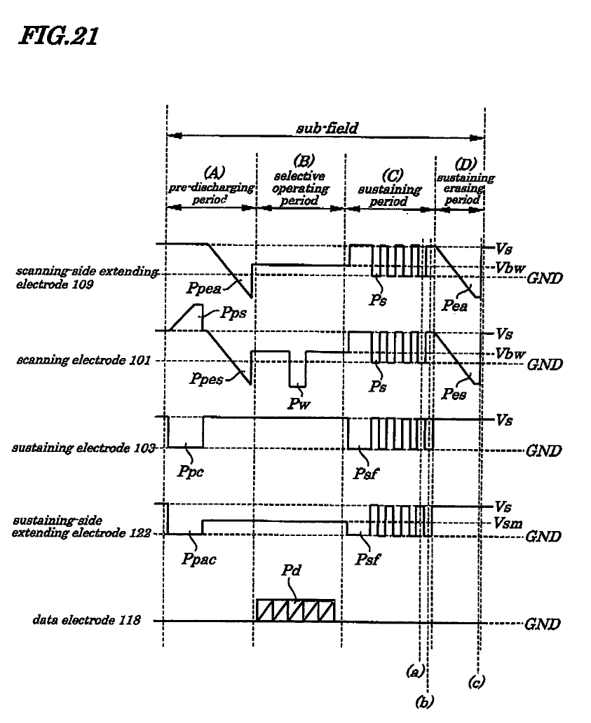

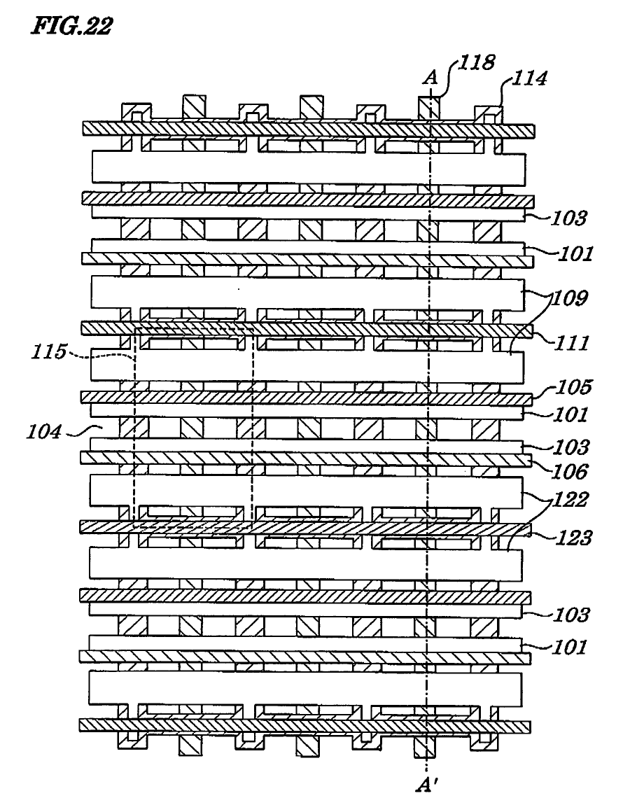

FIG. 22 is a plan view of a plasma display device of a seventh embodiment of the present invention. Configurations of the plasma display device of the seventh embodiment are the same as those shown in the known plasma display device shown in FIG. 17 except structures of electrodes formed on a front substrate. That is, the rib 114 formed on a rear substrate (not shown) is structured so as to have a parallel cross shape so that the rib 114 partitions cells being adjacent to one another in right/left and up/down directions. Therefore, a unit display cell 115 is defined by the rib 114. By configuring as above, discharge interference among the unit display cells 115 being adjacent to one another in up and down directions is suppressed by the rib 114 in a horizontal direction and, therefore, there is no need for forming a non-discharge gap to suppress the discharge interference.

On a front substrate are formed transparent scanning electrodes 101 and sustaining electrodes 103 with a main discharge gap being interposed between the scanning electrode 101 and sustaining electrode 103 and metal trace electrodes 105 and 106 to reduce a resistance value of these electrodes are arranged so as to be overlain, respectively, on the transparent scanning electrode 101 and the sustaining electrode 103. A transparent scanning-side extending electrode 109 is formed on a side being opposite to the main discharge gap 104 of the scanning electrode 101. Similarly, a sustaining-side extending electrode 122 is formed on a side being opposite to the main discharge gap 104 of the sustaining electrode 103. In the seventh embodiment, an order of arrangement between the scanning electrode 101 and the sustaining electrode 103 is interchanged for every display line. Therefore, in the cells being adjacent to one another in up and down directions, the scanning-side extending electrode 109 and the sustaining-side extending electrode 122 are formed so as to be adjacent to one another. Therefore, metal trace electrodes 111 and 123 to be used for reducing resistance values of the scanning-side extending electrode 109 and the sustaining-side extending electrode 122 are formed so as to be overlain on the rib 114 formed among up/down display cells 115 in a horizontal direction and are used commonly by display lines adjacent to one another in up and down directions.

Here, a clearance is formed in portions of each of the scanning-side extending electrode 109 and sustaining-side extending electrode 122 being touched to the rib 114 formed in a horizontal direction. This is used, when a positional deviation between the front substrate 102 and rear substrate occurs, to prevent an electrode area from being changed by overlying between each electrode and the rib 114. Therefore, if a user does not care such the change in an electrode area, there is no need for employing such the structure described as above and a simple and belt-like electrode structure can be used.

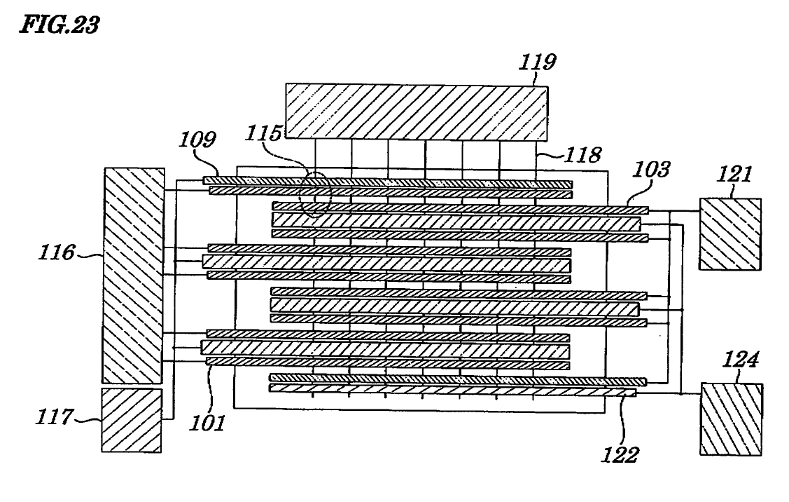

FIG. 23 is a circuit block diagram showing connection between each electrode and a driving circuit of the seventh embodiment. Electricity and/or signals from the scanning electrode 101 are taken out individually for every display line and the scanning electrode 101 is individually connected to a scanning driver 116. All the scanning-side extending electrodes 109 are electrically connected to one another and are connected to a scanning-side extending driver 117. On the other hand, all the sustaining electrodes 103 are electrically connected to one another and are connected to a sustaining driver 121. All the sustaining-side extending electrodes 122 are electrically connected to one another and are connected to a sustaining-side extending driver 124. Each of the data electrodes 118 is individually connected to a data driver 119.

The plasma display device of the seventh embodiment differs from those of the sixth embodiment in arrangement of each electrode in an entire panel and a positional relation of each electrode to cells adjacent to one another in up and down directions. However, the plasma display device of the seventh embodiment can be considered to be the same as those of the fifth embodiment in that a pair of the scanning electrode 101 and the sustaining electrode 103 is formed in a central portion of the display cell 115 with a main discharge gap 104 being interposed between the scanning electrode 101 and the sustaining electrode 103 and the scanning-side extending electrode 109 and the sustaining-side extending electrode 122 are arranged on portions being opposite to the main discharge gap 104 of each electrode. Therefore, the plasma display device of the seventh embodiment can be operated by the operating method employed in the fifth embodiment.

In the plasma display device of the seventh embodiment, also by reducing an area of the scanning electrode 101 to be used for writing discharge, discharge currents that flow by writing discharge can be reduced. Moreover, by making large a total area of the scanning electrode 101 and the scanning-side extending electrode 109 and a total area of the sustaining electrode 103 and sustaining-side extending electrode 122, currents that flow by sustaining discharge can be increased and unit light-emitting luminance can be enhanced.

Moreover, in the plasma display device of the seventh embodiment, since there is no need for forming the non-discharge gap 113 as shown in FIG. 16, an electrode area between the scanning-side extending electrode 109 and sustaining-side extending electrode 122 can be made wider and, therefore, by further increasing a sustaining discharge current, unit light-emitting luminance can be enhanced.

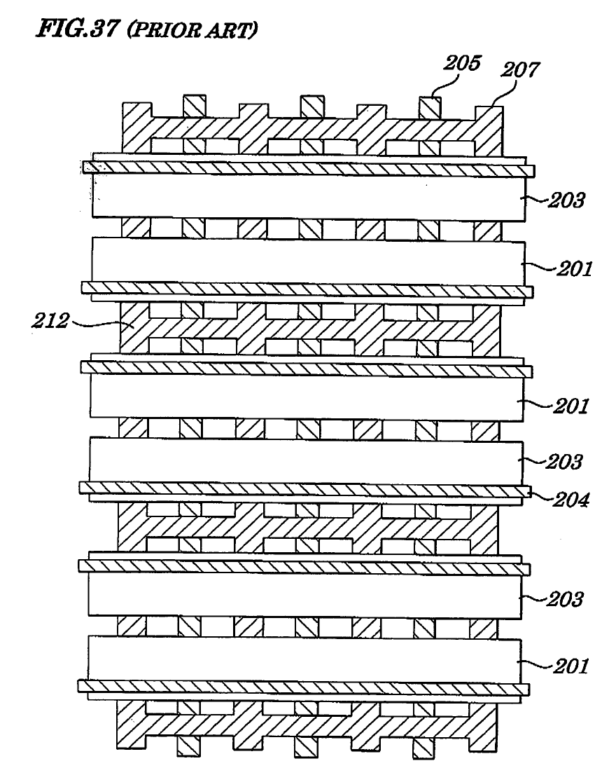

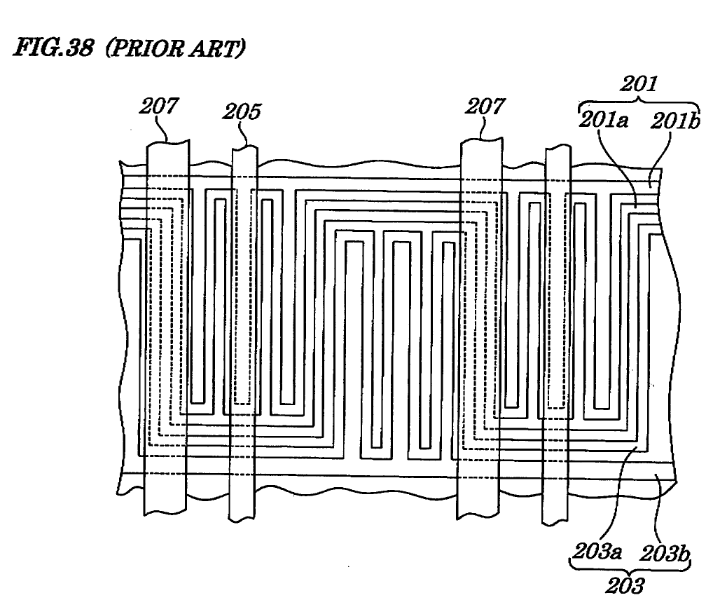

Moreover, in the PDP of the seventh embodiment, non-transparent trace electrodes 111 and 123 formed in juxtaposition with the scanning-side extending electrode 109 and sustaining-side extending electrode 122 are overlain on the rib 114 in a horizontal direction. As a result, light emitted for displaying is not shielded and the number of the trace electrodes 111 that shield the light emitted for displaying is two as in the case of the known PDP shown in FIG. 37. Also, in the PDP of the seventh embodiment, areas of electrodes made up of the scanning electrode 101 and sustaining electrode 103 are small and an amount of currents that flow through the trace electrode 105 and 106 is made small and, therefore, it is possible to make narrow a width of the trace electrodes 105 and 106 when compared with the known PDP. This enables an aperture rate to be higher than that of the known PDP and the plasma display device to have high luminance.

Also, the PDP of the seventh embodiment is so constructed that the scanning-side extending electrode 109 and sustaining-side extending electrode 122 are shared by the display cells 115 being adjacent to one another in up and down directions. As a result, the number of the electrodes electrically drawn from the panel is about 1.5 times larger than the number of display lines on both the scanning-side and sustaining-side, which enables reduction in the number of electrodes.

### Eighth Embodiment

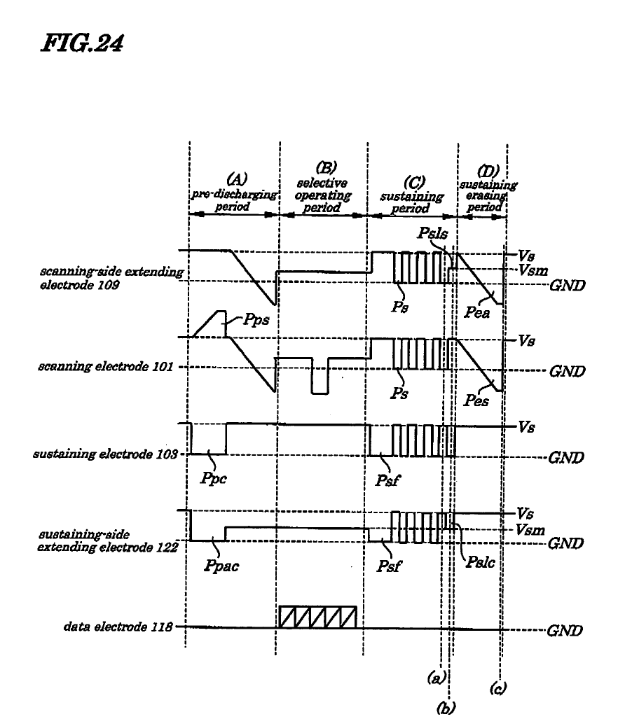

FIG. 24 is a timing chart showing a method for driving the plasma display device of an eighth embodiment of the present invention. Configurations of the eighth embodiment are the same as those employed in the seventh embodiment, however, a method for driving the plasma display device of the eighth embodiment differs from that of the seventh embodiment. In FIG. 24, a period A is a pre-discharging period used to cause discharge to easily occur during a subsequent selective operating period, a period B is the selective operating period during which an ON/OFF operation for displaying in each display cell is selected, a period C is a sustaining period during which discharge for displaying in all display cells selected is made to occur, and a period D is a sustaining erasing period during which discharge for displaying is stopped.

A waveform of a pulse to be applied to each electrode is the same as that used in the fifth and sixth embodiments shown in FIG. 21 except each of the waveforms of the pulses applied during the sustaining period C. During the sustaining period C, all the scanning electrodes 101 and scanning-side extending electrodes 109 are held at the sustaining voltage Vs and a first sustaining pulse “Psf” having its crest voltage being the sustaining voltage Vs and of a negative polarity is applied to the sustaining electrode 103 and sustaining-side extending electrode 122. The sustaining voltage Vs is set at a voltage at which discharge occurs when a wall voltage generated on a surface electrode by writing discharge during the selective operating period B is superimposed on the sustaining voltage Vs, and at a voltage at which, when there is no superimposition of the wall charge, a surface electrode voltage does not exceed the discharge starting threshold voltage and no discharge occurs. A width of the first sustaining pulse “Psf” is set to be as comparatively long as, for example, about 5 micro seconds so that the sustaining discharge occurs in a stable manner.

Therefore, only in a cell in which writing discharge has occurred and wall charges have been formed during the selective operating period B, sustaining discharge occurs between the scanning electrode 101 and the sustaining electrode 103. By the occurrence of the sustaining discharge, negative wall charges are formed on the scanning electrode 101 and positive wall charges on the sustaining electrode 103. At this point, since the scanning-side extending electrode 109 are also held at the sustaining voltage Vs, as in the case of the scanning electrode 101, negative wall charges are formed also on the scanning-side extending electrode 109. Moreover, to the sustaining-side extending electrode 122 is applied a first sustaining pulse “Psf” and, therefore, positive wall charges are formed on the sustaining-side extending electrode 122 as in the case of the sustaining electrode 103.

Then, the sustaining electrode 103 and sustaining-side extending electrode 122 are fixed at the sustaining voltage Vs and a sustaining pulse “Ps” having its crest voltage being the sustaining voltage Vs and of negative polarity is applied to the scanning electrode 101 and scanning-side extending electrode 109. In the eighth embodiment, a width of the sustaining pulse “Ps” is, for example, about 2 micro seconds. At this time, since negative wall charges are formed on both the scanning electrode 101 and scanning-side extending electrode 109, both of the electrodes 101 and 109 act independently and equally as surface discharge electrodes on a scanning side. Also, at this time, since positive wall charges are formed on both the sustaining electrode 103 and sustaining-side extending electrode 122, both of the electrodes 103 and 122 act independently and equally as surface discharge electrodes on a sustaining-side. This causes the occurrence of sustaining discharge by four electrodes including the surface discharge electrodes on the scanning side and on the sustaining-side.

Furthermore, sustaining pulses “Ps” having their crest voltages being the sustaining voltage Vs and being reversed in phase to each other are applied, alternately and continuously, to scanning-side surface discharge electrodes made up of the scanning electrode 101 and scanning-side extending electrode 109 and to sustaining-side surface discharge electrodes made up of the sustaining electrode 103 and sustaining-side extending electrode 122. This causes sustaining discharge to occur continuously.

Up to this point, the operations described above are the same as those employed in the fifth and seventh embodiments. However, in the eighth embodiment, driving methods employed immediately before a shift to the sustaining erasing period D differ from those in the fifth and seventh embodiments. The scanning electrode 101 is held at the sustaining voltage Vs and a sustaining pulse “Ps” having its crest voltage being the sustaining voltage Vs and of negative polarity is applied to the sustaining electrode 103. At this point, such a final sustaining pulse “Psls” that makes a potential difference between the scanning-side extending electrode 109 and the sustaining electrode 103 be lower than the sustaining voltage Vs is applied to the scanning-side extending electrode 109 and such a final sustaining pulse “Pslc” that makes a potential difference between the sustaining-side extending electrode 122 and the scanning electrode 101 be lower than the sustaining voltage Vs is applied to the sustaining-side extending electrode 122. In the eighth embodiment, either of the final sustaining pulses “Psls” and “Pslc” is a potential Vsm being an intermediate potential difference between the sustaining voltage Vs and the ground potential GND.

Thereafter, during the sustaining erasing period D, the sustaining electrode 103 and sustaining-side extending electrode 122 are fixed at the sustaining voltage Vs and a negative-polarity sawtooth-shaped sustaining erasing pulse “Pes” is applied. Also, a sustaining erasing pulse “Pea” having the same waveform as the pulse “Pes” is applied to the scanning-side extending electrode 109. The ultimate potential of the sustaining erasing pulse is, for example, about −60V and an inclination of these pulses is set, for example, to be 3V/micro second.

By such the processes, feeble discharge occurs between the scanning electrode 101 and the sustaining electrode 103 and wall charges formed on both the electrodes are erased and the charged state returns back to the initial state where no charges are formed, that is, to the state before the pre-discharging pulses “Pps”, “Ppc”, and “Ppac” were applied during the pre-discharging period A. The discharge, since it is feeble, occurs only in the vicinity of the main discharge gap 104, there is no change in the wall charges formed on the scanning-side extending electrode 109 and on the sustaining-side extending electrode 122. The process of erasing the wall charges performed during the pre-discharging period D includes a process of calibrating the wall charges, which is needed to achieve favorable operations in subsequent processes.

In the eighth embodiment, operations during the pre-discharging period A and selective operating period B are the same as in the seventh embodiments. Therefore, according to the plasma display device of the eighth embodiment, as in the case of the seventh embodiment, by making small an area of the scanning electrode 101 to be used for writing discharge, discharge currents that flow by writing discharge can be reduced. Also, by making large a total area of the scanning electrode 101 and the scanning-side extending electrode 109 and a total area of the sustaining electrode 103 and the sustaining-side extending electrode 122, currents that flow by sustaining discharge can be increased and unit light-emitting luminance can be enhanced accordingly.

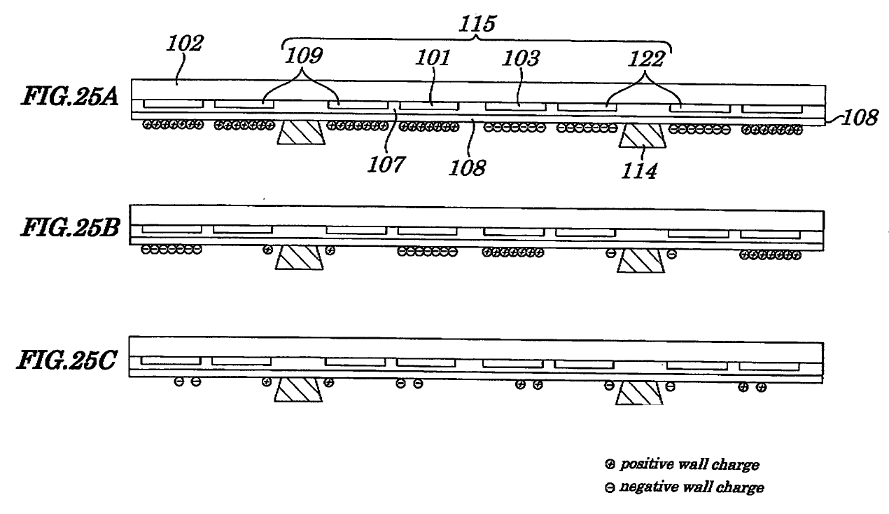

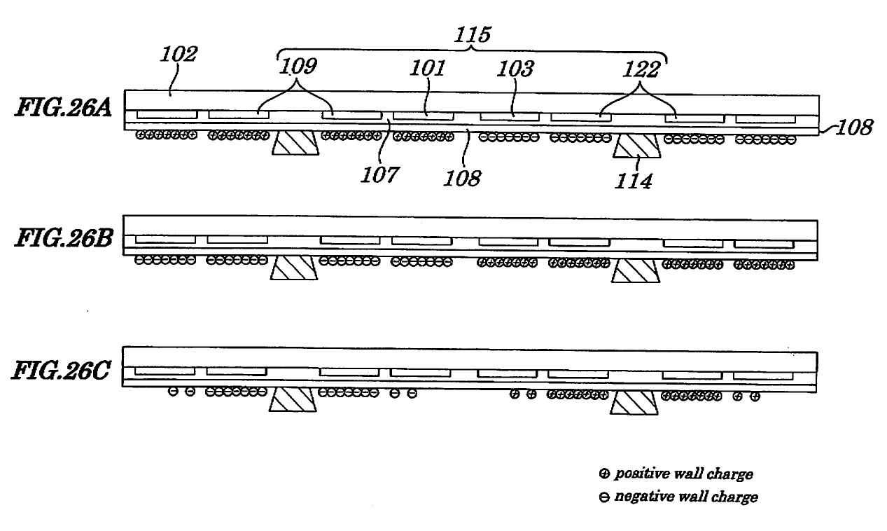

Operations being different from those in the seventh embodiment are described below. FIGS. 25A, 25B, and 25C and FIGS. 26A, 26B, and 26C show cross-sectional views along a line A-A′ showing the display cell 115 with wall charges formed therein in the PDP in the sixth and seventh embodiments shown in FIG. 22. FIGS. 25A, 25B, and 25C show the state in the eighth embodiment and FIGS. 26A, 26B, and 26C show the state in the seventh embodiment. FIGS. 25A and 25A show the states occurring immediately before a final sustaining pulse is applied, and FIGS. 25B and 26B show the states occurring after the final sustaining pulse has been applied. FIGS. 25C and 26C show the states after a sustaining erasing pulse has been applied. In FIGS. 25A to 25C, and 26A to 26C, rear substrates and components other than the rib 114 mounted on the rear substrate are not shown, however, dielectric layers 107 and protecting layers 108 in addition to each electrode out of components formed on front substrates 102 are shown. Description of the trace electrodes 105, 106, 111, and 123 are omitted.

At a time immediately before the final sustaining pulse is applied, there is no difference in operations explained in the time charts and shown in the states in FIG. 25A and FIG. 26A between the seventh and eighth embodiments. That is, no difference is found in accumulated states of wall charges between them immediately before the final sustaining pulse is applied. At a time immediately before the application of the final sustaining pulse, the discharge occurs when the sustaining electrode 103 and sustaining-side extending electrode 122 are held at the sustaining voltage Vs and the sustaining pulse “Ps” is applied to the scanning electrode 101 and scanning-side extending electrode 109. By this discharge, positive wall charges are accumulated on the scanning electrode 101 and scanning-side extending electrode 109 and negative wall charges are accumulated on the sustaining electrode 103 and sustaining-side extending electrode 122 (see FIGS. 25A and 26A).

Then, in the seventh embodiment, the scanning electrode 101 and scanning-side extending electrode 109 are held at the sustaining voltage Vs and a sustaining pulse “Ps” is applied to the sustaining electrode 103 and sustaining-side extending electrode 122. As a result, negative wall charges are accumulated on the scanning electrode 101 and scanning-side extending electrode 109 and positive wall charges are accumulated on the sustaining electrode 103 and sustaining-side extending electrode 122 (see FIG. 26B).

Then, in the eighth embodiment, the scanning electrode 101 is held at the sustaining voltage Vs and, since a sustaining pulse “Ps” is applied to the sustaining electrode 103, sustaining discharge occurs which causes negative walls to be accumulated on the scanning electrode 101 and positive walls to be accumulated on the sustaining electrode 103. At this time, the since final sustaining pulse “Psls” has been applied to the scanning-side extending electrode 109, a potential difference between the sustaining-side extending electrode 122 and sustaining electrode 103 is sufficiently lower than the sustaining voltage Vs and, therefore, no negative wall charges are formed on the sustaining-side extending electrode 122.

On the other hand, positive wall charges formed by the sustaining discharge immediately before the final sustaining pulse was applied are neutralized and erased by a large amount of spatial charges formed by sustaining discharge between the scanning electrode 101 and sustaining electrode 103 and, as a result, a state occurs in which almost all the positive wall charges do not reside. Also, the same thing occurs in the sustaining-side extending electrode 122, that is, no positive wall charges are not formed newly and negative wall charges formed by the sustaining discharge immediately before the final sustaining pulse was applied are neutralized and erased. As a result, large amounts of wall charges are accumulated only on the scanning electrode 101 and sustaining electrode 103 (see FIG. 25B).

Then, a sustaining erasing pulse is applied. Since discharge occurring by the sustaining erasing pulse is feeble, it is only in the discharge gap 104 that a state of accumulation of wall charges changes. Therefore, both in the eighth and seventh embodiments, wall charges are erased on the scanning electrode 101 and sustaining electrode 103. As a result, in the eighth embodiment, the state in which large amounts of wall charges are accumulated does not occur. However, in the seventh embodiment, negative wall charges reside on the scanning-side extending electrode 109 and a state in which positive wall charges reside on the sustaining-side extending electrode 122 occurs (see FIG. 25C and FIG. 25C).

Since wall charges formed between the scanning electrode 101 and sustaining electrode 103 both sandwiching a main discharge gap, are calibrated by sustaining erasing process, basically no discharge occurs. However, in some cases, feeble discharge occurs due to interference by discharge in display cells adjacent to one another. In cases where large amounts of wall charges reside on the scanning-side extending electrode 109 and sustaining-side extending electrode 122 as in the case of the seventh embodiment, even if the discharge is feeble, discharge easily extends on entire display cells, erroneous discharge occurs which causes display image quality to be degraded. However, in the eighth embodiment, since there is no accumulation of large amounts of wall charges in display cells, feeble discharge having occurred unexpectedly does not extend easily on entire display cells and, therefore, erroneous discharge does not occur easily which enables degradation in display image quality to be prevented.

However, in order to obtain such the effect, a divided configuration of the scanning electrode 101 or the sustaining electrode 103 is of importance. To reduce currents flowing through the scanning electrode 101, it is preferable that the divided configuration can form the main discharge gap 104 and the electrodes 101 and 103 are small in area. To suppress erroneous discharge, it is preferable that location of the scanning electrode 101 and sustaining electrode 103 is limited to a place being near to the main discharge gap 104 and that the scanning-side extending electrode 109 and sustaining-side extending electrode 122 are located in a place being far from the main discharge gap 104.

To clarify differences in operations between the seventh and eighth embodiments, the advantage of the eighth embodiment is described by comparing with the seventh embodiment, however, occurrence of the erroneous discharge in the seventh embodiment is not a substantial feature of the present invention. As shown in FIG. 37, even if the scanning electrode 101 and the sustaining electrode 103 are so configured as not to be divided, since wall charges calibrated by sustaining erasing are formed only in the vicinity of the main discharge gap 104, wall charges formed by sustaining discharge reside in portions being far from the main discharge gap 104 even after the sustaining erasing. Due to this, in the known plasma display device as in the case of the seventh embodiment, as described above, erroneous discharge easily occurs.

### Ninth Embodiment

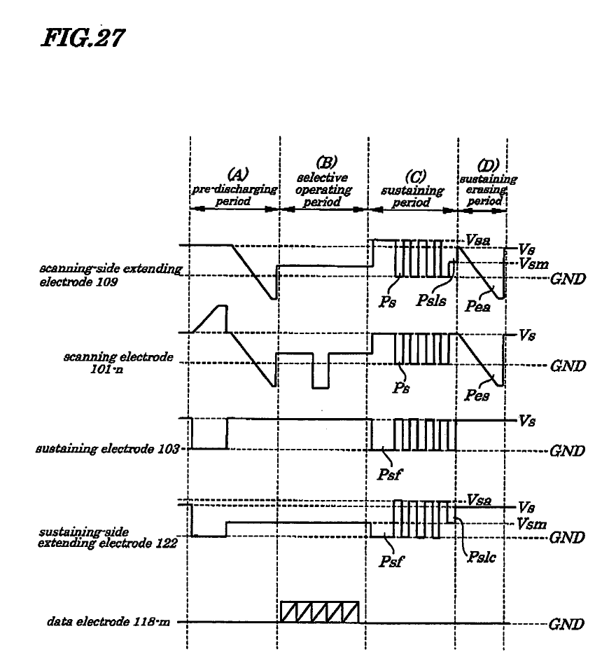

FIG. 27 shows a method for driving the plasma display device of a ninth embodiment of the present invention. Configurations of the ninth embodiment are the same as those of the seventh embodiment, however, differ from those of the seventh embodiment in the method for driving the plasma display device of the present invention. In FIG. 27, a period A is a pre-discharging period used to cause discharge to easily occur during a subsequent selective operating period, a period B is the selective operating period during which an ON/OFF operation for displaying in each display cell is selected, a period C is a sustaining period during which discharge for displaying in all display cells selected is made to occur, and a period D is a sustaining erasing period during which discharge for displaying is stopped.

Waveforms of pulses to be applied to each electrode are the same as those applied in the eighth embodiment shown in FIG. 24, except pulses to be applied during the sustaining period C. That is, during the sustaining period C, all the scanning electrodes 101 are held at the sustaining voltage Vs and a first sustaining pulse “Psf” having its crest voltage being the sustaining voltage Vs and of negative polarity is applied to the sustaining electrode 103 and the sustaining-side extending electrode 122. At this point, the scanning-side extending electrode 109 is held at an extended sustaining voltage Vsa which is higher than the sustaining voltage Vs. In the ninth embodiment, the extending sustaining voltage Vsa is, for example, about the sustaining voltage Vs+10V. The sustaining voltage Vs is set at a voltage at which discharge occurs when a wall voltage generated on a surface electrode by writing discharge during the selective operating period B is superimposed on the sustaining voltage Vs, and at a voltage at which, when there is no superimposition of the wall charge, a surface electrode voltage does not exceed the discharge starting threshold voltage and no discharge occurs. A width of the first sustaining pulse “Psf” is set to be as comparatively long as, for example, about 5 micro seconds so that the sustaining discharge occurs in a stable manner.

Therefore, only in a display cell in which writing discharge has occurred and wall charges have been formed during the selective operating period B, sustaining discharge occurs between the scanning electrode 101 and the sustaining electrode 103. By the occurrence of the sustaining discharge, negative wall charges are formed on the scanning electrode 101 and positive wall charges are formed on the sustaining electrode 103. At this point, the scanning-side extending electrode 109 are also held at the extended sustaining voltage Vsa, negative wall charges are formed on the scanning-side extending electrode 109 as in the case of the scanning electrode 101. Moreover, since the first sustaining pulse “Psf” has been applied to the sustaining-side extending electrode 122, positive wall charges are formed as in the case of the sustaining electrode 103.

Then, the sustaining electrode 103 is fixed at the sustaining voltage Vs and a sustaining pulse “Ps” having its crest voltage being the sustaining voltage Vs and of negative polarity is applied to the scanning electrode 101 and scanning-side extending electrode 109. At this point, the sustaining-side extending electrode 122 is held at the extended sustaining voltage Vsa. In the ninth embodiment, a width of a sustaining pulse “Ps” is, for example, 2 micro seconds. At this time, since negative wall charges are formed on both the scanning electrode 101 and scanning-side extending electrode 109, both of them act as surface discharge electrodes on a scanning side. Also, since positive wall charges are formed on both the sustaining electrode 103 and sustaining-side extending electrode 122, both of them act as surface discharge electrodes on a sustaining side. This causes the occurrence of sustaining discharge by four electrodes including the surface discharge electrodes on the scanning side and on the sustaining-side.

Then, negative-polarity sustaining pulses “Ps” whose crest voltages are the sustaining voltage Vs and whose phases are reversed to one another are alternately and continuously applied to the surface discharge electrodes made up of the scanning electrode 101 and the scanning-side extending electrode 109 on the scanning side and to the surface discharge electrodes made up of the sustaining electrode 103 and the sustaining-side extending electrode 122 on the sustaining side. During a period of time when a sustaining pulse “Ps” has not been applied, the scanning electrode 101 and sustaining electrode 103 are held at the sustaining voltage Vs and the scanning-side extending electrode 109 and the sustaining-side extending electrode 122 are held at the extended sustaining voltage Vsa. This causes sustaining discharge to occur continuously.

Immediately before a period shift to the sustaining erasing period D, the scanning electrode 101 is held at the sustaining voltage Vs and a sustaining pulse “Ps” having its crest voltage being the sustaining voltage Vs and of negative polarity is applied to the sustaining electrode 103. At this point, such a final sustaining pulse “Psls” that makes a potential difference between the scanning-side extending electrode 109 and the sustaining electrode 103 be lower than the sustaining voltage Vs is applied to the scanning-side extending electrode 109 and such a final sustaining pulse “Pslc” that makes a potential difference between the sustaining-side extending electrode 122 and the scanning electrode 101 be lower than the sustaining voltage Vs is applied to the sustaining-side extending electrode 122. In the ninth embodiment, both of the final sustaining pulses “Psls” and “Pslc” are set at a potential Vsm being an intermediate voltage between the sustaining voltage Vs and ground potential GND.

During the sustaining erasing period D, the sustaining electrode 103 and the sustaining-side extending electrode 122 are fixed at the sustaining voltage Vs and a negative-polarity sawtooth-shaped sustaining erasing pulse “Pes” is applied to the scanning electrode 101. Moreover, a sustaining erasing pulse “Pea” having the same waveform shape as the pulse “Pes” is applied also to the scanning-side extending electrode 109. As the ultimate voltage, for example, −60V is used in the ninth embodiment and, as an inclination of the pre-discharging pulse “Pes” and “Pea”, about 3V/micro second is used.

By such the processes, feeble discharge occurs between the scanning electrode 101 and the sustaining electrode 103 and wall charges formed on both the electrodes 101 and 103 are erased and the charged state returns back to the initial state, that is, to the state before the pre-discharging pulses “Pps” and “Ppc” were applied during the pre-discharging period A. The discharge, since it is feeble, occurs only in the vicinity of the main discharge gap 104, there is no change in the wall charges formed on the scanning-side extending electrode 109 and on the sustaining-side extending electrode 122. The process of erasing wall charges performed during the pre-discharging period D includes a process of calibrating the wall charges which is needed to achieve favorable operations in subsequent processes.

In the ninth embodiment, operations to be performed during the pre-discharging period A and selective operating period B are the same as those in the eighth embodiment. Therefore, in the plasma display device of the ninth embodiment, as in the case of the eighth embodiment, by making small an area of the scanning electrode 101 to be used for writing discharge, discharge currents that flow by the writing discharge can be reduced. Also, by making large a total area of the scanning electrode 101 and the scanning-side extending electrode 109 and a total area of the sustaining electrode 103 and the sustaining-side extending electrode 122, currents that flow by the sustaining discharge can be increased and unit light-emitting luminance can be enhanced accordingly.

Moreover, according to the plasma display device of the ninth embodiment, stability of display operations can be enhanced further.

An optimal voltage to be used for driving the plasma display device is set by being selected out of combinations of various factors including characteristics of the PDP or driving methods to be used for driving the plasma display device. Out of them, the sustaining voltage Vs to cause discharge for displaying to occur is an important potential to be used as a reference voltage for driving. Generally, a lower limit of the sustaining voltage Vs is defined by a minimum sustaining voltage Vsmin which is necessary for continuous discharge between surface electrodes. On the other hand, a higher limit is defined by a maximum sustaining voltage Vsmax being a highest voltage that can prevent erroneous discharge from occurring due to the sustaining pulse “Ps”. Therefore, the sustaining voltage Vs is set at any one of voltages within a sustaining voltage margin that is defined by the minimum sustaining voltage Vsmin and maximum sustaining voltage Vsmax.

Secular changes are observed in characteristics of voltages described above and, therefore, a display failure occurs if the sustaining voltage Vs is out of the sustaining voltage margin. Due to this, in order to realize a continuous and stable display, it is important that secular changes in characteristics of voltages have to be suppressed and a wider sustaining margin has to be secured.

Factors for determination of the sustaining voltage margin are described in detail. When a voltage is applied between surface discharge electrodes, an electric field becomes intense in the vicinity of the main discharge gap 104. Therefore, first discharge occurs in the vicinity of the main discharge gap 104. At this point, if a sufficiently high voltage is applied between the surface discharge electrodes, discharge extends through entire display cells which serves as sustaining discharge. Because of this, the maximum sustaining voltage Vsmax is determined depending on whether or not discharge occurs in the vicinity of the main discharge gap 104 and contribution to voltages by electrodes located in portions being far from the discharge gap is small.

On the other hand, when a voltage to be applied between surface discharge electrodes is low, an electric field therein is weak in portions being far from the main discharge gap 104 and, therefore, even if discharge occurs in the vicinity of the main discharge gap 104, the discharge does not extend through entire surface discharge electrodes. Due to this, the discharge occurs continuously only in the vicinity of the main discharge gap 104 or sustaining discharge stops. Even if the discharge occurs continuously in the vicinity of the main discharge gap 104, since the extension of the discharge is small, luminance is very low. Moreover, since a difference exists in the way of the extension of the discharge due to a difference in characteristics in every display cell, a difference in luminance is large in every display cell and the discharge cannot be used as the discharge for displaying. Therefore, in order to make a display in a stable manner, the extension of discharge through entire display cells is needed and application of more higher voltage is required. As a result, a following relation (1) holds:
Vsmin=Vsmr+Va (1)
where “Vsmr” denotes a voltage that enables discharge to occur continuously in the vicinity of the main discharge gap 104 and “Vsmin” denotes a minimum sustaining voltage which is obtained by adding an extended voltage Va which is needed to extend the discharge through the display cell to the voltage “Vsmr”.

In the ninth embodiment, a voltage being applied to the scanning-side extending electrode 109 and sustaining-side extending electrode 122 both being located far from the main discharge gap 104 during the sustaining period C is an extended sustaining voltage Vsa which is higher than the sustaining voltage Vs. A sustaining voltage margin employed in such the plasma display device as above is somewhat different from the case described above.

The maximum sustaining voltage Vsmax is determined depending on whether main discharge occurs in the vicinity of the main discharge gap 104 or not. At this time, even if a voltage to be applied to the scanning-side extending electrode 109 or the sustaining-side extending electrode 122 being located far from the main discharge gap 104 is somewhat high, an electric field existing in the vicinity of the main discharge gap 104 is not affected. Therefore, almost no change in the maximum sustaining voltage Vsmax occurs by application by the driving method of the ninth embodiment.

On the other hand, though the minimum sustaining voltage Vsmin is defined by a voltage needed to let discharge extend through entire display cells, since a region where discharge does not extend easily is far from a region located far from the main discharge gap 104, by applying Vsmr being a minimum potential required for maintaining the discharge in the main discharge gap 104 between the scanning electrode 101 and sustaining electrode 103 being located near to the main discharge gap 104 and by applying the total voltage of Vsmr and the extended voltage Va to the scanning-side extending electrode 109 and sustaining-side extending electrode 122 being far from the main discharge gap 104, it is possible to let sustaining discharge which extends through entire display cells occur continuously. That is, if the extended sustaining voltage Vsa can be set as shown by a following equation (2), the minimum sustaining voltage Vsmin can be reduced by the extended voltage Va and, as a result, the sustaining voltage margin can be extended.
Vsa=Vs+Va (2)

The extended voltage Va, though it varies depending on configurations of the PDP and its driving method, is about 5V to 15V according to estimation by inventors of the present invention. According to the ninth embodiment, the plasma display device can be provided which is capable of widening a sustaining voltage margin and of preventing occurrence of a display failure caused by secular change and of being operated in a highly stable manner.

### Tenth Embodiment

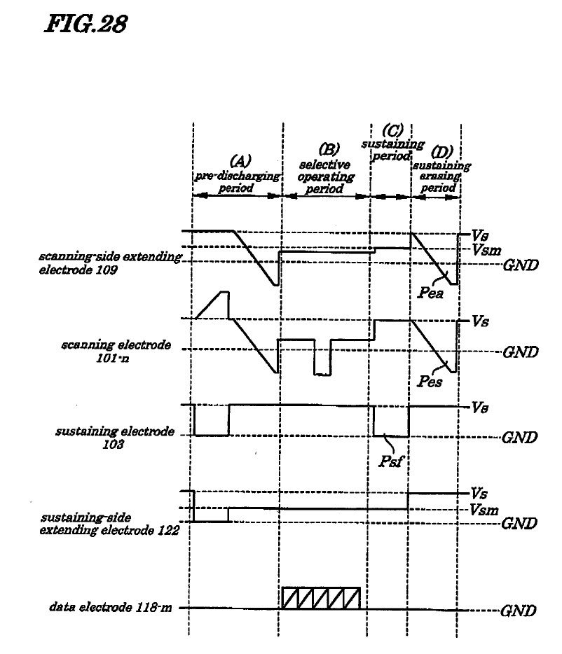

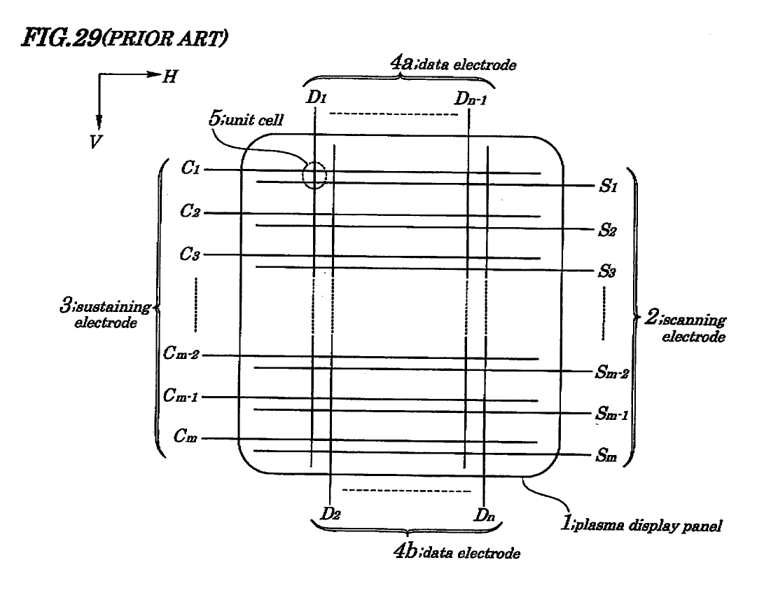

FIG. 28 is a timing chart showing a method for driving a plasma display device of a tenth embodiment of the present invention. Configurations of the PDP of the tenth embodiment are the same as those employed in the seventh embodiment. Moreover, basic driving methods of the tenth embodiment are the same as those in the eighth embodiment. However, the PDP of the tenth embodiment differs from those of other embodiments in that it employs a sub-field (hereinafter, referred to as an “LSB”) that represents minimum luminance.

In FIG. 28, a period A is a pre-discharging period used to cause discharge to easily occur during a subsequent selective operating period, a period B is the selective operating period during which an ON/OFF operation for displaying in each display cell is selected, a period C is a sustaining period during which discharge for displaying in all display cells selected is made to occur, and a period D is a sustaining erasing period during which discharge for displaying is stopped.

A waveform of a pulse to be applied to each electrode is the same as that used in the embodiment shown in FIG. 24 except each of the waveforms of the pulses applied during the sustaining period C. During the sustaining period C, all the scanning electrode 101 are held at the sustaining voltage Vs and a first sustaining pulse “Psf” having its crest voltage being the sustaining voltage and of a negative polarity is applied to the sustaining electrode 103. At this point, such a first sustaining pulse “Psfs” that makes a potential difference between the scanning-side extending electrode 109 and the sustaining electrode 103 be lower than the sustaining voltage Vs is applied to the scanning-side extending electrode 109 and such a final sustaining pulse “Psfc” that makes a potential difference between the sustaining-side extending electrode 122 and the scanning electrode 101 be lower than the sustaining voltage Vs is applied to the sustaining-side extending electrode 122. In the tenth embodiment, both of the first sustaining pulses “Psfs” and “Psfc” are set at a potential Vsm being an intermediate voltage between the sustaining voltage Vs and ground potential GND. A width of the first sustaining pulse “Psf”, “Psfs”, and “Psfc” is set to be as comparatively long as, for example, about 5 micro seconds so that the sustaining discharge occurs in a stable manner.

Both of potentials between the scanning electrode 101 and sustaining-side extending electrode 122 and between the scanning-extending electrode 109 and sustaining electrode 103 are set to be sufficiently lower than the sustaining voltage Vs, the sustaining discharge does not extend up to the scanning-side extending electrode 109 and sustaining-side extending electrode 122 and occurs only between the scanning electrode 101 and the sustaining electrode 103. Then, during the sustaining erasing period D, as in the case of the eighth embodiment, the sustaining electrode 103 and the sustaining-side extending electrode 122 are fixed as the sustaining voltage and a negative-polarity sawtooth-shaped sustaining erasing pulse “Pes” is applied to the scanning electrode 101. A sustaining erasing pulse “Pea” having the same waveform as the pulse “Pes” is applied to the scanning-side extending electrode 109. As the ultimate voltage of these sustaining erasing pulses, for example, about −60 V is used in the embodiment and as an inclination of these pulses, about 3V/micro second is used.

By such the processes, feeble discharge occurs between the scanning electrode 101 and the sustaining electrode 103 and wall charges formed on both the electrodes are erased and the charged states return back to their initial states, that is, to the states before the pre-discharging pulses “Pps” and “Ppc” were applied during the pre-discharging period A.

A method for improving display image quality employed in the plasma display device of the tenth embodiment using its driving method is described. AS described above, in the plasma display device, gray-scale is expressed by combining display luminance, that is, two or more sub-fields during which different numbers of sustaining pulses are applied. A minimum value in luminance changes for every shade of gray serving as a resolution of a gray scale is determined by luminance in a sub-field (LSB) which represents minimum luminance. In the case of displaying dark images in particular, small luminance changes for every shade of gray, that is, low luminance for the LSB enables smooth gray-scale expression, which can realize a high-quality display.

On the other hand, in general, as a demand for high luminance in displaying becomes strong, cell structures that can provide higher luminance are needed. For example, even if a sub-field is introduced during which only the first sustaining pulse “Psf” is applied for an LSB and during which, immediately after the application of the pulse “Psf”, a shift occurs from the sustaining period C to the sustaining erasing period D, since light-emitting luminance during the sub-field is high, no sufficient resolution of gray scale can be achieved.

In the plasma display device and its driving method employed in the tenth embodiment, both writing discharge occurring during the selective operating period B and sustaining discharge occurring once during the sustaining period C occur only between the scanning electrode 101 and the sustaining electrode 103, both being small in area and, therefore, it is made possible to minimize light-emitting luminance during the sub-field. As a result, by using the sub-field having such the configurations as the LSB, the resolution of shades of gray can be improved and displaying of high image quality can be achieved.

Moreover, it is possible to use the LSB luminance as luminance to be used only for writing discharge, with the sustaining discharge being not used at all. This method enables luminance for the LSB to be further reduced.

It is apparent that the present invention is not limited to the above embodiments but may be changed and modified without departing from the scope and spirit of the invention. For example, in the above embodiments, the ultimate potential of the scanning pulse “Pw” during the selective operating period B is set to be negative, as in the case of the conventional method for driving the known plasma display device, the ultimate potential may be set to be a ground voltage GND. Moreover, in the above embodiments, main discharge for display light-emitting is made to occur among electrodes formed on the same substrate, however, the main discharge can be made to occur among electrodes formed separately on two insulating substrates. The methods shown in the above embodiments can be combined to achieve the plasma display device.

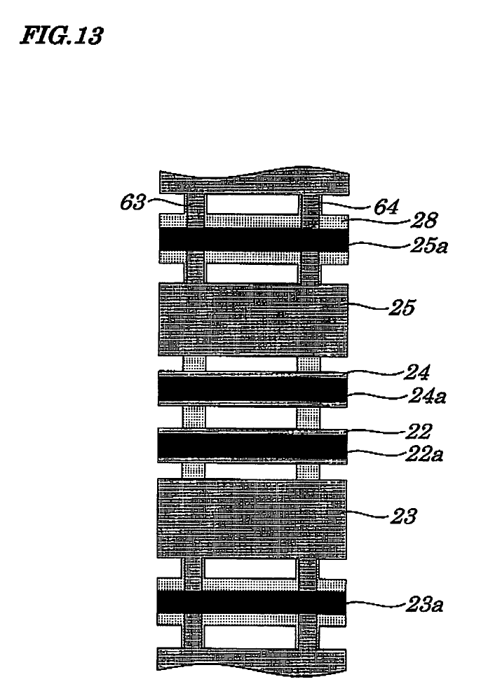

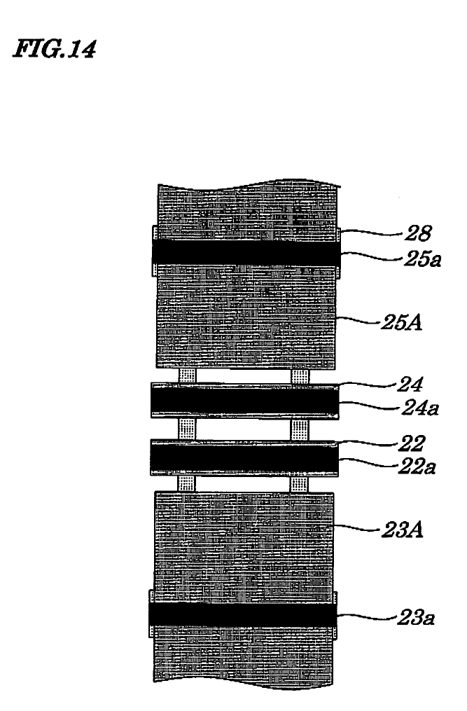

Moreover, in the fourth embodiment, as shown in FIG. 13, instead of the connection section 61 shown in FIG. 12, the connection sections 63 and 64 formed on the rib 28 may be formed. Also, as shown in FIG. 14, instead of the sustaining extended electrode 25 shown in FIG. 12, a sustaining extended electrode 25A may be formed. The sustaining extended electrode 25A is integrated with sustaining extended electrode in a unit cell (not shown) being adjacent, which is extended from the sustaining extended electrode 25 in an upper direction. Also, instead of the scanning extended electrode 23 shown in FIG. 12, a scanning extended electrode 23A may be formed. The scanning extended electrode 23A is integrated with scanning extended electrode in a unit cell (not shown) being adjacent, which is extended from the scanning extended electrode 23 in a down direction.

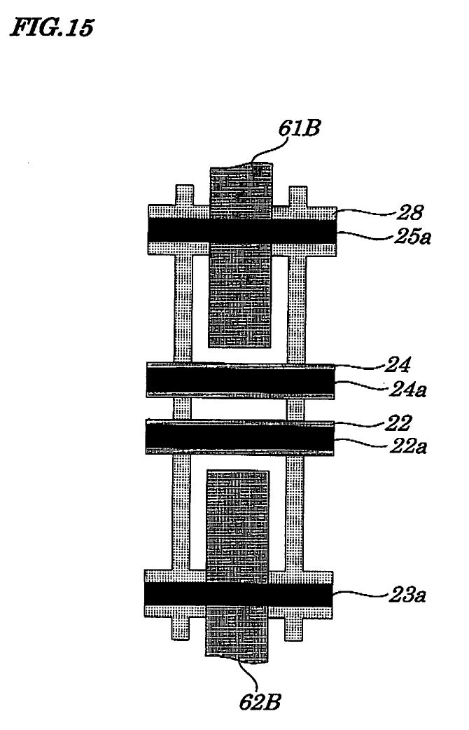

Also, as shown in FIG. 15, instead of the connection section 61 shown in FIG. 12 and sustaining extended electrode 25, a connection section 61B may be formed. The connection section 61B is a section formed by extending the connection section 61 in up and down direction, which serves also as the sustaining extended electrode. Instead of the connection section 62 shown in FIG. 12 and scanning extended electrode 23, a connection section 62B may be formed. The connection section 62B is a section formed by extending the connection section 62 in up and down directions, which serves also as the scanning extended electrode. By configurations shown in FIGS. 13, 14, or 15, an influence by shielding of light emitted by sustaining discharge is suppressed.

Also, in FIG. 5 that shows the first embodiment, during the scanning period T2, as in the conventional case shown in FIG. 20, a sub-scanning pulse “p” may be applied to the sustaining main electrode 24 and a scanning base pulse “q” may be applied to the scanning main electrode 22. In FIG. 5, each of the reference potentials for the scanning main electrode 22, scanning extended electrode 23, sustaining main electrode 24, sustaining extended electrode 25, and data electrodes 26a and 26b is shown by broken lines, however, these reference potentials may be set to be varied in various manners. By making the scanning main electrode 22, scanning extended electrode 23, sustaining main electrode 24, and sustaining extended electrode 25 have the same reference potential, the number of power supplies for the scanning main electrode driver 32, scanning extended electrode driver 33, sustaining main electrode driver 34 and sustaining extended electrode driver 35 can be minimized, thus enabling a size of the power circuit 45 to be reduced.

By making reference potentials of the scanning main electrode 22 and sustaining main electrode 24 be lower than the reference potentials of the scanning extended electrode 23 and sustaining extended electrode 25, a voltage level of each of pulses to be output from the scanning main electrode driver 32 and sustaining main electrode driver 34 can be set to be lower and, therefore, power consumption can be reduced. By making reference potentials of the scanning extended electrode 23 and sustaining extended electrode 25 be lower than the reference potentials of the scanning main electrode 22 and sustaining main electrode 24, a voltage level of each of pulses to be output from the scanning extended electrode driver 33 and sustaining extended electrode driver 35 can be set to be lower and power consumption can be reduced accordingly.

Furthermore, the black dielectric layer 58 shown in FIG. 8 may be configured in a manner in which it is contacted with the protecting layer 54. The number of sub-fields shown in FIG. 19 is divided into four, however, it can be divided into, for example, eight, that is, the number corresponding to the number of gray levels. When eight sub-fields are set, a ratio of time width of sustaining period for each sub-field is set to be 1:2:4:8:16:32:64:128 and an image of 256 gray levels are displayed in a screen.

1. A plasma display device comprising:
a plasma display panel; and
a driving unit to drive said plasma display panel by dividing one field for a display screen into two or more sub-fields with weights different from each other, each of which is assigned to each of said sub-fields according to a gray level;
wherein said plasma display panel comprises:
a first substrate and a second substrate arranged in a manner in which said first substrate faces said second substrate;
two or more pairs of main electrodes, each pair being made up of a scanning main electrode and a sustaining main electrode and being formed on a surface of said first substrate being opposite to said second substrate in parallel to each other with a discharge gap being interposed between said scanning main electrode and said sustaining main electrode;
two or more pairs of extended electrodes, each pair being made up of a scanning extended electrode formed on a side being opposite to said discharge gap relative to said scanning main electrode with a specified interval being interposed between said scanning main electrode and said scanning extended electrode, and a sustaining extended electrode formed on a side being opposite to said discharge gap relative to said sustaining main electrode with a specified interval being interposed between said sustaining main electrode and said sustaining extended electrode;
two or more data electrodes formed on a surface of said second substrate being opposite to said first substrate in a manner to be orthogonal to each of said pairs of main electrodes and each of said pairs of extended electrodes;
two or more unit cells formed, in a manner to be surrounded by partition walls, at intersecting regions of said two or more pairs of main electrodes and said two or more pairs of extended electrodes and said two or more data electrodes;
discharge space containing each of said two or more unit cells being formed between said first substrate and said second substrate with discharge gas being filled; and
a light shielding unit to shield most of light emitted in said scanning main electrode and said sustaining main electrode;
wherein, during every sub-field, said driving unit to cause pre-discharge to occur in all unit cells, by applying a pre-discharging pulse only to said scanning main electrode and said sustaining main electrode and not to said scanning extended electrode and sustaining extended electrode and to cause address discharge to occur in each of selected units cell by applying a scanning pulse in a one-pass scanning manner to each said scanning main electrode and simultaneously by applying a display data pulse, in synchronization with said scanning pulse, to each of said data electrodes and, to cause sustaining discharge to occur in each of said selected unit cells by applying all or a greater part of a sustaining pulse alternately to said scanning extended electrode and sustaining extended electrode.

2. The plasma display device according to claim 1, wherein said driving unit is so constructed that, when said sustaining pulse is applied to said scanning extended electrode and said sustaining extended electrode, said sustaining pulse is simultaneously applied to said scanning main electrode and said sustaining main electrode.

3. The plasma display device according to claim 1, wherein said scanning main electrode or said sustaining main electrode is constructed by stacking a metal bus electrode on a transparent electrode and wherein a width of said metal bus electrode being stacked on said scanning main electrode or said sustaining main electrode is set to be smaller than a width of corresponding said transparent electrode and to be more than half of that of said transparent electrode and wherein said metal bus electrode makes up said light shielding unit.

4. The plasma display device according to claim 1, wherein said scanning main electrode or sustaining main electrode is constructed only of a metal bus electrode and said metal bus electrode makes up said light shielding unit.

5. The plasma display device according to claim 1, wherein at least in a region containing said discharge gap, a black dielectric layer is formed which shields light emitted by said scanning main electrode and said sustaining main electrode.

6. The plasma display device according to claim 1, wherein two said scanning extended electrodes are electrically connected to each other in two unit cells being adjacent to one another, or/and two said sustaining extended electrodes are electrically connected to each other contained in said two unit cells.

7. The plasma display device according to claim 6, wherein one bus electrode is formed in a center portion of said two scanning extended electrodes being electrically connected and integrated or said two sustaining extended electrodes being electrically connected and integrated.

8. The plasma display device according to claim 7, wherein said two scanning extended electrodes being electrically connected and integrated or said two sustaining extended electrodes being electrically connected and integrated are electrically connected via a connection unit which passes through a central line of said unit cell.

9. The plasma display device according to claim 7, wherein said two scanning extended electrodes being electrically connected and integrated or said two sustaining extended electrodes being electrically connected and integrated are electrically connected via a connection unit formed above a partition wall surrounding said unit cell.

10. A method for driving a plasma display device having a plasma display panel and a driving unit to drive said plasma display panel by dividing one field for a display screen into two or more sub-fields with weights being assigned to each of said sub-fields according to a gray level, said method comprising:
a step of constructing said plasma display panel of a first substrate and a second substrate arranged in a manner in which said first substrate faces said second substrate, two or more pairs of main electrodes, each pair being made up of a scanning main electrode and a sustaining main electrode being formed on a surface of said first substrate being opposite to said second substrate in parallel to each other with a discharge gap interposed between said scanning main electrode and said sustaining main electrode, two or more pairs of extended electrodes, each pair being made up of a scanning extended electrode formed on a side being opposite to said discharge gap relative to said scanning main electrode with a specified interval being interposed between said scanning main electrode and scanning extended electrode and a sustaining extended electrode formed on a side being opposite to said discharge gap relative to said sustaining main electrode with a specified interval being interposed between said sustaining main electrode and said sustaining extended electrode, two or more data electrodes formed on a surface of said second substrate being opposite to said first substrate in a manner to be orthogonal to each of said pairs of main electrodes and each of said pairs of extended electrodes, two or more unit cells formed, in a manner to be surrounded by partition walls at intersecting regions between said two or more pairs of main electrodes and said two or more pairs of extended electrodes and said two or more data electrodes, discharge space containing each of said two or more unit cells being formed between said first substrate and second substrate with discharge gas being filled, and a light shielding unit to shield most of light emitted by said scanning main electrode and said sustaining main electrode; and
a step of said driving unit causing pre-discharge to occur in all unit cells, during every sub-field, by applying a pre-discharging pulse only to said scanning main electrode and said sustaining main electrode and not to said scanning extended electrode and sustaining extended electrode and to cause address discharge to occur in a selected unit cell by applying a scanning pulse in a one-pass scanning manner to each scanning main electrode and simultaneously by applying a display data pulse, in synchronization with said scanning pulse, to each of data electrodes and to cause sustaining discharge to occur in each selected unit cell by applying all or a greater part of a sustaining pulse alternately to said scanning extended electrode and sustaining extended electrode.

11. A plasma display device comprising:
two or more first electrodes; and
two or more second electrodes each having a gap being interposed between each of said first electrodes and each of said second electrodes;
wherein a display is made by discharge made to occur between each of said first electrodes and each of said second electrodes and wherein each of said first electrodes has a first portion and a second portion wherein said first portion of each of said first electrodes is used for selective discharge to select a state of being displayed or not being displayed and said second portion of each of said second electrodes is not used for said selective discharge to select a state of being displayed or not being displayed.

12. The plasma display device according to claim 11, wherein each of said second electrodes has a first portion and a second portion and wherein said first portion of each of said second electrodes is used for said selective discharge to select a state of being displayed or not being displayed and said second portion of each of said second electrodes is not used for said selective discharge to select a state of being displayed or not being displayed.

13. A plasma display device comprising:
a first substrate and a second substrate arranged in a manner in which said first substrate faces said second substrate;
two or more first electrodes being formed on a surface side of said first substrate being opposite to said second substrate and extending in parallel to one another in a row direction;
two or more second electrodes formed in parallel to said two or more first electrodes with a main discharge gap in which discharge for displaying is made to occur being sandwiched between each of said first electrodes and each of said second electrodes;
two or more third electrodes being formed on a surface side of said second substrate being opposite to said first substrate and extending in a column direction being orthogonal to a direction in which said first electrodes extend; and
two or more display cells each being defined by an intersecting region among each of said first electrodes, each of said second electrodes, and each of said third electrodes;
wherein each of said first electrodes has a first portion and a second portion and wherein said first portion of each of said first electrodes is used for said selective discharge to select a state of being displayed or not being displayed and said second portion of each of said first electrodes is not used for selective discharge to select a state of being displayed or not being displayed.

14. The plasma display device according to claim 13, wherein each of said second electrodes has a first portion and a second portion wherein said first portion of said second electrodes is used for said selective discharge to select a state of being displayed or not being displayed and said second portion of said second electrodes is not used for said selective discharge to select a state of being displayed or not being displayed.

15. The plasma display device according to claim 13, wherein each of display lines is formed by a pair of said first electrode and said second electrode, and said first and second electrodes are so constructed that an arranging order of each of said first electrodes and each of said second electrodes is interchanged for every display line and wherein, in said display lines being adjacent to one another, at least one of second portions, being adjacent to one another, of each of said first electrodes is electrically connected to at least one of second portions, being adjacent to one another, of each of said second electrodes.

16. The plasma display device according to claim 13, wherein partition walls to maintain gaps between said first and second substrates are formed in boundaries of said display lines and each of said second portions of said first electrodes and each of said second portions of said second electrodes both being electrically connected to one another in said display lines being adjacent to one another has a high resistance electrode portion having a visible light transmittance and a low resistance electrode portion not having said visible light transmittance and wherein at least part of each of said low resistance electrode portion not having said visible light transmittance and each of said partition walls formed in boundaries of said display lines overlap each other.

17. The plasma display device according to claim 13, wherein each of said first portions of each of said first electrodes and each of said first portions of each of said second electrodes are formed in a manner in which a main discharge gap is sandwiched between each of said first portions of each of said first electrodes and each of said first portions of each of said second electrodes and wherein each of said second portions of each of said first electrodes is formed on a side being opposite to said main discharge gap on each of said first portion of each of said first electrodes and each of said second portions of each of said second electrodes is formed on a side being opposite to said main discharge gap on each of said first portions of each of said second electrodes.

18. A method for driving a plasma display device having a first substrate and a second substrate both being arranged so as to face each other, two or more first electrodes being formed on a surface side of said first substrate being opposite to said second substrate and extending in parallel to one another in a row direction and each being divided into, at least, a first portion and a second portion, two or more second electrodes formed in parallel to said first electrodes with a main discharge gap in which discharge for displaying is made to occur being sandwiched between each of said first electrodes and each of said second electrodes, two or more third electrodes being formed on a surface side of said second substrate being opposite to said first substrate and extending in a column direction being orthogonal to a direction in which said first electrodes extend, and two or more display cells being defined by an intersecting region among each of said first electrodes, each of said second electrodes, and each of said third electrodes, said method comprising:
a step of getting discharge that controls presence or absence of light emission in said display cells to occur by applying a first selected pulse to each of said first electrodes having an independent input for every line; and
a step of getting discharge that emits light for displaying to occur by continuously applying a sustaining pulse between each of said first electrodes and each of said second electrodes,
wherein said first selected pulse is applied to each of said first portion of each of said first electrodes and said sustaining pulse is applied to each of said first portions and said second portions of each of said first electrodes.

19. The method for driving a plasma display device according to claim 18, wherein said process of getting discharge that controls presence or absence of light emission in said display cells to occur includes a step of getting discharge to occur between each of said first electrodes and each of said third electrodes and a step of getting discharge to occur between each of said first electrodes and each of said second electrodes.

20. The method for driving a plasma display device according to claim 19, wherein each of said second electrodes is divided into a first portion and a second portion and said step of getting discharge to occur between each of said first electrodes and each of said third electrodes includes a step of getting discharge between said first portion of each of said first electrodes and said first portion of each of said second electrodes.

21. The method for driving a plasma display device according to claim 18, wherein a gray scale expression is made by setting two or more sub-field periods during one of which discharge that controls presence or absence of light emission in display cells is made to occur, discharge that emits light for displaying is made to occur by continuously applying a sustaining pulse between each of said first electrodes and each of said second electrodes in one field period during which one piece of an image is displayed and by combining selection of said sub-field periods and wherein, during at least one of said sub-field periods contained in said field period, said first selected pulse is applied to each of said first portions of each of said first electrodes and said sustaining pulse is applied to each of said first portions and second portions of each of said first electrodes and, during at least one said sub-field period, said first selected pulse is applied to each of said first portions of each of said first electrodes and said sustaining pulse is applied to each of said first portions of each of said first electrodes.

22. The method for driving a plasma display device according to claim 21, wherein said sub-field period during which said sustaining pulse is applied to each of said first portions of each of said first electrodes is a sub-filed period during which sustaining discharge is made to occur once.

23. The method for driving a plasma display device according to claim 21, wherein said sub-field during which said sustaining pulse is applied to each of said first portions of each of said first electrodes is a sub-field during which a minimum luminance is expressed.

24. The method for driving a plasma display device according to claim 18, wherein a gray scale expression is made by setting two or more sub-field periods during one of which discharge that controls presence or absence of light emission in display cells is made to occur, discharge that emits light for displaying is made to occur by continuously applying a sustaining pulse between each of said first electrodes and each of said second electrodes in one field period during which one piece of an image is displayed and by combining selection of said sub-field periods, wherein, during at least one of said sub-field periods contained in said field period, said first selected pulse is applied to each of said first portions of each of said first electrodes and said sustaining pulse is applied to each of said first and second portions of each of said first electrodes and during at least one of said sub-field periods, said first selected pulse is applied to each of said first portions of each of said first electrodes and a sustaining pulse is not applied.

25. The method for driving a plasma display device according to claim 24, wherein said sub-field during which said sustaining pulse is not applied is a sub-field during which a minimum luminance is expressed.

26. The method for driving a plasma display device according to claim 18, wherein each of said first portions of each of said first electrodes and each of said first portions of each of said second electrodes are formed in a manner in which said main discharge gap is sandwiched by each of said first portions of each of said first electrodes and each of said first portions of each of said second electrodes and each of said second portions of each of said first electrodes is formed on a side being opposite to said main discharge gap on each of said first portion of each of said first electrodes and each of said second portions of each of said second electrodes is formed on a side being opposite to said main discharge gap on each of said first portions of each of said second electrodes and at least one final sustaining pulse out of said sustaining pulses continuously applied is set so that a potential difference between each of said second portions of each of said first electrodes and each of said second portions of each of said second electrodes is lower than a potential difference between each of said first portions of each of said first electrodes and each of said first portions of each of said second electrodes.

27. The method for driving a plasma display device according to claim 18, wherein each of said first portions of each of said first electrodes and each of said first portions of each of said second electrodes are formed in a manner in which said main discharge gap is sandwiched by each of said first portions of each of said first electrodes and each of said first portions of each of said second electrodes and each of said second portions of each of said first electrodes is formed on a side being opposite to said main discharge gap on each of said first portion of each of said first electrodes and each of said second portions of each of said second electrodes is formed on a side being opposite to said main discharge gap on each of said first portions of each of said second electrodes and at least one part out of said sustaining pulses continuously applied is set so that a potential difference between each of said second portions of each of said first electrodes and each of said second portions of each of said second electrodes is larger than a potential difference between each of said first portions of each of said first electrodes and each of said first portions of each of said second electrodes.

28. A plasma display device having a first substrate and a second substrate both being arranged so as to face each other, two or more first electrodes being formed on a surface side of said first substrate being opposite to said second substrate and extending in parallel to one another in a row direction and each being divided into, at least, a first portion and a second portion, two or more second electrodes formed in parallel to said first electrodes with a main discharge gap in which discharge for displaying is made to occur being sandwiched between each of said first electrodes and each of said second electrodes and each being divided into, at least, a first portion and a second portion, two or more third electrodes being formed on a surface side of said second substrate being opposite to said first substrate and extending in a column direction being orthogonal to a direction in which said first electrodes extend, and two or more display cells being defined by an intersecting region among each of said first electrodes, each of said second electrodes, and each of said third electrodes, said plasma display device configured:
to get discharge that controls presence or absence of light emission in said display cells to occur between each of said first portions of each of said first electrodes and each of said third electrodes and between each of said first portions of each of said first electrodes and each of said first portions of each of said second electrodes by applying a first selected pulse to each of said first portions of each of said first electrodes having an individual input for every row and by applying a second selected pulse selectively to each of said third electrodes having an individual input for every column; and
to get discharge that emits light for displaying to occur by continuously applying a sustaining pulse between each of said first electrodes containing each of said first and second portions and each of said second electrodes containing each of said first and second portions.
